(19) United States
(12) Patent Application Publication
(10) Pub. No.: US 2025/0205706 A1
(43) Pub. Date: Jun. 26, 2025

(54) FLUIDIC DEVICES FOR SINGLE-ANALYTE ASSAYS

(71) Applicant: Nautilus Subsidiary, Inc., Seattle, WA (US)

(72) Inventors: Meysam Rezaei BARMI, Decatur, GA (US); Ali Najafi SOHI, Redwood City, CA (US); Gregory KAPP, San Carlos, CA (US); Scott RAPOPORT, San Diego, CA (US)

(21) Appl. No.: 18/986,567

(22) Filed: Dec. 18, 2024

Related U.S. Application Data
(60) Provisional application No. 63/612,959, filed on Dec. 20, 2023.

(51) Int. Cl. B01L 3/00

(52) U.S. Cl. CPC B01L 3/502776; B01L 2200/0636; B01L 2300/0816; B01L 2300/0877; B01L 2400/086

(57) ABSTRACT

Fluidic vessels having flow-altering properties are provided. The fluidic vessels may alter fluid flow velocity profiles downstream of ports or inlets to produce a more substantially uniform flow velocity profile. Fluidic vessels provided herein may be useful for delivering and/or discharging fluidic media containing pluralities of macromolecules during fluid transfer processes.

### CROSS REFERENCE TO RELATED APPLICATIONS

This patent application claims priority to U.S. Patent Application No. 63/612,959, entitled “Fluidic devices for single-analyte assays,” filed Dec. 20, 2023, which is hereby incorporated by reference.

### BACKGROUND

Arrays for many array-based assays and processes can be disposed within a fluidic vessel, such as a flow cell or fluidic cartridge, to provide a degree of environmental control. The housing of the fluidic vessel provides some protection against the introduction and contact of unwanted materials to an array. Moreover, the fluidic vessel can provide a fixed boundary that contains and maintains contact between introduced fluids and/or materials and the array within the fluidic vessel.

For arrays with small feature size (i.e., nanometer- to micron-scale array features), it can be preferable to dispose the array within a microfluidic device. A microfluidic device will typically contain nanometer- to micron-scale channels and reservoirs with nanoliter- to microliter-scale volumes. At such length scales, flow within a microfluidic device is often substantially laminar. The typically low shear stresses of flow within a microfluidic device can reduce the likelihood of fluidic damage to array components and surfaces.

Certain array-based assays and processes can utilize reagents that may be expensive, time-sensitive, or environmentally sensitive. For example, an array may be contacted with an expensive antibody-type affinity reagent, or may be contacted with an emulsion that may flocculate over time. Accordingly, it is preferable to provide fluidic vessels that increase control over the delivery and efficient usage of fluids and/or reagents transferred to an array within the fluidic device.

### SUMMARY

In an aspect, provided herein is a fluidic vessel, comprising a chamber bounded by at least one substantially planar surface and a second surface, a first port between the chamber and an exterior of the fluidic vessel, a second port between the chamber and the exterior of the fluidic vessel, and a channel disposed between the first port and the second port, wherein the channel is bounded by the at least one substantially planar surface and the second surface, wherein the fluidic vessel further comprises an offset structure, wherein the first port is configured to deliver fluid to a surface of the offset structure, wherein the surface of the offset structure is substantially parallel to the surface of the substantially planar surface, and wherein a depth of the chamber between the surface of the offset structure and the second surface of the chamber is less than the depth of the chamber between the substantially planar surface and the second surface of the chamber.

In another aspect, provided herein is a fluidic vessel, comprising a first port, a second port, and a channel disposed between the first port and the second port, wherein the channel is bounded by at least one substantially planar surface and a second surface, wherein the channel has a depth between the substantially planar surface and the second surface, wherein the fluidic vessel comprises a baffled structure, wherein the first port is configured to deliver fluid across the baffled structure, wherein the baffled structure comprises a plurality of protrusions, wherein a length of a protrusion of the plurality of protrusions is greater than a width of the protrusion of the plurality of protrusions, and wherein the protrusion of the plurality of protrusions is oriented substantially orthogonal to a primary fluid flow direction of the fluidic vessel.

In another aspect, provided herein is a fluidic vessel, comprising a first port, a second port, and a channel disposed between the first port and the second port, wherein the channel is bounded by at least one substantially planar surface, wherein an array comprising a plurality of sites is disposed on the substantially planar surface, and wherein the channel has an average depth between the substantially planar surface and an opposing surface in an orthogonal direction relative to the substantially planar surface of no more than 20 microns.

In another aspect, provided herein is a fluidic vessel, comprising: a) a flow region with an aspect ratio greater than 1, wherein the aspect ratio is a length of the flow region divided by a width of the flow region, b) a first surface bounding the flow region, wherein the first surface comprises a curved surface, and c) a second surface bounding the flow region, wherein the second surface comprises a substantially planar surface, wherein the first surface is substantially opposed to the second surface, wherein the flow region has a depth between the first surface and second surface, and wherein a cross-sectional profile of the first surface varies with the length of the flow region.

In another aspect, provided herein is a fluidic vessel, comprising: a) a flow region with an aspect ratio greater than 1, wherein the aspect ratio is a length of the flow region divided by a width of the flow region, b) a substantially planar surface bounding the flow region, and c) an offset surface comprising a port, wherein the offset surface is substantially parallel to and offset from the substantially planar surface, wherein the offset surface comprises a curved edge that spans at least a portion of the width of the flow region, wherein the curved edge is indented toward the port.

In another aspect, provided herein is a fluidic vessel, comprising: a) a surface comprising an array of sites, wherein the surface has an aspect ratio greater than 1, wherein the aspect ratio is a length of the surface divided by a width of the surface, b) a port passing through the surface, wherein the port provides fluidic communication to the surface, and c) a baffled structure comprising a plurality of ridged structures, wherein the baffled structure is disposed in a region between the port and the array of sites.

In another aspect, provided herein is a fluidic vessel, comprising: a) a solid support, wherein a surface of the solid support comprises an array, wherein the array comprises a plurality of sites, wherein the surface of the solid support has an average length and an average width, and wherein the average length of the surface of the solid support is greater than the average width of the solid support, b) a first channel in the solid support, wherein the first channel is disposed adjacent to a first side of the array, and c) a second channel in the solid support, wherein the second channel is disposed adjacent to a second side of the array, wherein the second side differs from the first side, wherein an average separation distance between the first channel and the second channel is less than the average length of the surface of the solid support.

In another aspect, provided herein is a method, comprising: a) delivering a fluid to a first port of a fluidic vessel, as set forth herein, wherein the fluid comprises a plurality of macromolecules, b) flowing the fluid comprising the plurality of macromolecules across an array of sites that is disposed within the fluidic vessel, thereby binding macromolecules of the plurality of macromolecules to sites of the array of sites, and c) discharging the fluid through a second port of the fluidic vessel.

### INCORPORATION BY REFERENCE

All publications, items of information available on the internet, patents, and patent applications cited in this specification are herein incorporated by reference to the same extent as if each individual publication, patent, or patent application was specifically and individually indicated to be incorporated by reference. To the extent publications, items of information available on the internet, patents, or patent applications incorporated by reference contradict the disclosure contained in the specification, the specification is intended to supersede and/or take precedence over any such contradictory material.

### BRIEF DESCRIPTION OF DRAWINGS

FIGS. 1A-1C illustrate top-down views of solid support configurations comprising an array with a non-unity aspect ratio, and ports that are configured to produce a primary fluid flow direction across a shorter dimension of the array, in accordance with some embodiments. FIG. 1D illustrates a cross-sectional view of a fluidic vessel containing the solid support of FIG. 1A and fluidic passages passing through bottom of the solid support, in accordance with some embodiments. FIG. 1E illustrates a cross-sectional view of a fluidic vessel containing the solid support of FIG. 1A and fluidic passages passing through the top of the fluidic vessel, in accordance with some embodiments. FIG. 1F illustrates an alternative configuration of the fluidic vessel of FIG. 1E, in which the fluid is passed through a narrow channel into the chamber of the fluidic vessel, in accordance with some embodiments.

FIGS. 2A, 2B, 2C, 2D, 2E, 2F, 2G, and 2H depict steps of methods of utilizing a fluidic vessel such as the fluidic vessel illustrated in FIGS. 1A and 1D.

FIG. 3A shows a concentration profile of a packet of a first fluid displacing a second fluid in a fluidic vessel under laminar flow conditions when the fluidic vessel has a substantially uniform cross-sectional profile, in accordance with some embodiments. FIG. 3B shows a concentration profile of a packet of a first fluid displacing a second fluid in a fluidic vessel under laminar flow conditions when the fluidic vessel has a non-uniform cross-sectional profile, in accordance with some embodiments. FIG. 3C shows a top-down view of a fluidic vessel comprising an array of sites, in which a velocity profile of a fluid is substantially uniform proximal to the region containing the array of sites.

FIG. 4A depicts a contour profile of a solid support that is configured to produce a flow profile similar to FIG. 3B, in accordance with some embodiments. FIG. 4B depicts an isometric view of a three-dimensional rendering of the solid support of FIG. 4A, in accordance with some embodiments. FIGS. 4C and 4D illustrate cross-sectional views of a fluidic vessel that incorporates the surface 401 depicted in FIGS. 4A and 4B, in accordance with some embodiments of the present disclosure.

FIGS. 5A, 5B, 5C, and 5D illustrate steps of a method of forming a solid support similar to the contoured solid support of FIGS. 4A and 4B, in accordance with some embodiments.

FIG. 6A depicts a model of a fluidic vessel having an offset entrance region relative to a flat solid support, in accordance with some embodiments. FIG. 6B depicts a top-down view of the model of FIG. 6A. FIG. 6C depicts a cross-sectional view of a fluidic vessel having an offset entrance region that is disposed in a central region of the fluidic vessel, in accordance with some embodiments. FIG. 6D depicts a model of a fluidic vessel having a baffled entrance region relative to a flat solid support, in accordance with some embodiments. FIGS. 6E, 6F, 6G, 6H, and 6I depict top-downs views of baffled structures of various configurations, in accordance with some embodiments. FIG. 6J depicts a top-down view of the model of FIG. 6D, in accordance with some embodiments. FIG. 6K depicts a cross-sectional view of a fluidic vessel having a baffled entrance region that is disposed in a central region of the fluidic vessel, in accordance with some embodiments. FIG. 6L depicts a baffled structure containing structures of varying orientation with respect to a primary direction of fluid flow or a primary orientation of a boundary of a fluidic vessel, in accordance with some embodiments.

FIG. 7A shows a model of a fluidic vessel having a single curved flow path and two terminal ports, in accordance with some embodiments. FIG. 7B shows a model of a branched fluidic vessel having four branches with a common central port and one terminal port at the distal end of each branch, in accordance with some embodiments.

FIG. 8A illustrates a top-down view of a configuration of a fluidic vessel, in accordance with some embodiments. FIG. 8B illustrates a cross-section view along the lengthwise direction of the fluidic vessel of FIG. 8A.

FIG. 9A illustrates a top-down view of a fluidic vessel containing an array, in which the array is flanked on lengthwise sides by channels that are configured to provide a non-stationary boundary, in accordance with some embodiments. FIG. 9B illustrates a cross-section view across the width of the fluidic device of FIG. 9B, in accordance with some embodiments. FIG. 9C depicts a cross-sectional view of an alternative configuration of a fluidic vessel, in accordance with some embodiments of the present disclosure.

FIG. 10A depicts a velocity profile of a fully-developed fluid flow downstream of an entrance region for a fluidic vessel having a flat solid support, in accordance with some embodiments. FIG. 10B depicts simulated velocity profiles as a function of inlet height for a fully-developed fluid flow downstream of an entrance region for a fluidic vessel having an offset entrance region, in accordance with some embodiments.

FIG. 11 depicts simulated velocity profiles as a function of baffle depth for a fully-developed fluid flow downstream of an entrance region for a fluidic vessel having a baffled entrance region, in accordance with some embodiments.

### DETAILED DESCRIPTION

### Definitions

Terms used herein will be understood to take on their ordinary meaning in the relevant art unless specified otherwise. Several terms used herein and their meanings are set forth below.

As used herein, the term “port” refers to an opening between an internal void of a fluidic vessel and the exterior of the vessel through which a fluid can be delivered or discharged. A port may be configured to provide fluidic communication between an internal void of a fluidic vessel and a fluid source that is external to the fluidic vessel or external to the internal void. A port may provide an opening into a chamber or channel within a fluidic vessel through which a fluid can be delivered into or discharged from the chamber or channel. A port may be located at a terminal location of a chamber or channel. Alternatively, a port can be located at a non-terminal location of a chamber or channel. A port may be referred to as an “inlet port” if the port is configured to deliver a fluid into an internal void of a fluidic vessel. A port may be referred to as an “outlet port” if the port is configured to discharge a fluid from an internal void of a fluidic vessel. A port may be configured for bidirectional fluid flow (i.e., capable of delivery and discharge of a fluid).

As used herein, the terms “velocity profile,” “flow velocity profile,” or “fluid velocity profile” refer to a spatial and/or temporal description of fluid velocity within a fluidic vessel. A fluid velocity profile may include at least one of: i) a magnitude or speed of the fluid velocity at a point, and ii) a vector direction of the velocity at the point. A fluid velocity profile may be provided as a one-dimensional profile (e.g., a plurality of vectors and/or magnitudes describing velocities for any point along a one-dimensional line or curve), a two-dimensional profile (e.g., a plurality of vectors and/or magnitudes describing velocities for any point of a two-dimensional plane or surface), a three-dimensional profile (e.g., a plurality of vectors and/or magnitudes describing velocities for any point of a three-dimensional volume). In some cases, a fluid velocity profile may also include a temporal or transient portion describing the time-dependence of the velocity magnitude and/or vector at any point of the profile. A fluid velocity profile including a temporal component can increase the dimensionality of the profile by one (e.g., a one-dimensional spatial profile becomes a two-dimensional spatiotemporal profile). A fluid velocity profile may be described by a theoretical or empirical mathematical function, or may be calculated by a fluidic modeling process or algorithm. As used herein, the term “speed,” when used in reference to a fluid velocity or a fluid velocity profile, refers to the magnitude of the velocity.

As used herein, the term “baffled structure” refers to a plurality of fluid-impermeable structures that alter a fluid velocity profile downstream of the baffled structure. A baffled structure may comprise a plurality of structures that protrude relative to a surface within a chamber or channel of a fluidic vessel (i.e. protrusions). A baffled structure may comprise a plurality of structures that are inset relative to a surface within a chamber or channel of a fluidic vessel (i.e. depressions). A baffled structure may be configured to produce fluid momentum transfer in two or three dimensions, thereby producing a difference between an upstream fluid velocity profile and a downstream fluid velocity profile. In some cases, a baffled structure may reduce spatial variability of velocity magnitude and/or direction vector of a fluid velocity profile of a fluid downstream of the baffled structure.

As used herein, the term “offset structure” refers to a structure within an internal void of a fluidic vessel comprising a surface that is offset with respect to a downstream surface of the internal void, in which the offset surface further comprises a port. An offset surface may protrude with respect to the downstream surface (e.g., is closer to an opposing surface of the internal void). An offset structure may be depressed with respect to the downstream surface (e.g., is further distanced from an opposing surface of the internal void). An offset structure may comprise an edge that delineates a transition from the offset surface to the downstream surface. The edge of an offset structure can comprise a curved edge. The transition between an offset surface and a downstream surface may be substantially orthogonal or may be inclined. An offset structure may be configured to produce fluid momentum transfer in two or three dimensions, thereby producing a difference between an upstream fluid velocity profile and a downstream fluid velocity profile. In some cases, an offset structure may reduce spatial variability of velocity magnitude and/or direction vector of a fluid velocity profile of a fluid downstream of the baffled structure.

As used herein, the term “flow region” refers to an area or volume of an internal void (e.g., a lumen, chamber or channel) of a fluidic vessel within which a fluid flows (i.e., experiences bulk fluid displacement) or is configured to flow. A flow region can optionally contain one or more ports and/or a surface comprising an array. A flow region may contain one or more subregions, including a flow development subregion, and a steady-state flow subregion. A flow development region can refer to a region of an internal void of a fluidic vessel in which a fluid velocity profile is spatially variable along a vector oriented in the direction of bulk fluid flow. A steady-state flow subregion can refer to a region of an internal void of a fluidic vessel in which a fluid velocity profile is substantially spatially uniform along a vector oriented in the direction of bulk fluid flow.

As used herein, the term “analyte” refers to a molecule, particle, or complex of molecules or particles that is coupled to an array site or an anchoring moiety. An analyte may comprise a target for an analytical method (e.g., sequencing, identification, quantification, etc.) or may comprise a functional element such as a binding ligand or a catalyst. An analyte may comprise a biomolecule, such as a polypeptide, polysaccharide, nucleic acid, lipid, metabolite, enzyme cofactor or a combination thereof. An analyte may comprise a non-biological molecule, such as a polymer, metal, metal oxide, ceramic, semiconductor, mineral, or a combination thereof. As used herein, the term “sample analyte” refers to an analyte derived from a sample collected from a biological or non-biological system. A sample analyte may be purified from at least one, some or all other substances, such as substances found in its native milieu, or unpurified from other substances, such as substances found in its native milieu. As used herein, the term “standard analyte” refers to a known or characterized analyte that is provided as a physical or chemical reference to a process. A standard analyte may comprise the same type of analyte as a sample analyte, or may differ from a sample analyte. For example, a polypeptide analyte process may utilize a polypeptide standard analyte with known characteristics. In another example, a polypeptide analyte process may utilize a non-polypeptide standard analyte with known characteristics.

As used herein, the term “orthogonal binding”, when used in reference to an array or a molecule, moiety, or particle contacted thereto, refers to any unwanted, unexpected, or contrary-to-design binding that is apparent at an array surface or array feature in the presence of a binding reagent. Orthogonal binding may arise, for example, due to binding interactions between the binding reagent and the array surface or due to binding interactions between the binding reagent and a moiety or substance at or near the array surface. Orthogonal binding phenomena may be qualitatively characterized as an apparent binding interaction that occurs in a system that has been engineered to prevent such a binding interaction (e.g., a hydrophilic molecule binding to a putatively hydrophobic surface). Orthogonal binding phenomena may be quantitatively characterized, for example, as measurable binding interactions occurring between an array surface or array feature (e.g., an interstitial region or an analyte binding site) and an unbound moiety that may become contacted with the array surface or feature, in which the measurable binding interactions occur at a rate and/or to an extent that exceeds a predicted rate and/or extent, such as a thermodynamic or kinetic prediction (e.g., a dissociation constant, a binding on-rate, a binding off-rate, etc.). For example, if an unbound moiety is characterized to bind to a surface-coupled passivating moiety (e.g., polyethylene glycol) with a kilomolar dissociation constant (a very weak binding interaction), then observing a millimolar binding dissociation constant between the unbound moiety and an array surface that is provided with a uniform layer of the surface-coupled passivating moiety would indicate an orthogonal binding phenomena (i.e., binding due to a mechanism other than the specific binding of the unbound moiety to the surface-coupling passivating moiety). Orthogonal binding phenomena may be characterized based upon a stochastic measure, such as spatial and/or temporal variations in unwanted, unexpected, or contrary-to-design binding phenomena.

As used herein, the terms “blocking agent” or “blocking reagent” refer to a substance, material, molecule, particle, or moiety that inhibits orthogonal binding phenomena of a binding reagent or other assay reagent to an array component (e.g., an array site or a surface coating or layer attached thereto, an anchoring moiety, an analyte, an interstitial region or a surface coating or layer attached thereto) in a single-analyte array system. A blocking agent or blocking reagent may bind to a defect of an array or a surface thereof. A blocking agent or blocking reagent may be provided in a fluidic medium that is contacted to an array during an array-based method or process. A blocking agent or blocking reagent may be solvated, dissolved, suspended, or otherwise mobile within a fluidic medium. A blocking agent or blocking reagent may be bound to a surface of an array or bound to an array component (e.g., an array site or a surface coating or layer attached thereto, an anchoring moiety, an analyte, an interstitial region or a surface coating or layer attached thereto). A blocking agent or blocking reagent may comprise a polypeptide blocking agent or a non-polypeptide blocking agent. A blocking agent or blocking reagent may comprise an ionic polymer, a zwitterionic polymer, a non-ionic polymer, a cationic surfactant, an anionic surfactant, a non-ionic surfactant, a saccharide, a stabilizing agent, or an amphiphilic agent.

As used herein, the term “nucleic acid nanoparticle,” refers to a single- or multi-chain polynucleotide molecule comprising a compacted three-dimensional structure. The compacted three-dimensional structure can optionally have a characteristic tertiary structure. An exemplary nucleic acid nanostructure is a structured nucleic acid particle (SNAP). A SNAP can be configured to have an increased number of interactions between regions of a polynucleotide strand, less distance between the regions, increased number of bends in the strand, and/or more acute bends in the strand, as compared to the same nucleic acid molecule in a random coil or other non-structured state. Alternatively or additionally, the compacted three-dimensional structure of a nucleic acid nanostructure can optionally have a characteristic quaternary structure. For example, a nucleic acid nanostructure can be configured to have an increased number of interactions between polynucleotide strands or less distance between the strands, as compared to the same nucleic acid molecule in a random coil or other non-structured state. In some configurations, the tertiary structure (i.e. the helical twist or direction of the polynucleotide strand) of a nucleic acid nanostructure can be configured to be more dense than the same nucleic acid molecule in a random coil or other non-structured state. Nucleic acid nanostructures may include deoxyribonucleic acid (DNA), ribonucleic acid (RNA), peptide nucleic acid (PNA), other nucleic acid analogs, and combinations thereof. Nucleic acid nanostructures may have naturally-arising or engineered secondary, tertiary, or quaternary structures. A structured nucleic acid particle can contain at least one of: i) a moiety that is configured to couple an analyte to the nucleic acid nanostructure, ii) a moiety that is configured to couple the nucleic acid nanostructure to another object such as another SNAP, a solid support or a surface thereof, iii) a moiety that is configured to provide a chemical or physical property or characteristic to a nucleic acid nanostructure, or iv) a combination thereof. Exemplary SNAPs may include nucleic acid nanoballs (e.g. DNA nanoballs), nucleic acid nanotubes (e.g. DNA nanotubes), and nucleic acid origami (e.g. DNA origami). A SNAP may be functionalized to include one or more reactive handles or other moieties. A SNAP may comprise one or more incorporated residues that contain reactive handles or other moieties (e.g., modified nucleotides).

As used herein, the terms “type” or “species,” when used in reference to a molecule, particle, or moiety, refer to a molecule, particle, or moiety with a unique, distinguishable chemical structure. For example, the term “type of anchoring moiety” can refer to an anchoring moiety with a unique, distinguishable binding characteristic, for example, as characterized by an anchoring moiety binding availability or anchoring moiety binding competency. A first anchoring moiety may have one or more structural dissimilarities, such as an absence of a detectable label or a damaged moiety, with respect to a second anchoring moiety and still be of the same type of anchoring moiety if the structural dissimilarities do not result in a difference in binding characteristic between the first anchoring moiety and the second anchoring moiety. Anchoring moiety variants with differences in quantity, location, orientation, and types of coupling moieties are different species from each other if the differences result in differences in a binding characteristic. For example, members of a “type of anchoring moiety” can have a unique, distinguishable structure that is common to the members compared to other anchoring moieties that lack the unique, distinguishable structure. Anchoring moiety types may be identified, for example, by common shape and/or conformation, number of coupling moieties, or type of coupling moieties.

As used herein, the term “array” refers to a population of sites that provide spatial separation of molecules, moieties, or analytes that are resolved such that the sites can be distinguished from each other. Accordingly, molecules, moieties or analytes at one site of an array can be resolved from molecules, moieties or analytes at other sites of the array. The sites can function as unique identifiers and/or the sites can be attached to unique identifiers. The term “array of analytes” refers to an array with a population of sites, in which a plurality of sites of the population of sites is occupied by analytes.

As used herein, the terms “address,” “binding site,” and “site,” when used in reference to an array, means a location in an array where a particular molecule or analyte is present. An address can contain only a single molecule or analyte, or it can contain a population of several molecules or analytes of the same species (i.e. an ensemble of the molecules). Alternatively, an address can include a plurality of molecules or analytes that are different species. Addresses of an array are typically discrete. Addresses can be optically resolvable. The discrete addresses can be contiguous, or they can have interstitial spaces between each other. An array useful herein can have, for example, addresses that are separated by less than 100 microns, 10 microns, 1 micron, 500 nm, 100 nm, 10 nm or less. Alternatively or additionally, an array can have addresses that are separated by at least 10 nm, 100 nm, 500 nm, 1 micron, 5 microns, 10 microns, 50 microns, 100 microns or more. The addresses can each have an area of less than 1 square millimeter, 500 square microns, 100 square microns, 25 square microns, 1 square micron or less. An array can include at least about 1×10⁴, 1×10⁵, 1×10⁶, 1×10⁸, 1×10¹⁰, 1×10¹², or more addresses.

As used herein, the term “solid support” refers to a substrate that is insoluble in aqueous liquid. Optionally, the substrate can be rigid. The substrate can be non-porous or porous. The substrate can optionally be capable of taking up a liquid (e.g., due to porosity) but will typically, but not necessarily, be sufficiently rigid that the substrate does not swell substantially when taking up the liquid and does not contract substantially when the liquid is removed by drying. A nonporous solid support is generally impermeable to liquids or gases. Exemplary solid supports include, but are not limited to, glass and modified or functionalized glass, plastics (including acrylics, polystyrene and copolymers of styrene and other materials, polypropylene, polyethylene, polybutylene, polyurethanes, Teflon™, cyclic olefins, polyimides etc.), nylon, ceramics, resins, Zeonor™, silica or silica-based materials including silicon and modified silicon, carbon, metals, metal oxides (e.g., zirconia, titania, alumina, etc.), inorganic glasses, optical fiber bundles, gels, and polymers.

As used herein, the terms “group” and “moiety” are intended to be synonymous when used in reference to the structure of a molecule. The terms refer to a component or part of the molecule. The terms do not necessarily denote the relative size of the component or part compared to the rest of the molecule, unless indicated otherwise. A group or moiety can contain one or more atom. As used herein, the term “coupling moiety” refers to a component or part of a molecule or particle that is configured to couple the molecule or particle to a second molecule or particle, or that couples the molecule or particle to the second molecule or particle. A coupling moiety may couple a molecule or particle to a second molecule or particle reversibly or irreversibly. A coupling moiety may couple a molecule or particle to a second molecule or particle covalently or non-covalently.

As used herein, the term “binding reagent” refers to an entity that is capable of reproducibly binding to a binding partner (e.g., an analyte) or other substance. A binding reagent may form a reversible or irreversible interaction with a binding partner. A binding reagent may bind with a binding partner in a covalent or non-covalent manner. A binding reagent may be configured to perform a chemical modification (e.g., ligation, cleavage, concatenation, etc.) that produces a detectable change in the larger molecule, thereby permitting observation of the interaction that occurred. A binding partner can comprise an affinity agent or a plurality thereof. Affinity reagents may include chemically reactive affinity reagents (e.g., kinases, ligases, proteases, nucleases, etc.) and chemically non-reactive affinity reagents (e.g., antibodies, antibody fragments, aptamers, DARPins, peptamers, etc.). A binding reagent may be detectable if one or more detectable labels (e.g., fluorophores, luminophores) are attached or otherwise incorporated with the binding reagent. A binding reagent can further comprise a linking group or linking moiety that couples components (e.g., affinity agents, detectable labels) of a binding reagent together. A linking group or linking moiety may comprise a nanoparticle, such as a nucleic acid nanoparticle, or a non-nucleic acid nanoparticle (e.g., a polymer nanoparticle, a semiconductor nanoparticle, a carbon nanoparticle, a metal nanoparticle).

As used herein, the terms “protein” and “polypeptide” are used interchangeably to refer to a molecule or analyte comprising two or more amino acids joined by a peptide bond. A polypeptide may refer to a peptide (e.g., a polypeptide with less than about 200, 150, 100, 75, 50, 40, 30, 20, 15, 10, or less than about 10 linked amino acids). A polypeptide may refer to a naturally-occurring molecule, or an artificial or synthetic molecule. A polypeptide may include one or more non-natural, modified amino acids, or non-amino acid linkers. A polypeptide may contain D-amino acid enantiomers, L-amino acid enantiomers or both. A polypeptide may be modified naturally or synthetically, such as by post-translational modifications.

As used herein, the term “label” or “detectable label” refers to a moiety of an affinity reagent or other substance that provides a detectable characteristic. The detectable characteristic can be, for example, an optical signal such as absorbance of radiation, luminescence or fluorescence emission, luminescence or fluorescence lifetime, luminescence or fluorescence polarization, or the like; Rayleigh and/or Mie scattering; binding affinity for a ligand or receptor; magnetic properties; electrical properties; charge; mass; radioactivity or the like. A label component can be a detectable chemical entity that is conjugated to or capable of being conjugated to another molecule or substance. Exemplary molecules that can be conjugated to a label component include an affinity reagent or a binding partner. A label component may produce a signal that is detected in real-time (e.g., fluorescence, luminescence or radioactivity). A label component may produce a signal that is detected off-line (e.g., a nucleic acid barcode) or in a time-resolved manner (e.g., time-resolved fluorescence). A label component may produce a signal with a characteristic frequency, intensity, polarity, duration, wavelength, sequence, or fingerprint. Exemplary labels include, without limitation, a fluorophore, luminophore, chromophore, nanoparticle (e.g., gold, silver or carbon nanotubes), heavy atom, radioactive isotope, mass label, charge label, spin label, receptor, ligand, nucleic acid barcode, polypeptide barcode, polysaccharide barcode, or the like.

As used herein, the term “nucleic acid origami” refers to a nucleic acid construct comprising an engineered secondary, tertiary or quaternary structure. A nucleic acid origami may include DNA, RNA, PNA, LNAs, other nucleic acid analog, modified or non-natural nucleic acids, or combinations thereof. A nucleic acid origami may comprise a plurality of oligonucleotides that hybridize via sequence complementarity to produce the engineered structuring of the origami particle. A nucleic acid origami may comprise sections of single-stranded or double-stranded nucleic acid, or combinations thereof. A nucleic acid origami may comprise one or more tertiary structures of a nucleic acid, such as A-DNA, B-DNA, C-DNA, L-DNA, M-DNA, Z-DNA, etc. A nucleic acid origami may comprise single-stranded nucleic acid, double-stranded nucleic acid, multi-stranded nucleic acid, or combinations thereof. Exemplary nucleic acid origami structures may include nanotubes, nanowires, cages, tiles, nanospheres, blocks, and combinations thereof.

As used herein, the term “nucleic acid nanoball” refers to a globular or spherical nucleic acid structure. A nucleic acid nanoball may comprise a concatemer of oligonucleotides that arranges in a globular structure. A nucleic acid nanoball may comprise one or more oligonucleotides, including oligonucleotides comprising self-complementary nucleic acid sequences. A nucleic acid nanoball may comprise a palindromic nucleic acid sequence. A nucleic acid nanoball may include DNA, RNA, PNA, LNAs, other nucleic acid analog, modified or non-natural nucleic acids, or combinations thereof.

As used herein, the term “oligonucleotide” refers to a molecule comprising two or more nucleotides joined by a phosphodiester bond or analog thereof. An oligonucleotide may comprise DNA, RNA, PNA, LNAs, other nucleic acid analog, modified nucleotides, non-natural nucleotides, or combinations thereof. An oligonucleotide may include a limited number of bonded nucleotides, such as, for example, less than about 10000, 8000, 6000, 5000, 4000, 3000, 2000, 1000, 750, 500, 400, 300, 250, 200, 190, 180, 170, 160, 150, 140, 130, 120, 110, 100, 90, 80, 70, 60, 50, 40, 30, 25, 20, 15, 10, or less than 5 nucleotides. An oligonucleotide may include a linking group or linking moiety at a terminal or intermediate position. For example, an oligonucleotide may comprise two nucleic acid strands that are joined by an intermediate PEG molecule. In another example, an oligonucleotide may comprise a cleavable linker (e.g., a photocleavable linker, an enzymatically-cleavable linker, a restriction site, etc.) that joins two portions of the oligonucleotide. The terms “polynucleotide” and “nucleic acid” are used herein synonymously with the term “oligonucleotide.”

As used herein, the terms “coupled” and “attached” refer to the state of two entities being joined, fastened, adhered, connected, or bound to each other, thereby co-localizing the two entities. Two entities may be “directly coupled” if the two entities are contacted through a direct physical mechanism, such as covalent bonding, non-covalent bonding, electrostatic binding, or magnetic attraction. Two entities may be “indirectly coupled” if joining, fastening, adhesion, connection, or binding between the two entities is achieved through an intermediate entity. For example, an analyte, as set forth herein, may be coupled to a solid support, as set forth herein, by an anchoring moiety, in which the anchoring moiety is directly coupled to the solid support and in which the analyte is directly coupled to the anchoring moiety but does not physically contact the solid support. Coupling can be covalent or non-covalent. For example, a particle can be coupled to a protein by a covalent or non-covalent bond. A covalent bond is characterized by the sharing of pairs of electrons between atoms. A non-covalent bond is a chemical bond that does not involve the sharing of pairs of electrons and can include, for example, hydrogen bonds, ionic bonds, van der Waals forces, hydrophilic interactions, adhesion, adsorption, and hydrophobic interactions.

As used herein, the term “anchoring moiety” refers to a molecule or particle that serves as an intermediary attaching an analyte to a surface (e.g., on a solid support or a microbead). An anchoring group may be covalently or non-covalently attached to a surface and/or a polypeptide. An anchoring group may be a biomolecule, polymer, particle, nanoparticle, or any other entity that is capable of attaching to a surface or analyte. In some cases, an anchoring group may be a nucleic acid nanoparticle such as a SNAP.

As used herein, the term “single,” when used in reference to an object such as an analyte, means that the object is individually manipulated or distinguished from other objects. A single analyte can be a single molecule (e.g. single protein), a single complex of two or more molecules (e.g. a multimeric protein having two or more separable subunits, a single protein attached to a structured nucleic acid particle or a single protein attached to an affinity reagent), a single particle, or the like. Reference herein to a “single analyte” in the context of a composition, system or method herein does not necessarily exclude application of the composition, system or method to multiple single analytes that are manipulated or distinguished individually, unless indicated contextually or explicitly to the contrary.

As used herein, the term “structured nucleic acid particle” or “SNAP” refers to a single- or multi-chain polynucleotide molecule having a compacted three-dimensional structure. The compacted three-dimensional structure can optionally be characterized in terms of hydrodynamic radius or Stokes radius of the SNAP relative to a random coil or other non-structured state for a nucleic acid having the same sequence length as the SNAP. The compacted three-dimensional structure can optionally be characterized with regard to tertiary structure. For example, a SNAP can be configured to have an increased number of internal binding interactions between regions of a polynucleotide strand, less distance between the regions, increased number of bends in the strand, and/or more acute bends in the strand, as compared to a nucleic acid molecule of similar length in a random coil or other non-structured state. Alternatively or additionally, the compacted three-dimensional structure can optionally be characterized with regard to tertiary or quaternary structure. For example, a SNAP can be configured to have an increased number of interactions between polynucleotide strands or less distance between the strands, as compared to a nucleic acid molecule of similar length in a random coil or other non-structured state. In some configurations, the secondary structure of a SNAP can be configured to be more dense than a nucleic acid molecule of similar length in a random coil or other non-structured state. A SNAP may contain DNA, RNA, PNA, modified or non-natural nucleic acids, or combinations thereof. A SNAP may include a plurality of oligonucleotides that hybridize to form the SNAP structure. The plurality of oligonucleotides in a SNAP may include oligonucleotides that are attached to other molecules (e.g., binding reagents, analytes such as proteins, reactive moieties, or detectable labels) or are configured to be attached to other molecules (e.g., by functional groups). A SNAP may include engineered or rationally designed structures. Exemplary SNAPs include nucleic acid origami and nucleic acid nanoballs.

The term “comprising” is intended herein to be open-ended, including not only the recited elements, but further encompassing any additional elements.

As used herein, the term “each,” when used in reference to a collection of items, is intended to identify an individual item in the collection but does not necessarily refer to every item in the collection. Exceptions can occur if explicit disclosure or context clearly dictates otherwise.

The embodiments set forth below and recited in the claims can be understood in view of the above definitions.

### Fluidic Vessels

The present disclosure provides various embodiments of fluidic vessels that may be useful for fluidic systems including, for example, microfluidic systems. Some fluidic vessel architectures put forth herein may reduce the necessary pressure gradient to drive fluid flow through a fluidic vessel, or may reduce the channel dimensions and/or volume that of a fluidic device. Other fluidic vessel architectures put forth herein may be configured to form a more uniform mass or momentum flux across the width of a flow region of a fluidic vessel. The skilled person will readily recognize that the fluidic vessel architectures set forth herein may readily be combined to provide additional useful embodiments.

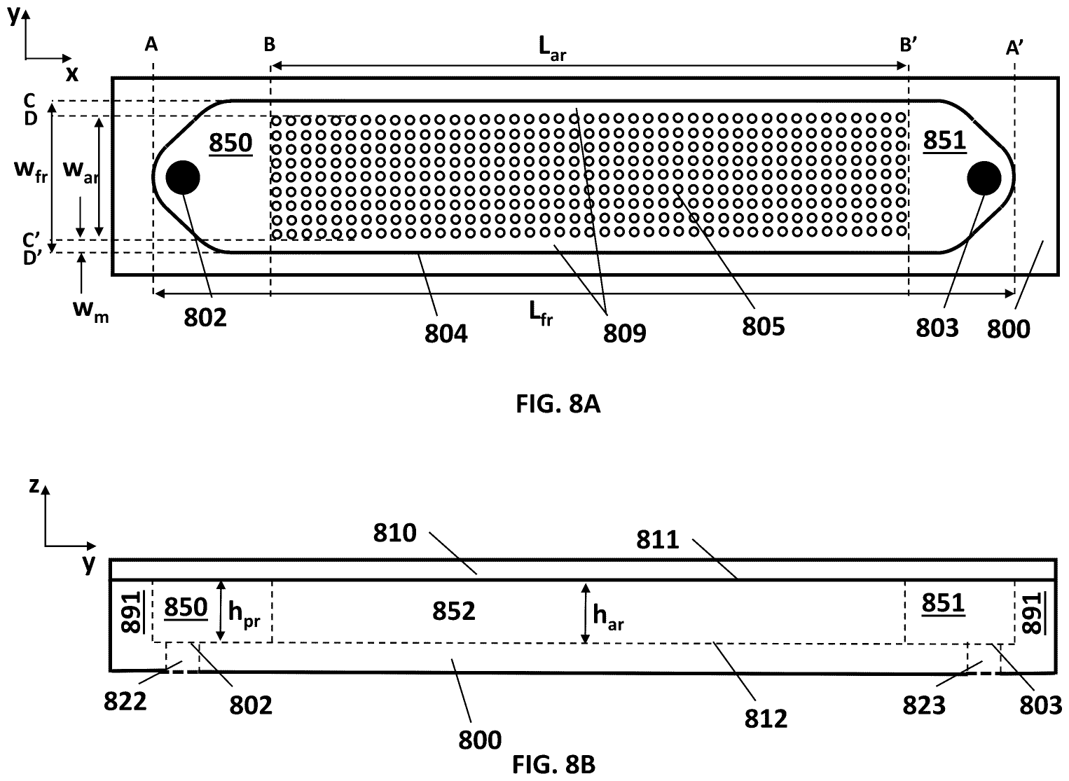

FIGS. 8A-8B illustrate certain features of fluidic vessels, including features that may be useful for arrays that are to be utilized in array-based assays or processes. FIG. 8A illustrates a top-down view of a fluidic vessel formed from a solid support 800. The fluidic vessel comprises a chamber or channel that lies within an area delineated by the boundary 804. A first port 802 and a second port 803 provide fluidic communication between the channel or chamber and an external environment or fluidic system that may be connected to the fluidic vessel. In the depicted configuration, the first port 802 and the second port 803 are provided at substantially opposite ends of the channel or chamber along an axis that is substantially parallel to the depicted x-axis. Accordingly, a flow of fluid from the first port to the second port would be assumed to have a bulk flow that is also aligned with the depicted x-axis. The fluidic vessel further comprises an array of sites 805 that are provided on a surface within the channel or chamber.

The geometry of the fluidic vessel depicted in FIG. 8A may be defined in part by several dimensions. The average or maximum length of the flow region (i.e., the portions of the channel or chamber where fluid flow is possible), L_{fr}, may be defined as the distance between parallel axes A and A′. Additionally, it may be useful to define a length of the flow region containing the array, hereinafter the array region, Lₐᵣ, as the maximum or average distance between axes B and B′. Likewise, the average or maximum width of the flow region, w_{fr}, may be defined as the distance between parallel axes D and D′. Additionally, it may be useful to define a width of the flow region containing the array, war, as the maximum or average distance between axes C and C′. In some configurations, a margin 809 having a width, wₘ, may exist between the array of sites 805 and the boundary 804 of the channel or chamber. Such a margin 809 may be provided due to decreased fluid and/or mass transport near solid boundaries (e.g., no-slip boundary conditions during laminar flow), thereby inhibiting momentum or mass transport processes to array regions close to the boundary 804.

Depending upon the morphology and/or geometry of the channel or chamber of a fluidic vessel and the location of ports, it may be useful to define multiple regions of the channel or chamber based upon differences in the velocity profile of fluid flow within each individual region. For the channel or chamber geometry illustrated in FIG. 8A, the terminal ends of the flow region may be defined by spatial and/or temporal variations in flow. For example, if a fluid is delivered to the first port 802, there might be a first region 850 where, due to expansion in the y-axis direction, the velocity profile of the fluid flow varies in both the y-axis and x-axis directions (as well as an unseen z-axis direction). Likewise, if the fluid is discharged through the second port 803, there might be a second region 851 where, due to compression in the y-axis direction, the velocity profile of the fluid flow varies in both the y-axis and x-axis directions (as well as the unseen z-axis direction). Further, there may be a region of the chamber or channel where the fluid flow, assuming steady-state delivery and/or discharge of fluid to the channel or chamber, has a steady-state velocity profile. Such a velocity profile may be characterized as only varying in the y-axis direction (as well as the unseen z-axis direction). Optionally, the array of sites 805 may be disposed within the channel or chamber in a portion of the flow region characterized by a steady-state velocity profile during steady-state fluid delivery and/or discharge. In some cases, all sites of the array of sites 805 may be disposed within a portion of the flow region having a steady-state velocity profile. In other cases, some sites of the array of sites may be disposed within a portion of the flow region having a non-steady state velocity profile.

Turning to FIG. 8B, a cross-sectional view of the fluidic vessel of FIG. 8A is shown. The fluidic device may include a chamber 852 bound by a first barrier 800 and a second barrier 810. In some configurations, the the first barrier 800 is provided by a first solid support and the second barrier 810 is provided by a second solid support. The first barrier 800 may have a first surface 812 that forms a first portion of the boundary 804 enclosing the channel or chamber, and the second barrier 810 may have a second surface 811 that forms a second portion of the boundary 804. In some cases, the first surface 812 and the second surface 811 may be planar and substantially opposed (i.e., substantially parallel to each other). In other cases, the first surface 812 or the second surface 811 may be curved or otherwise not parallel or opposed to the other surface. In some cases, the first surface 812 or the second surface 811 may be substantially planar. In particular cases, the first surface 812 and the second surface 811 may be substantially planar. In some cases, the array of sites 805 may be disposed on the first surface 812 or the second surface 811. In some cases, a first array of sites may be disposed on the first surface 812 and a second array of sites may be disposed on the second surface 811.

Returning to FIG. 8B, the chamber 852 of a fluidic vessel may comprise volumes characterized by spatially- and/or temporally variable fluid velocity profiles (shown as 850 and 851) and at least a volume characterized by a steady-state fluid velocity profile. The chamber 852 may be characterized by one or more height dimensions. For example, a channel or chamber may have a maximum or average height near a port 802 or 803, hₚᵣ, or a maximum or average height at the array region, hₐᵣ. In some cases, hₚᵣ and hₐᵣ may be substantially the same. In other cases, hₚᵣ and hₐᵣ may differ.

Returning to FIG. 8B, the first port 802 and the second port 803 are shown to provide fluidic communication through fluidic passages 822 and 823, respectively. Fluidic passages 822 and 823 are depicted as passing through the first solid support 800. In other cases, the fluidic passages 822 and 823 could be provided through the second solid support 810, thereby providing ports 802 and 803 on the second surface 811. Alternatively, fluidic ports could be provided through the vertical walls 891 that enclose a portion of the boundary 804 of the channel or chamber.

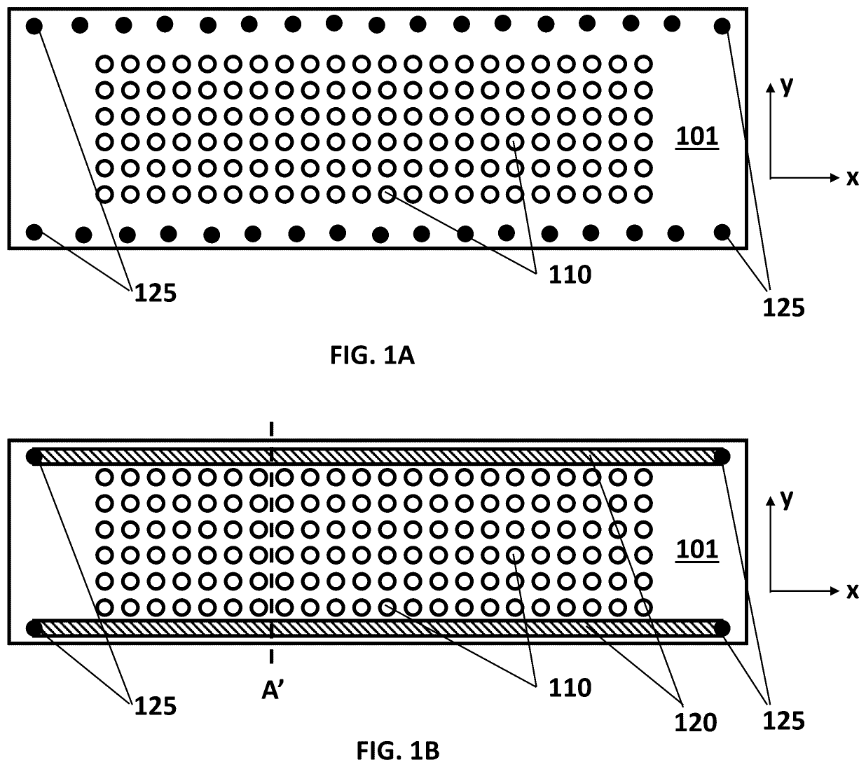

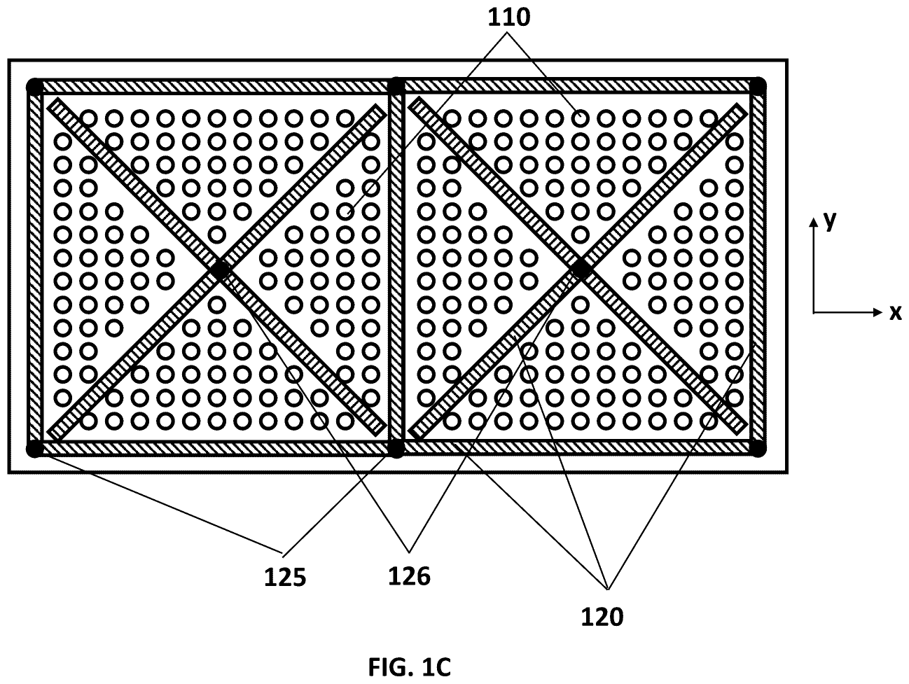

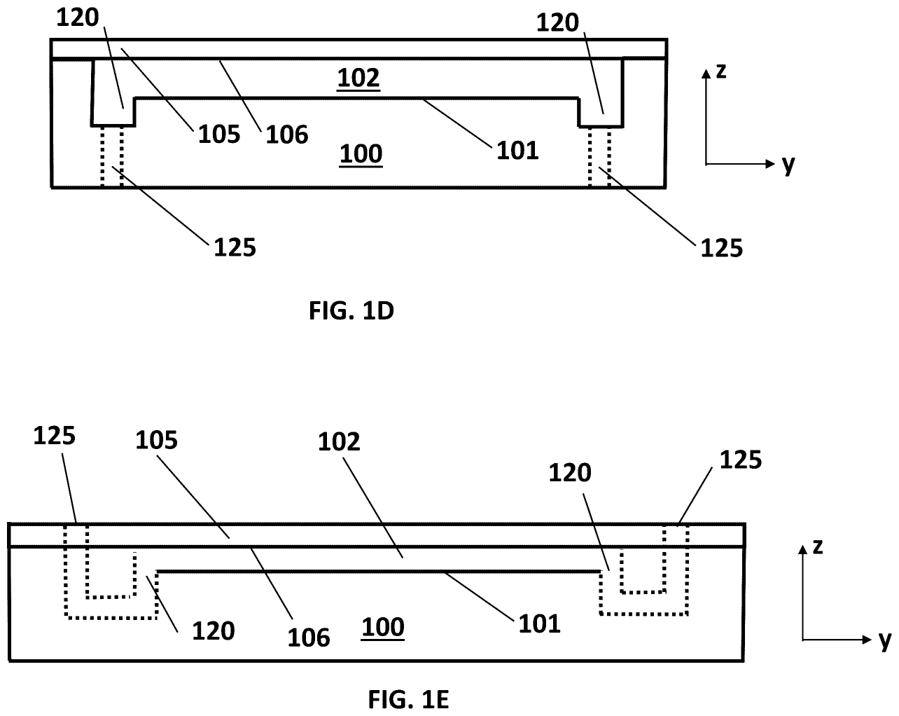

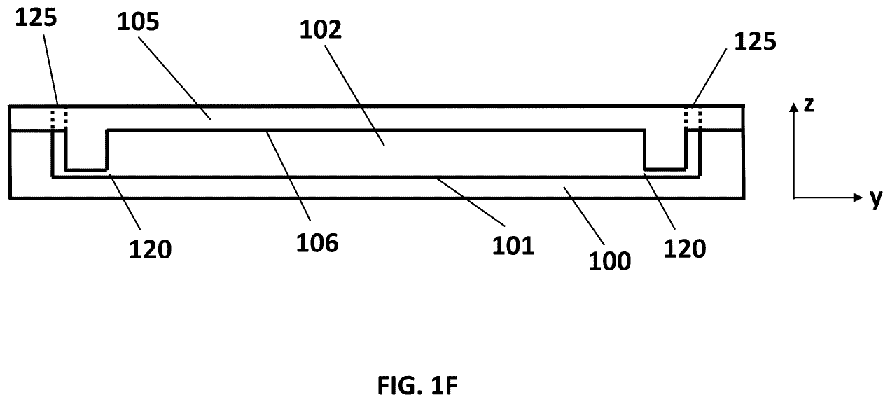

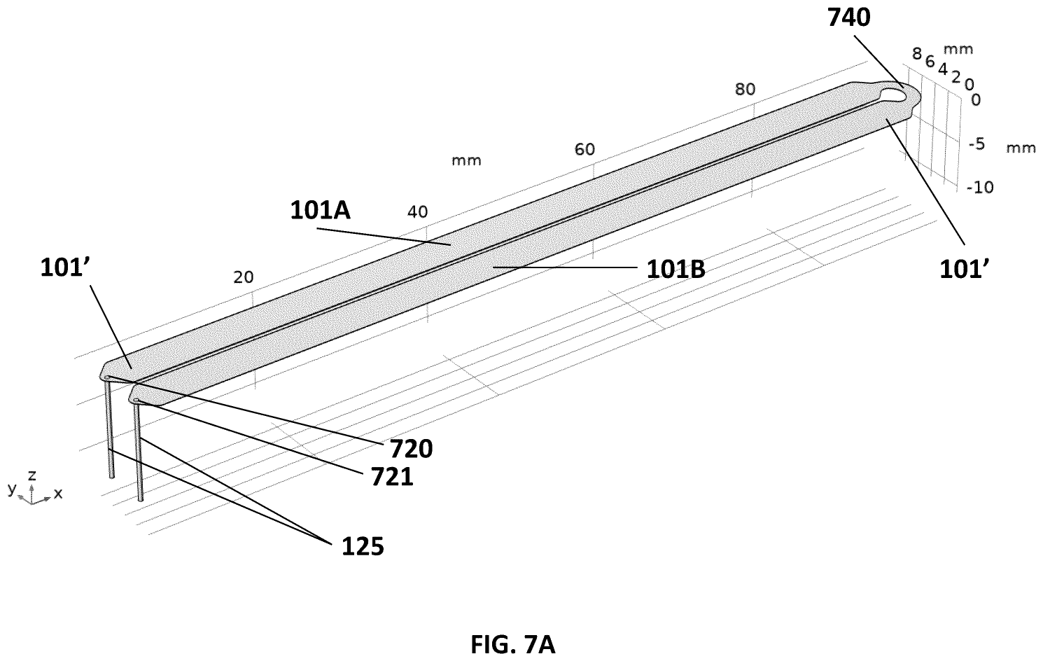

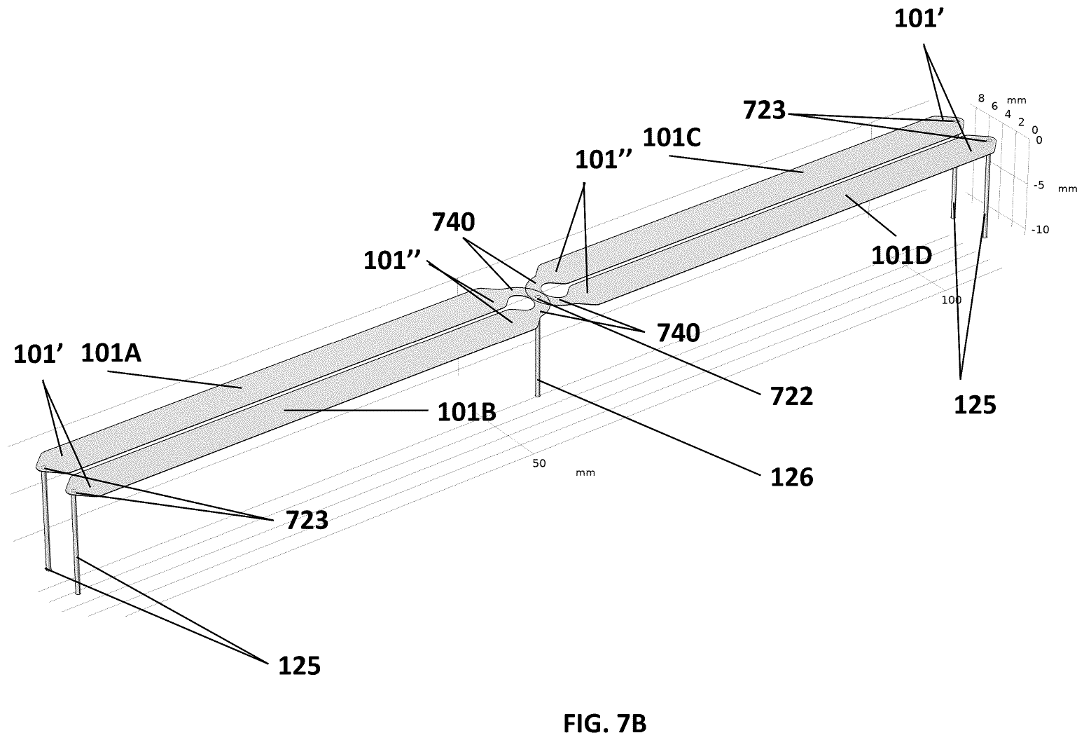

The skilled person will recognize numerous variations to the fluidic vessel. For example, the fluidic vessel may comprise additional channels and/or chambers (see for example FIG. 7, in which the fluidic device comprises two array-containing chambers connected by a curved channel). FIGS. 1A-7B and FIG. 9A-9B illustrate various additional features that may be combined with some or all of the features of the fluidic vessel of FIGS. 8A-8B to form useful fluidic vessels, particularly for array-based assays or processes.

In some cases, a fluidic vessel may contain an elongated chamber or channel. An elongated chamber or channel may be characterized as having a length in a direction of bulk flow that is longer than the width and/or the height of the chamber or channel. Accordingly, the chamber or channel may be characterized by an aspect ratio of the maximum or average length in the direction of bulk flow to the maximum or average width or to the maximum or average height, in which the aspect ratio is greater than 1. For example, a 10 millimeter (mm) long channel with a 1 mm width would have an aspect ratio of 10.

For a fluidic vessel with an elongated chamber or channel, the pressure drop to produce fluid flow through the chamber or channel will have a proportionality to the average distance that the fluid must be transferred. Assuming a fixed length and width for a chamber or channel and a maximum achievable pressure drop (e.g., due to pump performance), increased flow speed can be primarily achieved through increased channel height, thereby increasing the overall volume of the channel or chamber. Provided herein are fluidic vessel architectures that can reduce channel or chamber volume, thereby reducing the necessary volume of a fluid that must be delivered to the fluidic vessel or reducing the time required to deliver a fixed volume to the fluidic vessel.

A fluidic vessel comprising an elongated chamber or channel may comprise an array, as set forth herein, disposed within the elongated chamber or channel. Optionally, the array may also comprise an aspect ratio of greater than 1 (for example as measured by a ratio of the length to width of an area containing the array). In some cases, the longer aspect of an array may be oriented in substantially the same direction as the primary direction of fluid flow. In other cases, the longer aspect of an array may be oriented at an angle or orthogonal to the primary direction of fluid flow.

It may be advantageous to provide a fluidic vessel containing an elongated chamber or channel, in which the fluidic vessel is configured to produce a primary flow direction in a shorter path (e.g., across the shorter width or height of the chamber or channel) rather than a longer path (e.g., along the longer length of the chamber or channel). FIGS. 1A-1F provide examples of fluidic vessels that are configured to produce a primary fluid flow direction along a shorter aspect (e.g., width or height) of a chamber or channel of the fluidic vessel.

FIGS. 1A-1C depict top-down views of solid support configurations that may be configured to produce flow across a shorter aspect of a chamber or channel of a fluidic vessel containing the solid support. FIG. 1A depicts a surface of a solid support 101 that is elongated in a direction along the x-axis. The surface of the solid support 101 comprises an array of sites 110, in which the area of the surface of the solid support 101 surface occupied by the array of sites 110 is also elongated along the x-axis direction. The surface of the solid support 101 also has plurality of ports 125 that are provided in two groups that are oriented in the x-axis direction. Depending upon the configuration of the chamber or channel of a fluidic vessel, a group of ports may be provided in a margin adjacent to a boundary of the chamber or channel. In the configuration of FIG. 1A, one group of ports 125 may be inlet ports (i.e., configured to have fluid delivered to the inlet ports) and another group of ports may be outlet ports (i.e., configured to discharge fluid from the chamber or channel). Accordingly, the direction of fluid may be primarily oriented from the axis of a first group of ports to the axis of a second group of ports. For the configuration of FIG. 1A, the primary direction of fluid flow would be in the y-axis direction, thereby driving fluid across the width of the array of sites 110. Likewise, the fluidic vessel configuration of FIG. 1A would have spatially variable velocity profiles in the x-axis and y-axis direction in the immediate vicinity of the ports 125, but may have a substantially steady-state velocity profile in the y-axis direction in the region containing the array of sites 110.

FIG. 1B depicts an alternative configuration of the fluidic vessel depicted in FIG. 1A, in which the group of ports is replaced with two substantially parallel channels 120, and in which each channel 120 has one or more ports 125 that provide fluidic communication to the channel 120. The channel 120 has a depth that lies below the level of the surface of the solid support 101. Optionally, the channels may be machined, etched, or otherwise formed into the surface of the solid support 101. Similar to the configuration of FIG. 1A, the primary direction of fluid flow would be in the y-axis direction. However, because fluid transfer through the channel or chamber of the fluidic vessel occurs by overflow from one of the channels 120 onto the surface of the solid support 101, the velocity profile may be substantially steady-state over a larger region of the channel or chamber of the fluidic vessel.

FIG. 1C depicts an alternative configuration of FIG. 1B, in which an array of sites 110 are divided into subarrays by channels 120 disposed as dividers between the subarrays. In this configuration, the crossed channels 120 have a central port 126 that delivers fluid into or discharges fluid from the channels 120. The array of sites 110 is further bounded by additional channels 120 that have ports 125 for fluidic communication. In this configuration, the average path length of fluid flow is shortened to the average distance of fluid flow across the triangular subarrays.

FIG. 1D displays a cross-sectional view of a fluidic vessel comprising a solid support similar to the one shown in FIG. 1B, for example a cross-section of a device along axis A′ of FIG. 1B. The fluidic vessel may comprise a chamber 102 in a void space. Optionally, the chamber 102 may be formed by joining a first solid support 100 to a second solid support 105. Optionally, two or more pieces may be joined to form a fluidic vessel with an enclosed chamber 102. Alternatively, a chamber, channel, or void space may be formed within a fluidic vessel by a material removal process such as boring or etching. The first boundary 100 has a first surface 101 that contacts the chamber 102, and the second boundary 105 has a second surface 106 that contacts the chamber 102 such that the first surface 101 and the second surface 106 are substantially parallel and opposed. The boundary 100 further comprises channels 120 that are adjacent to the side boundaries of the chamber 102. The channels 120 are inset into the boundary 100 such that the bottoms of the channels have a lower z-axis height than the z-axis height of the first surface 101. Fluidic passages 125 facilitate delivery of fluid to or discharge of fluid from the channels 120.

FIG. 1E depicts an alternative configuration of the fluidic vessel shown in FIG. 1D. The vessel of FIG. 1E has fluidic passages 125 provided through the second solid support 105, in which the passages 125 have a substantially U-shaped path to the ports 120. FIG. 1F depicts an additional alternative configuration of the vessel of FIG. 1D, in which the fluidic passages 125 deliver fluid to ports that are located at substantially the same z-axis height as the first surface 101. The configuration of FIG. 1E may rely upon a similar mechanism of channel overflow as utilized with the vessel of FIG. 1D to provide fluid transfer through the chamber or channel 102. Alternatively, fluid transfer of the fluidic vessel of FIG. 1F may be controlled by delivery through and discharge into the narrow ports 120. If the width and/or height of the port 120 is sufficiently small, a mechanism such as capillary wetting may hold a fluid in the fluidic passage 125 in hydrostatic equilibrium until a hydraulic pressure is provided to overcome the capillary tension. In some cases, it may be useful to provide a coating to the fluidic passage 125 to facilitate capillary wetting of the surfaces of the passage 125 by a fluid.

In an aspect, provided herein is a fluidic vessel, comprising: a) a solid support, wherein a surface of the solid support comprises an array, wherein the array comprises a plurality of sites, wherein the surface of the solid support has an average length and an average width, and wherein the average length of the surface of the solid support is greater than the average width of the solid support, b) a first channel in the solid support, wherein the first channel is disposed adjacent to a first side of the array, and c) a second channel in the solid support, wherein the second channel is disposed adjacent to a second side of the array, wherein the second side differs from the first side, wherein an average separation distance between the first channel and the second channel is less than the average length of the surface of the solid support.

Configurations of fluidic vessels like those provided in FIGS. 1A-1E may also advantageously provide a substantially uniform velocity profile with respect to the x-axis direction (not seen in FIGS. 1A-1E). If channels 120 or rows of ports 125 are provided along an elongated aspect of a fluidic vessel, filling of the channels or ports with a fluid may facilitate delivering the fluid across the surface 101 or 106 of the fluidic vessel with a substantially uniform velocity profile in a direction orthogonal to the primary direction of fluid flow. In some cases, a length of an array of sites 110 may be shorter than a length of a channel 120 or row of ports 125 along the array of sites 110, thereby facilitating formation of a substantially uniform velocity profile as a fluid flow across the array of sites 110.

Pressure drop necessary to drive fluid flow through a fluidic vessel containing an elongated chamber or channel may also be reduced by reducing the length of the chamber or channel. FIG. 7A depicts a first configuration of a fluidic vessel having two chambers, 101A and 101B, that are fluidically connected by a narrower channel 740. Fluid may be delivered through a fluidic passage 125 into the first chamber 101A by flowing through port 720. The fluid can flow through the first chamber 101A into the channel 740, then continue through the second chamber 101B until discharging through port 721 into an outlet fluidic passage 125. Given the doubled pathway through two chambers and the flow constriction of the channel 740, the pressure drop of transporting a fluid through the fluidic vessel of FIG. 7A may be more than twice the pressure drop of transporting a fluid through a single chamber (e.g., 101A or 101B). FIG. 7B depicts an alternative configuration of the fluidic vessel of FIG. 7A, in which fluid transport through the vessel occurs via a central port 722. The central port 722 may be configured as an inlet or outlet for fluid. Assuming the central port 722 is an inlet, fluid may be delivered through fluidic passage 726 to the central port 722, then flow toward the four outlet ports 723. The fluid would exit the fluidic vessel through fluidic passages 725. Each chamber (101A, 101B, 101C, and 101D, respectively) can fluidically communicate with the central port 722 through one of the four narrower channels 740. The longest flow path that a fluid would travel through the vessel of FIG. 7B, assuming equivalent overall length of the vessel as the vessel of FIG. 7A and equivalent volumes, is about 25% of the fluid path length of the vessel of FIG. 7A. This can reduce the necessary pressure drop to drive fluid through the vessel of FIG. 7B relative to the vessel of FIG. 7A.

A fluidic vessel configuration may achieve fluid flow through a flow region with a reduced necessary pressure drop, or may facilitate a greater volumetric flow rate for a fixed pressure drop. In some cases, a size of a surface of a fluidic vessel may be determined based upon a necessary surface area to provide an array of sites. Accordingly, a chamber or channel containing an array of sites of a fluidic vessel configuration provided herein may have a fixed length and/or width, but the chamber or channel volume can be reduced with respect to height without requiring an increased pressure drop to provide a particular fluid volumetric flow rate. In an aspect, provided herein is a fluidic vessel, comprising a first port, a second port, and a channel disposed between the first port and the second port, wherein the channel is bounded by at least one substantially planar surface, wherein an array comprising a plurality of sites is disposed on the substantially planar surface, and wherein the channel has an average dimension between the substantially planar surface and an opposing surface in an orthogonal direction relative to the substantially planar surface of no more than about 100 microns (e.g., no more than about 90, 80, 70, 60, 50, 40, 30, 20, 15, 10, 5, or less than 5 microns).

A fluidic vessel (e.g., the branched fluidic vessel of FIG. 7B) may be readily combined with other fluidic vessel structures set forth herein. FIGS. 7A and 7B depict flow transitional regions 101′ (e.g., regions immediately downstream of ports or channel entrances or exits) at certain points within the flow regions of the depicted fluidic vessels. It may be advantageous to provide a structure (e.g., a curved surface, an offset structure, a baffled structure), as set forth herein, to facilitate formation of a substantially uniform fluid velocity profile in the chamber or channel (e.g., 101A, 101B, 101C, 101D) containing the structure.

Fluidic vessels, including microfluidic devices, may experience regions of low fluid speed or stagnant fluid flow. Such near-zero speed flows may occur adjacent to surfaces of a chamber or channel of a fluidic vessel, as well as in corners or other areas that inhibit momentum transfer in a flowing fluid. In particular, microfluidic devices can have creeping flow or laminar flow with substantially no slip at surfaces forming boundaries of a chamber or channel within the microfluidic device. Stagnant flow may facilitate increased residence times for moieties adjacent to a surface, or may facilitate unwanted binding of said moieties to the surface. For example, in the fluidic vessel configuration depicted in FIG. 8B, fluorescently-labeled moieties in a fluid flowing through the chamber of channel 852 may bind to the second surface 811 in part due to substantially no-slip flow along the second surface 811. Unwanted binding of fluorescent moieties on the second surface 811 can adversely affect the accuracy of a fluorescence detection assay.

Accordingly, it may be useful to provide fluidic vessels with configurations that reduce fluid stagnation at one or more boundaries of a chamber or channel of the fluidic device. Some fluidic vessel configurations provided herein include at least one moveable boundary that is configured to generate mass transfer of moieties adjacent to the moveable boundary, thereby eliminating phenomena associated with stagnation of moieties at the surface of the boundary. In some cases, a moveable boundary may be formed by solid particles that are transferred along a surface of a chamber or channel of a fluidic vessel. In other cases, a moveable boundary may be formed by simultaneously flowing a first fluid that is substantially devoid of moieties (e.g., macromolecules or other assay reagents) with a second fluid containing the moieties, in which a flowing layer of the first fluid inhibits contact of the second fluid to a surface of a chamber or channel of a fluidic vessel.

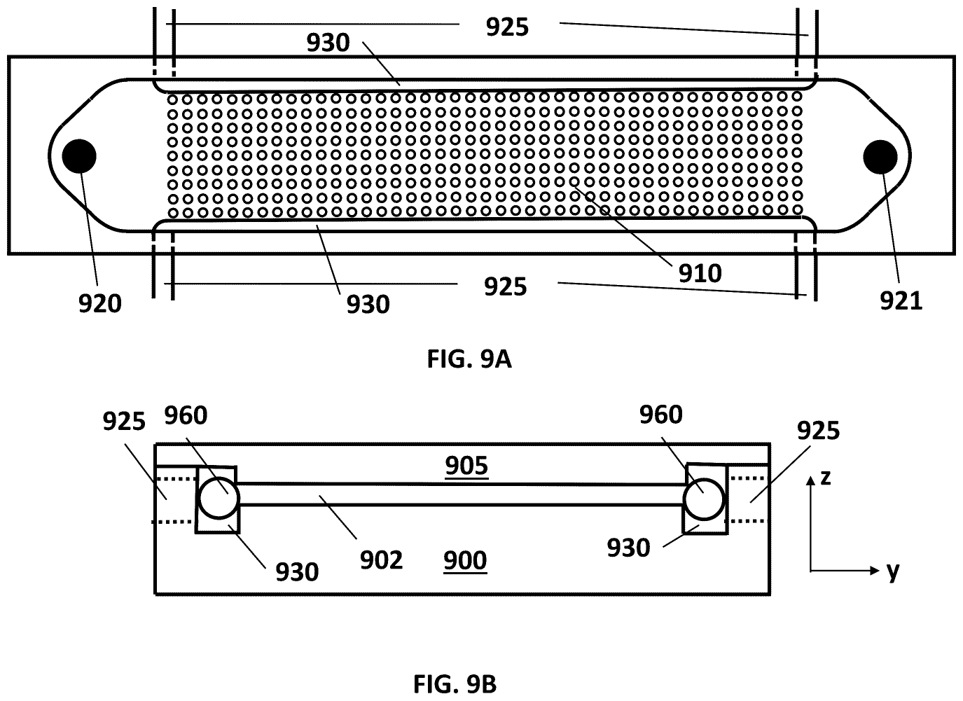

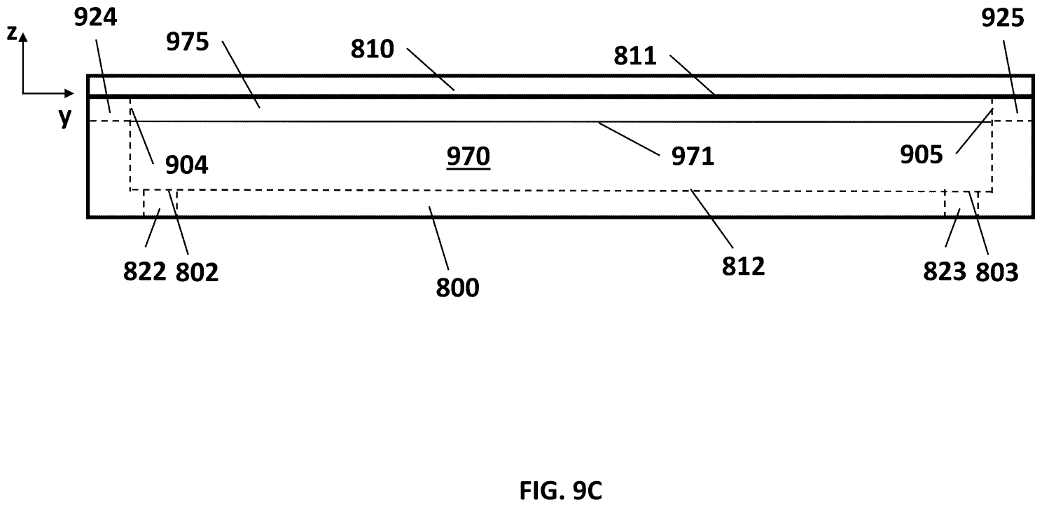

FIGS. 9A-9C illustrate fluidic vessel configurations that may be useful for providing at least one moveable boundary to a chamber or channel of a fluidic vessel. FIG. 9A depicts an alternative configuration of the solid support depicted in FIG. 8A, in which the solid support further comprises two channels 930 that are configured similarly to the channels depicted in FIG. 1B. The channels 930 are in fluidic communication with an external system or environment by fluidic passages 925. The channels are disposed adjacent to an array of sites 910 that is disposed on the surface of the solid support. A first fluid can be delivered to the chamber or channel of the fluidic vessel through fluidic passages 925, thereby creating a flow of the first fluid through the channels 930. The solid support further comprises a first port 920 and a second port 921 that are configured to provide a flow of a second fluid comprising moieties (e.g., macromolecules or other assay reagents) across the array of sites 910. In a first preferable configuration, the first fluid may comprise a fluid that is substantially immiscible with the second fluid (e.g., a non-polar first fluid contacted to a polar second fluid). In a second preferable configuration, the first fluid may comprise a plurality of particles (e.g., beads) that are transported through the channels 930 by a flow of the first fluid.

FIG. 9B depicts a cross-sectional view of a fluidic device that incorporates a solid support like that depicted in FIG. 9A. In the depicted configuration, particles 960 may be delivered into a channel 930 of the fluidic vessel by flow through a fluidic passage 925. In some configurations, the size of the particles (e.g., the diameter of the particles) may be sufficiently large or the average height of the chamber or channel 902 of the fluidic vessel may be sufficiently small to prevent the particles 960 from entering into the chamber or channel 902. The movement of the particles 960 through the channel 930 will form a moveable boundary along the sides of the chamber or channel 902 adjacent to the arrays.

FIG. 9C depicts a cross-sectional view of an alternative configuration of a fluidic vessel, in which a moveable boundary may be formed along a surface of a chamber or channel of a fluidic vessel. The depicted fluidic vessel is a configuration of the vessel depicted in FIG. 8B. FIG. 9C depicts additional fluidic passages 924 and 925 that are provided adjacent to the coupling between the first solid support 800 and the second solid support 810. A first fluid can be delivered through fluidic passage 924 to port 904 and discharged through port 905 to fluidic passage 925. In the shown configuration, the first fluid can form a flowing fluid layer 975 adjacent to the surface 811 of the second solid support 810, provided the first fluid is buoyant or immiscible with a second fluid that is transferred from port 802 to port 803. Alternatively, the first fluid can comprise particles that are buoyant, thereby forming a flowing layer of particles along the surface 811 of the second solid support 810. It will be readily recognized that the location of ports 924 and 925 can be shifted to form a layer of fluid adjacent to differing surfaces of the chamber or channel of the fluidic vessel. For example, a layer of the first fluid can be formed adjacent to the surface 812 of the first solid support 800 if the first fluid or particles contained therein are of a higher density than the second fluid. Providing a flowing layer adjacent to the surface 812 may employ delivery of the second fluid through ports in the second solid support 810. In some cases, a defined interface 971 may be formed between the first fluid 975 and the second fluid 970. The interface may form an effective boundary beyond which transport of moieties from the second fluid 970 is limited.

In some cases, a moveable boundary may be formed by providing magnetically-charged or electrically-charged particles to a fluidic vessel, as set forth herein. A presence of a magnetic or electrical field, as appropriate can be utilized to draw said particles to a surface of a chamber or channel of a fluidic vessel and/or transport the particles along the surface of the chamber or channel, thereby forming a moveable boundary.

It will be recognized that moveable boundaries formed by contact of a first fluid to a second fluid may preferably arise from the contact of two immiscible fluids. Preferably, the multi-fluid system may be selected for the properties of: 1) having a first fluid that is substantially immiscible with a second fluid, and 2) having a first fluid that has minimal solubility for moieties contained within the second fluid. Alternatively, a first fluid containing particles can contact a second fluid containing moieties to form a moveable layer of particles, in which the first fluid and the second fluid contain miscible solvents, and in which the particles are organized by a phenomenon such as buoyancy, magnetic attraction, electrical attraction, or a combination thereof. It will be further recognized that miscibility of a first fluid with a second fluid may be, in part, a function of the contact time between the two fluids. For example, for brief contact times, a dense aqueous sugar solution may be effectively immiscible with an aqueous fluid that is substantially devoid of sugar due to the differences in density and/or viscosity limiting mixing between the two fluids.

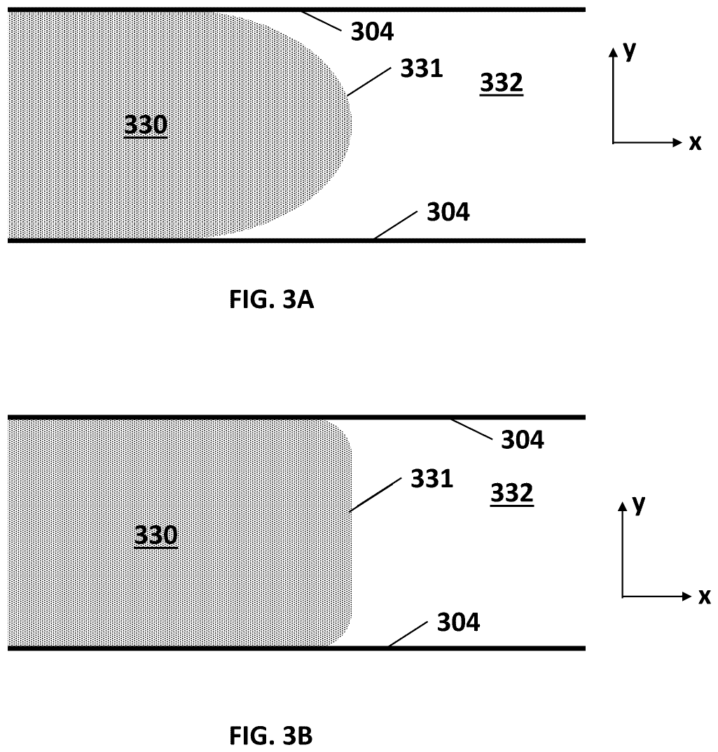

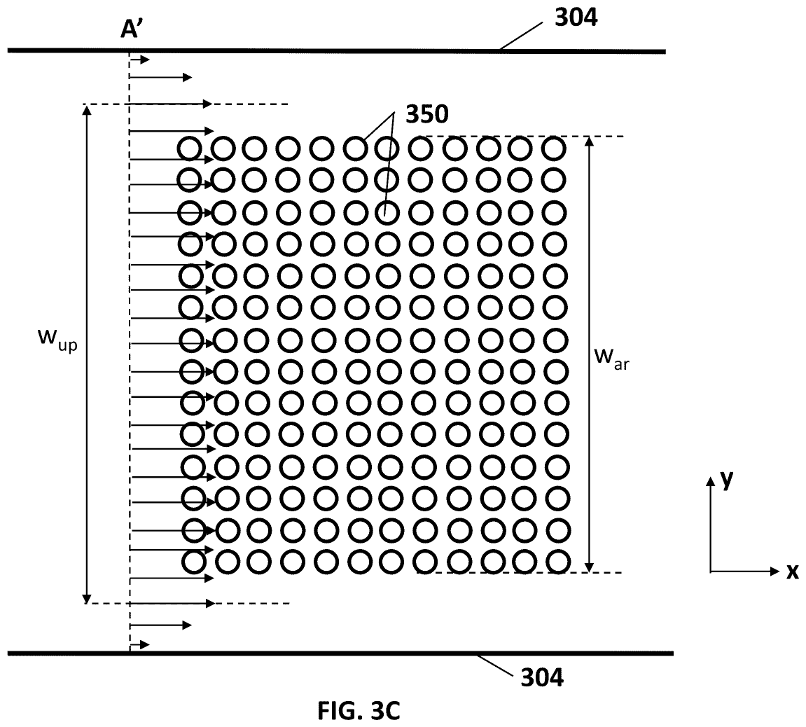

Flow of a fluid within a fluidic vessel, such as a microfluidic device, may be substantially laminar due to the length scales of the vessel, the fluid properties (e.g., density, viscosity, temperature), and the flow rate of the fluid. In some cases, laminar flow of a fluid within a closed conduit may be characterized by a substantially parabolic velocity profile (i.e., zero or near-zero speed at a solid boundary of a chamber or channel, and a maximum speed near the center of the chamber or channel). FIG. 3A displays a diagram of fluid flow within a chamber or channel bounded by boundaries 304. A flow of a second fluid 330 may displace a first fluid 332. Assuming a no-slip boundary condition at the boundaries 304, the second fluid 330 may form a velocity profile with a near-zero speed at the boundaries 304 and a maximum speed near the center of the channel or chamber. Interface 331 depicts a substantially parabolic profile at the interface between the first fluid 332 and the second fluid 330, which can represent the velocity profile of the second fluid 330 or approximate a concentration profile of the second fluid 330 as it displaces the first fluid 332 (e.g., longer time to alter the fluid composition from that of the first fluid 332 to the second fluid 330). FIG. 3A depicts the flow profile of a laminar flow between two boundaries in the x-axis and y-axis directions, but if a chamber or channel of a fluidic vessel is bounded on four sides by solid boundaries, a flow profile similar to that depicted in FIG. 3A may also be observed in other frames of reference (e.g., x-axis and z-axis flow).

In some cases, it may be preferable to provide a fluidic vessel that produces a more uniform velocity profile than the substantially parabolic profile depicted in FIG. 3A. For example, for an array contacted by the second fluid 330 of FIG. 3A, array sites nearer to the center of the chamber or channel may be contacted by the second fluid more rapidly than sites closer to a boundary 304. For time-sensitive array processes (e.g., kinetic processes such as chemical reactions or affinity reagent binding), differences in fluid contact time may produce different outcomes depending upon site location in an array. FIG. 3B depicts a fluid velocity profile that may be provided in some fluidic vessels. The interface 331 between the second fluid 330 and the first fluid 332 may be characterized by a substantially uniform velocity or concentration profile across most of the width or height of a chamber or channel of the fluidic vessel, with a change only observed adjacent to the boundaries 304. If the chamber or channel contains an array, margins may be provided adjacent to the boundaries 304 such that the velocity or concentration profile is substantially uniform in the region of the channel or chamber containing the array. Preferably, the velocity or concentration profile depicted in FIG. 3B may be provided in a substantially laminar flow regime.

FIG. 3C depicts an alternative view of FIG. 3B, in which the locations of sites 350 of an array can be seen with respect to side boundaries 304 of a fluidic vessel. Velocity vectors of a fluid flow are shown orthogonal to the trace A′ adjacent to the array of sites 350. The velocity profile is substantially uniform in the y-axis direction, with a decrease in speed only observed adjacent to the side boundaries 304. In this configuration, the width of the velocity field having a substantially uniform velocity, wᵤₚ, is observed to be at least as wide or is wider than the maximum width of the array of sites, wₐ.

A substantially uniform velocity profile may be calculated as a spatial or statistical average of the magnitude of the velocity vector of a fluid in a direction orthogonal to the bulk direction of flow. For example, as shown in FIG. 3C, the bulk direction of fluid flow is in the x-axis direction, so the velocity profile may be averaged with respect to the y-axis or z-axis direction. A velocity profile may be considered substantially uniform with respect to a portion of a fluidic vessel (e.g., a width of the fluidic vessel, a width of an array disposed within the vessel) if the average of the magnitude of the velocity vector in the portion of the fluidic vessel is at least about 60% (e.g., at least about 65%, 70%, 75%, 80%, 85%, 90%, 95%, 99%, or more than 99%) of the maximum magnitude of the magnitude of the velocity vector in the portion of the fluidic vessel.

Provided herein is a fluidic vessel comprising a surface structure, wherein the surface structure forms a substantially uniform velocity profile in a fluid in a downstream region relative to the surface structure. In an aspect, provided herein is a fluidic vessel, comprising a first port, a second port, and a channel disposed between the first port and the second port, wherein the channel is bounded by at least one substantially planar surface, wherein the fluidic vessel comprises an offset structure, wherein the first port is configured to deliver fluid to a surface of the offset structure, wherein the fluidic vessel is configured to provide a fully-developed, laminar fluid flow between the first port and the second port, and wherein the fluid flow has an average speed that is at least 70% (e.g., 75%, 80%, 85%, 90%, 95%, 99%, or more than 99%) of the maximum speed of the fluid flow. In another aspect, provided herein is a fluidic vessel, comprising a first port, a second port, and a channel disposed between the first port and the second port, wherein the channel is bounded by at least one substantially planar surface, wherein the fluidic vessel comprises a baffled structure, wherein the first port is configured to deliver fluid across the baffled structure, wherein the fluidic vessel is configured to provide a fully-developed, laminar fluid flow downstream from the baffled structure, and wherein the fluid flow has an average speed that is at least 70% (e.g., 75%, 80%, 85%, 90%, 95%, 99%, or more than 99%) of the maximum speed of the fluid flow. In another aspect, provided herein is a fluidic vessel, comprising a first port, a second port, and a channel disposed between the first port and the second port, wherein the channel is bounded by at least one substantially planar surface, wherein an array comprising a plurality of sites is disposed on the substantially planar surface, wherein the fluidic vessel is configured to provide a fully-developed, laminar fluid flow adjacent to a region of the array, and wherein the fluid flow has an average speed that is at least 90% (e.g., 95%, 96%, 97%, 98%, 99%, or more than 99%) of the maximum speed of the fluid flow.

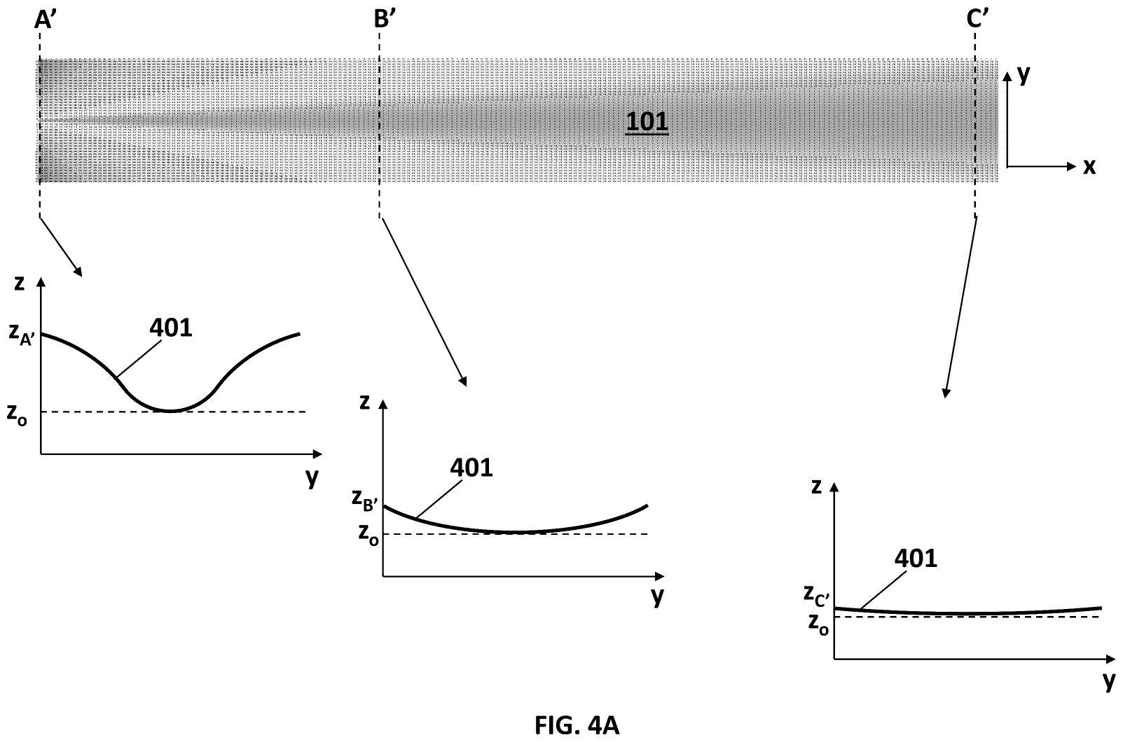

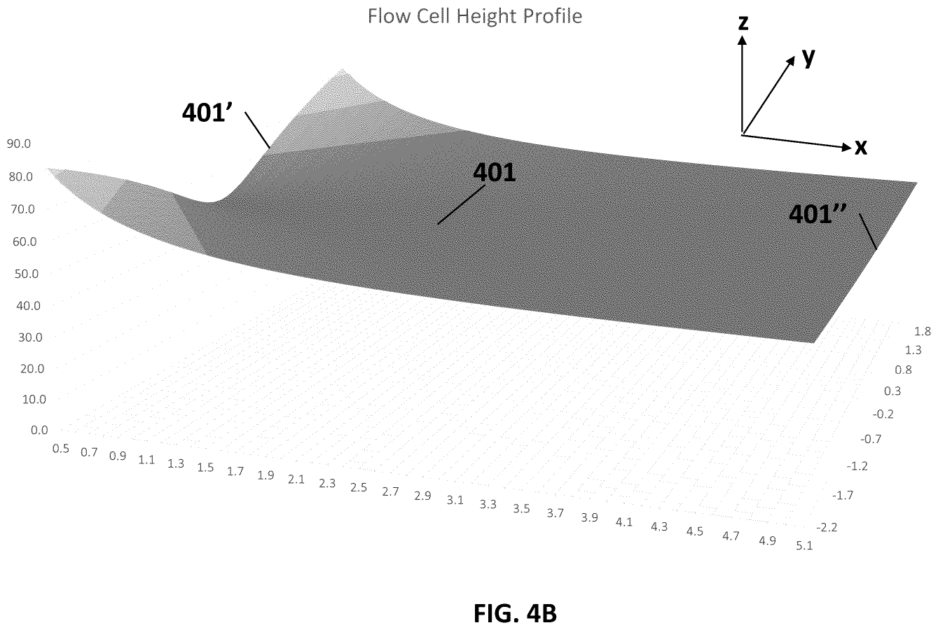

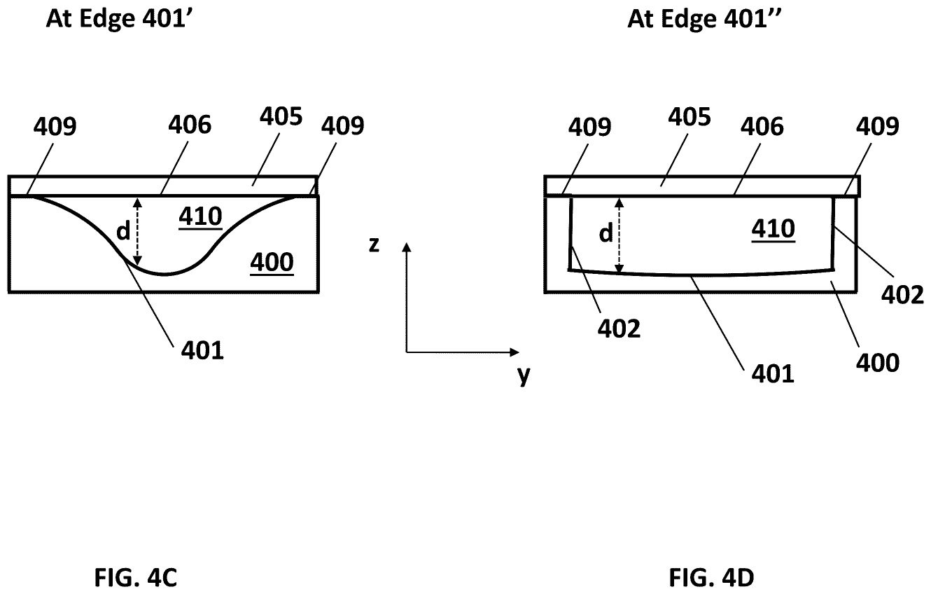

FIG. 4A depicts a surface with a continuous, curved morphology that may produce a substantially uniform velocity profile similar to the velocity profile depicted in FIG. 3B. The upper portion of FIG. 4A displays a shaded contour plot of the surface 401, with shading varying by surface height. Below the contour plot, cross-sectional surface height profiles are shown at traces A′, B′, and C′, respectively, for the surface 401. The surface 401 is observed to have a deeper, inflected profile at trace A′, and become more shallow and increasingly parabolic at traces B′ and C′. FIG. 4B displays an isometric view of the surface 401 shown in FIG. 4A. The curvature of the surface 401 is observed to be greatest along edge 401′ and flatten out to a nearly planar profile by edge 401″. The flattening and smoothing of the surface 401 occurs most rapidly adjacent to edge 401′. FIGS. 4C-4D illustrate cross-sectional views of a fluidic vessel that incorporates the surface 401 depicted in FIGS. 4A-4B. The fluidic vessel comprises a void space 410 (e.g., a chamber or channel). Optionally, the void space 410 may be bounded in part by a substantially planar surface 406 and the curved surface 401. Optionally, the void space 410 may be formed by joining a first solid support 400 to a second solid support 405, for exampling by joining (e.g., by adhesive, by thermal or laser bonding, etc.) along surfaces 409. Optionally, two or more pieces may be joined to form a fluidic vessel with an enclosed void space 410. Alternatively, a chamber, channel, or void space 410 may be formed within a fluidic vessel by a material removal process such as boring or etching. Accordingly, the height, d, of the chamber or channel 410 constantly varies across the y-axis direction of the fluidic vessel. As shown in FIG. 4D, the chamber or channel 410 at edge 401″ of FIG. 4B is bounded by a substantially planar surface 406 of the second solid support 405 and the slightly curved surface 401 of the first solid support 400, as well as two side surfaces 402. Accordingly, the height, d, of the chamber or channel 410 varies only a small amount in the y-axis direction of the fluidic vessel.

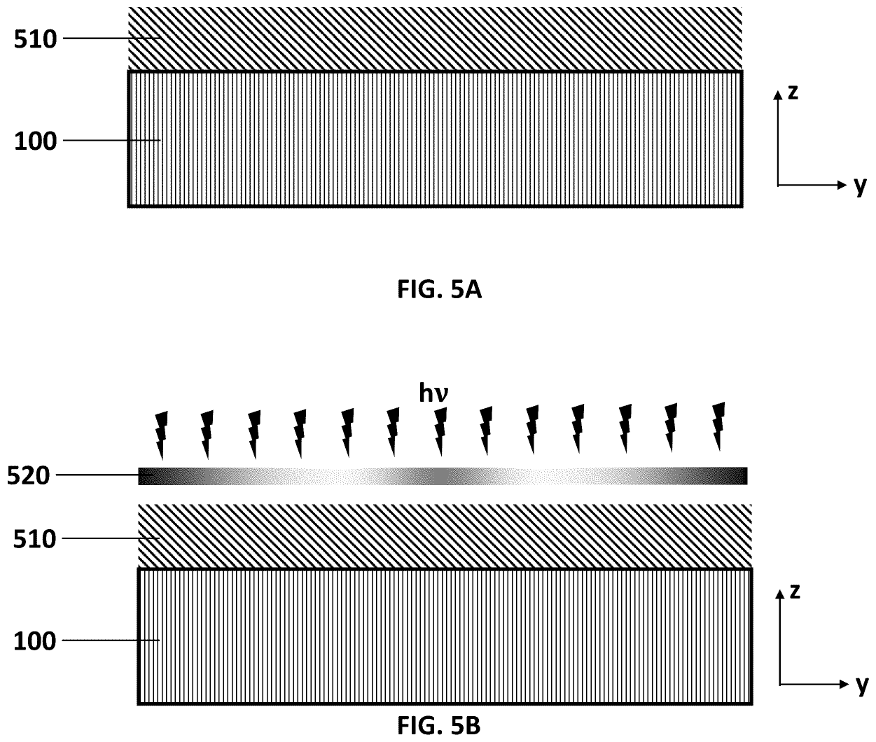

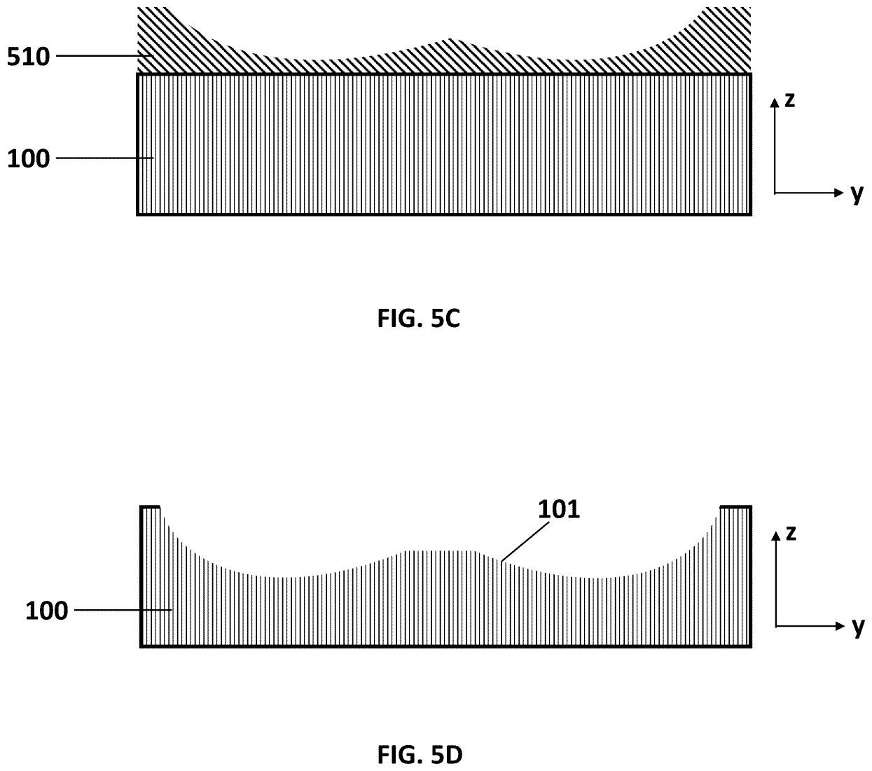

FIGS. 5A-5D illustrate a method of forming a curved surface on a solid support similar to the surface depicted in FIGS. 4A-4D. In a first step, a solid support 100 is provided with a layer of a patternable material (e.g., a photoresist). In a second step, the patternable material is illuminated in the presence of a grayscale mask 520 (e.g., a grayscale mask 520 provided on a second solid support). As shown in FIG. 5C, the spatially-variable illumination selectively removes patternable material 510 to provide a spatially-varying patternable material 510 depth on the solid support 100. In a final step, the patternable material 510 and the solid support 100 may undergo a process such as reactive-ion etching that causes spatially-variable etching of the solid support 100. Due to the reduced patternable material 510, the regions of the solid support 100 with the thinnest patternable material 510 depth will etch more rapidly, thereby forming the curved surface 101 on the solid support 100.

In an aspect, provided herein is a fluidic vessel, comprising: a) a flow region with an aspect ratio greater than 1, wherein the aspect ratio is a length of the flow region divided by a width of the flow region, b) a first surface bounding the flow region, wherein the first surface comprises a curved surface, and c) a second surface bounding the flow region, wherein the second surface comprises a substantially planar surface, wherein a cross-sectional profile of curvature of the first surface varies with the length of the flow region.

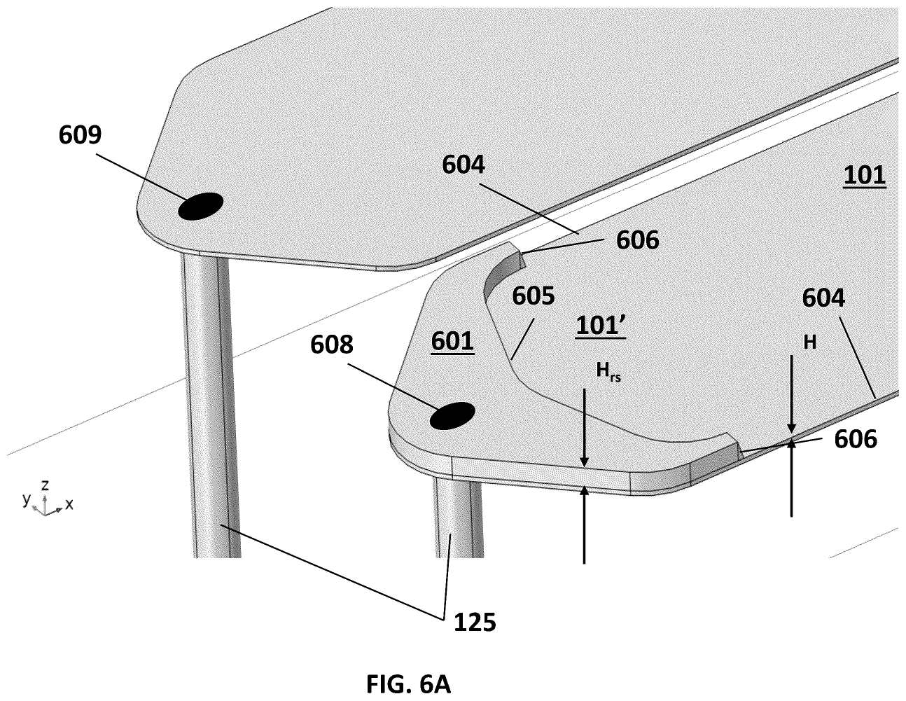

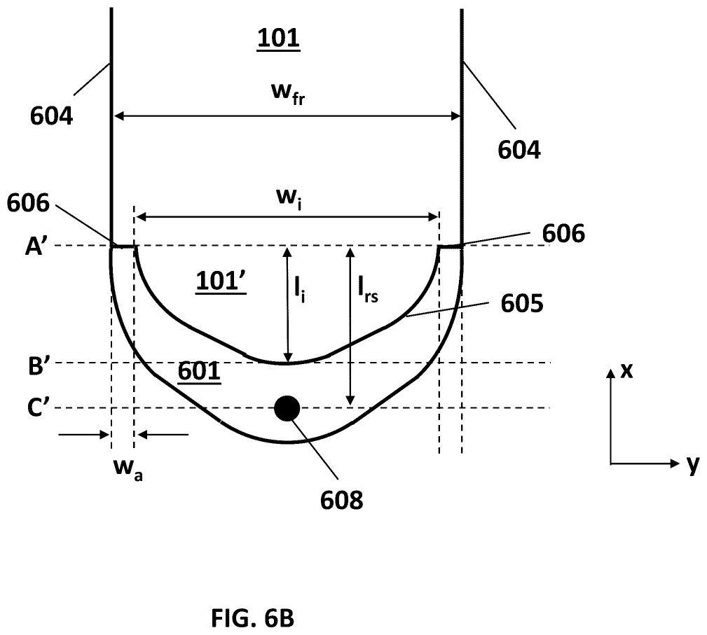

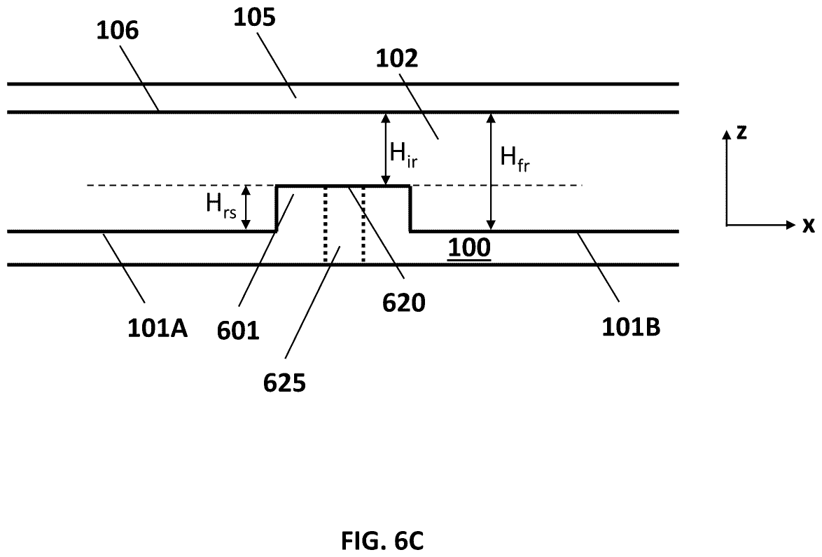

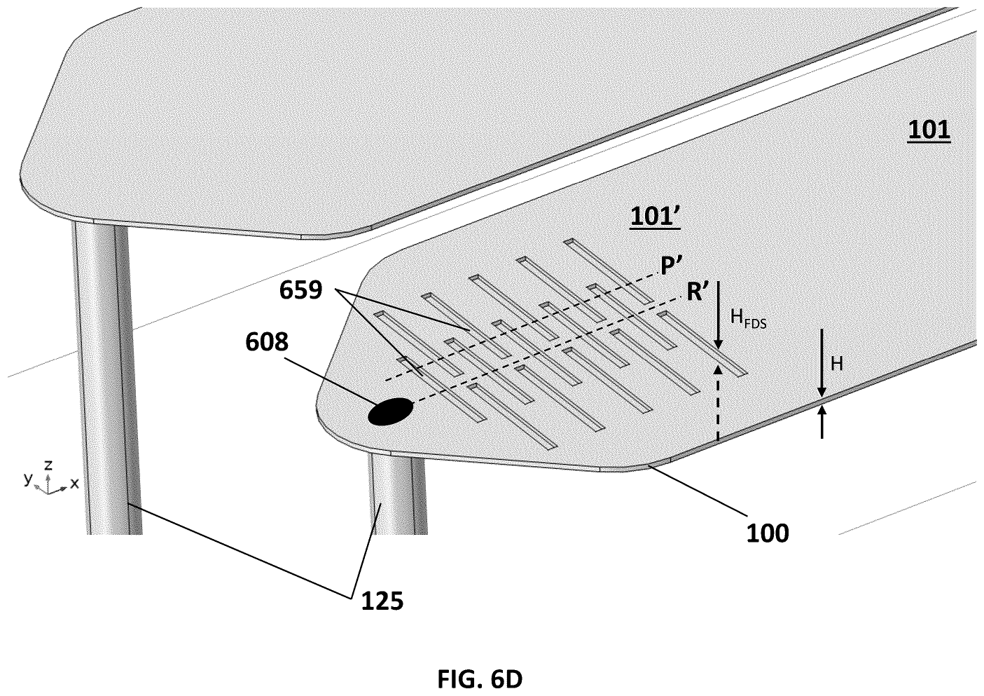

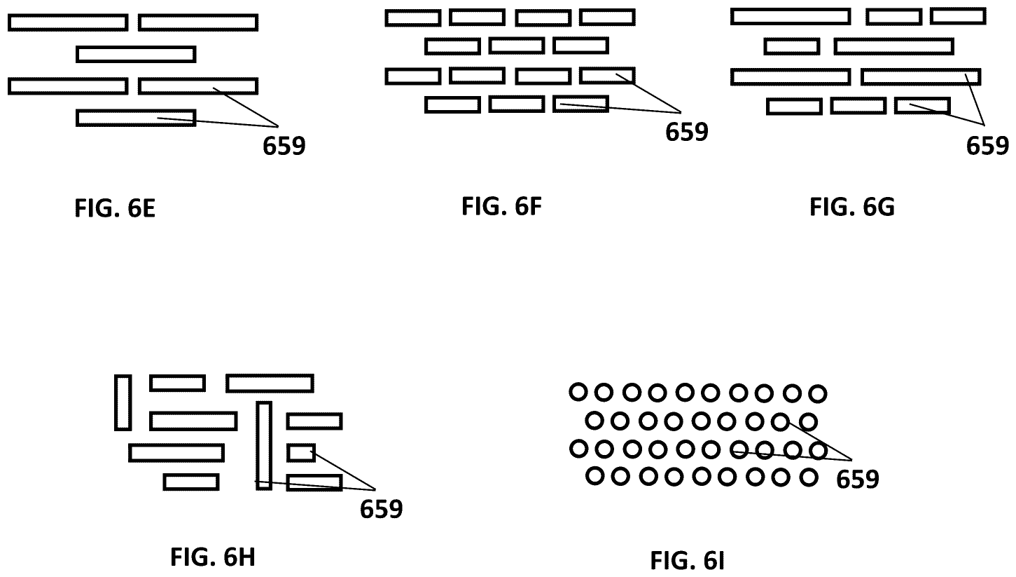

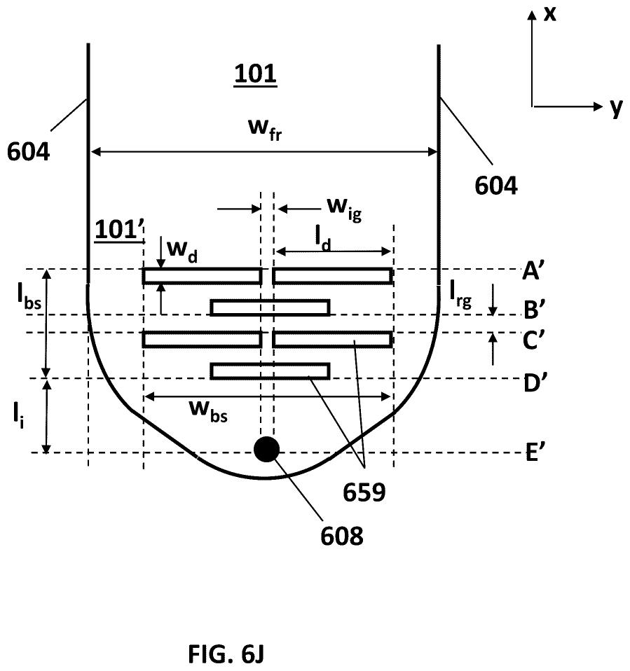

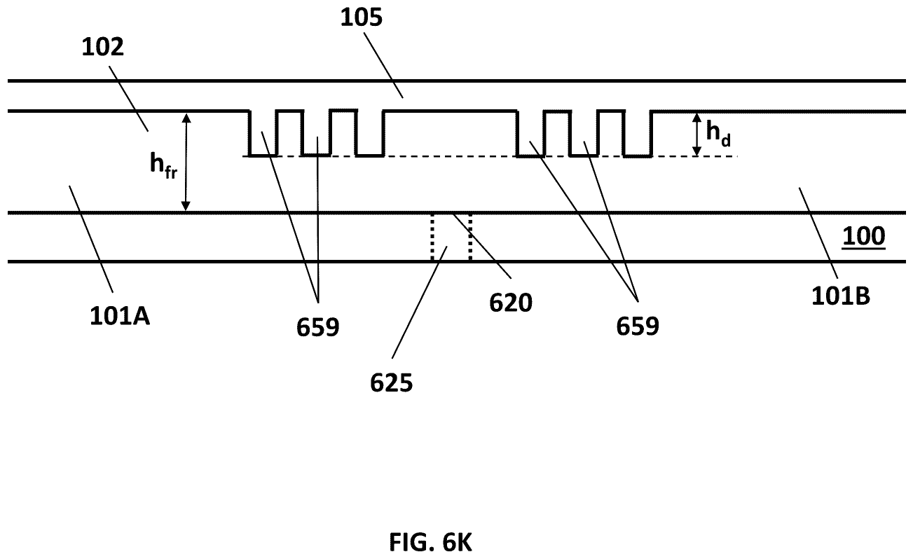

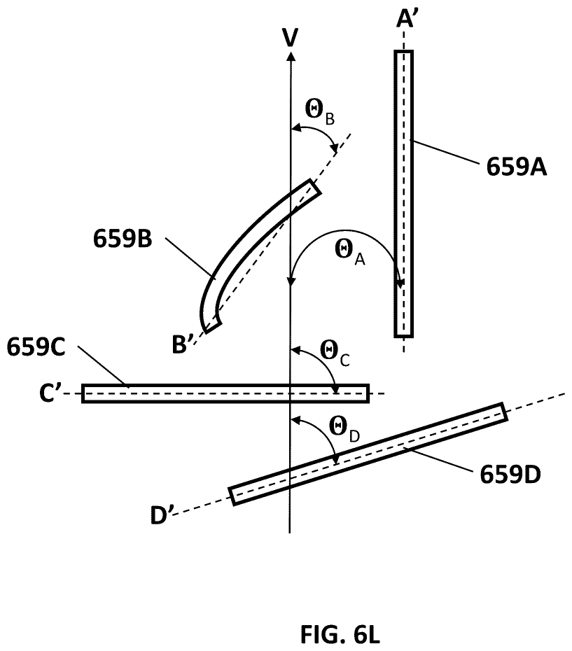

FIGS. 6A-6C illustrate aspects of a fluidic vessel structure that can provide a substantially uniform velocity profile to a fluid flow downstream from the structure. FIG. 6A provides an isometric view of an offset structure 601 provided at an inlet port that can facilitate formation of a substantially uniform velocity profile downstream from the offset structure 601. A fluidic passage 125 provides fluidic communication to a first port 608 through which a fluid may be delivered onto the surface of the offset structure 601. The fluid can flow downstream toward the second port 609. When flowing downstream, the fluid will flow off of the surface of the offset structure 601, thereby passing through a flow development region adjacent to the substantially planar surface of region 101′ where the fluid velocity profile may be disrupted from a typical laminar flow velocity profile by the fluidic effects of the offset structure 601. After flowing through the flow development region, the fluid may establish a substantially steady-state flow over the substantially planar surface 101. The steady state velocity profile may resemble the velocity profile depicted in FIG. 3B. In some cases, it may be preferable to provide an array of sites at the portion of the fluidic vessel containing the substantially planar surface 101. In some cases, it may be preferable to not provide an array of sites in the flow development region adjacent to the substantially planar surface 101′. The offset structure 601 may have an average or maximum height, Hᵣₛ, that may be measured with respect to an average, minimum, or maximum height of the downstream surface 101.

In an aspect, provided herein is a fluidic vessel, comprising: a) a flow region with an aspect ratio greater than 1, wherein the aspect ratio is a length of the flow region divided by a width of the flow region, b) a substantially planar surface bounding the flow region, and c) an offset surface comprising a port, wherein the offset surface is substantially parallel to and offset from the substantially planar surface, wherein the offset surface comprises a curved edge that spans at least a portion of the width of the flow region, wherein the curved edge is indented toward the port.

It will be understood that the offset structure is with reference to a substantially opposed boundary that encloses a chamber or channel of a fluidic vessel. Accordingly, a chamber or channel of a fluidic vessel can comprise a reduced height between the offset structure 601 and the substantially opposed boundary when compared to the height downstream from the offset structure 601. FIG. 6C depicts an offset structure 601 with an average or maximum height, Hᵣₛ, that is disposed within a channel or chamber 102 of average or maximum height H_{fr}. Accordingly, the inlet region may have an average or maximum height, Hᵢᵣ, that is a difference beween H_{fr} and Hᵣₛ.

The offset structure 601 shown in FIG. 6A can comprise a curved edge 605 that defines a transition from the surface of the offset structure 601 to a surface 101′ downstream from the offset structure 601. The curved edge 605 may be indented toward a port, and the offset structure may comprise arms 606 that extend in the downstream direction as the curved edge arcs toward the side boundaries 604 of the chamber or channel of the fluidic vessel.

FIG. 6B depicts a top-down view of the offset structure 601 and downstream flow regions of the fluidic vessel configuration illustrated in FIG. 6A. FIG. 6B provides several length scales that may characterize a geometry of the offset structure 601. The offset structure 601 may extend across at least a portion of the width w_{fr} of a chamber or channel of a fluidic vessel. The curved edge 605 of the offset structure 601 may have a width wᵢ. The width wᵢ of the curved edge 605 may be equal to (e.g., the arms 606 taper to a point at the side boundary 604) or less than (e.g., the ends of the arms 606 have a measurable width, wₐ) the width w_{fr} of the chamber or channel. The width wₐ of the termini of the arms 606 may be chosen to influence the width of a spatially-variable portion of a fluid velocity profile adjacent to a side boundary 604. For example, a wider arm terminus width wₐ may reduce the width of the velocity profile that has a substantially uniform velocity. The offset structure 601 may be provided with a curved edge 605 that is indented toward a port 608 of the offset structure 601. The maximum downstream length or distance, lᵣₛ, of the offset structure 601 may be measured as a distance in the x-axis direction between a centerpoint of the port 608 (marked by trace C′) and a furthest downstream extent of an arm 606 (marked by trace A′). The minimum downstream length or distance, lᵣₛ, of the offset structure 601 may be measured as a distance in the x-axis direction between a centerpoint of the port 608 (marked by trace C′) and a closest downstream extent of the curved edge 605 (marked by trace B′). The curved edge 605 of the offset structure 601 may be characterized by an indent depth, li, which may be measured as a distance in the x-axis direction between a deepest point of the indent (marked by trace B′) and a furthest downstream extent of an arm 606 (marked by trace A′).

FIGS. 6A-6B depict an offset structure 601 that is provided at a terminal location relative to a channel or chamber of a fluidic vessel. It will be recognized that the offset structure may also be provided in central regions of a channel or chamber of a fluidic vessel. In some cases, it may be useful to provide an offset structure 601 in a region of a chamber or channel that does not contain a port. For example, the offset structure 601 may facilitate reestablishment of a substantially uniform flow velocity profile if the velocity profile has begun to become variable or irregular in a downstream region of a chamber or channel. FIG. 6C depicts an offset structure 601 that is located within a channel or chamber 102. The channel or chamber 102 is enclosed, at least in part, by a first solid support 100 and a second solid support 105. The offset structure contains a port 620 that allows fluid to be delivered into the channel or chamber 102 through a fluidic passage 625. The fluid delivered into the channel or chamber 102 can flow bidirectionally toward downstream regions 101A and 101B. In some cases, the offset structure 601 can comprise at least two curved edges, with a first curved edge facilitating formation of a substantially uniform flow velocity profile in the direction of downstream region 101A, and the second curved edge facilitating formation of a substantially uniform flow velocity profile in the direction of downstream region 101B. In other cases, the offset structure 601 can comprise only one curved edge (e.g., to facilitate formation of a substantially uniform velocity profile in only one downstream direction). For an offset structure that provides fluid in multiple downstream directions, the curved edges may comprise the same geometry if the downstream geometries are similar, or may have differing geometries if the downstream geometries differ.

The geometry of an offset structure, such as the offset structures depicted in the fluidic vessel configurations shown in FIGS. 6A-6C, may vary based upon the overall geometry of a chamber or channel within which the offset structure is disposed. As shown in FIGS. 6B and 6C, an optimal height, Hᵣₛ, may be based in part on the average or maximum chamber or channel height, H_{fr}, and the average or maximum chamber or channel width, w_{fr}. Additionally, the distance downstream at which a substantially uniform velocity profile has developed may be based at least in part on parameters shown on FIGS. 6B-6C, such as Iᵣₛ, li, w_{fr}, wᵢ, and Hᵣₛ.

FIGS. 6D-6K illustrate aspects of another fluidic vessel structure that can provide a substantially uniform velocity profile to a fluid flow downstream from the structure. As shown in FIG. 6D, a baffled structure is disposed on a solid support in a region immediately downstream of a port 608. The baffled structure comprises a plurality of ridges 659 disposed on a surface of a solid support 100. In the configuration depicted in FIG. 6D, the ridges 659 are patterned in alternating rows of one or two ridges 659 such that each ridge 659 overlaps at least one ridge 659 in an upstream and/or downstream row. Trace R′ shows that a fluid flowing in the x-axis direction along that trace would flow over a ridge 659 in alternating rows, whereas a fluid flowing along trace P′ would flow over a ridge 659 in every row of the baffled structure.

In an aspect, provided herein is a fluidic vessel, comprising: a) a surface comprising an array of sites, wherein the surface has an aspect ratio greater than 1, wherein the aspect ratio is a length of the surface divided by a width of the surface, b) a port passing through the surface, wherein the port provides fluidic communication to the surface, and c) a baffled structure comprising a plurality of ridged structures, wherein the baffled structure is disposed in a region between the port and the array of sites.

It will be recognized that numerous configurations of baffled structures may be useful. FIGS. 6E-6I illustrate variations of baffled structures containing ridges 659 disposed on a surface of a solid support. FIG. 6E depicts an arrangement of ridges 659 in a solid support similar to the arrangement described for FIG. 6D. FIG. 6F depicts a similar staggered arrangement to FIG. 6E, but with ridges 659 that are shorter in length than those of FIG. 6E. FIG. 6G depicts a staggered plurality of ridges 659, in which the ridges 659 vary in length, and in which the spatial location of the varying ridges 659 may have a random arrangement. FIG. 6H depicts a variation of FIG. 6G, in which the ridges 659 vary in length and direction of orientation (e.g., some ridges 659 may be oriented orthogonal to a primary direction of flow, and/or some ridges 659 may be oriented along a primary direction of flow). FIG. 6I depicts an arrangement of a plurality of circular ridges 659, in which the rows of ridges 659 are staggered. The skilled person will readily recognize additional baffled structure configurations that combine various spatial configurations of baffled structures set forth herein.

FIG. 6J displays a top-down view of the solid support 100 configuration of FIG. 6D. Various length scales that may be useful for design of a baffled structure are labeled. A chamber or channel of a fluidic vessel may have an average or maximum width, w_{fr}, which can be greater than or equal to an average or maximum width of a baffled structure, w_{bs}. Each individual ridge 659 of a plurality of ridges 659 may be separated from other adjacent ridges 659 by an interstitial gap having a minimum, average, or maximum width, w_{ig}. An individual ridge 659 may be characterized as having one or more characteristic dimensions (e.g., a characteristic length l_{d}, a characteristic width, w_{d}, a characteristic diameter, etc.). A baffled structure may be offset relative to a port 608 by a minimum, average, or maximum distance, li, as measured by a distance between traces D′ and E′. A baffled structure may have a minimum, average, or maximum total length in a downstream direction, l_{bs}, as measured by a distance between traces A′ and D′. If a baffled structure comprises ridges 659 that are arranged in rows, two adjacent rows may be offset by a minimum, average, or maximum distance, l_{rg}, as measured by a distance between traces B′ and C′.

FIGS. 6D and 6J depict a baffled structure that is provided adjacent to a terminal port of a channel or chamber of a fluidic vessel. It will be recognized that the baffled structure may also be provided in central regions of a channel or chamber of a fluidic vessel. In some cases, it may be useful to provide a baffled structure in a region of a chamber or channel that does not contain a port. For example, the baffled structure may facilitate reestablishment of a substantially uniform flow velocity profile if the velocity profile has begun to become variable or irregular in a downstream region of a chamber or channel. FIG. 6K depicts two baffled structures, each comprising a plurality of ridges 659, that are located within a channel or chamber 102. The channel or chamber 102 is enclosed, at least in part, by a first solid support 100 and a second solid support 105. The offset structure contains a port 620 that allows fluid to be delivered into the channel or chamber 102 through a fluidic passage 625. The fluid delivered into the channel or chamber 102 can flow bidirectionally toward downstream regions 101A and 101B. Each ridge 659 has a minimum, average, or maximum height or thickness, hd, that is some fraction of the total average height or thickness, h_{fr}, of the solid support 100. The left baffled structure may facilitate formation of a substantially uniform flow velocity profile as fluid flows toward downstream surface 101A, and the right baffled structure may facilitate formation of a substantially uniform flow velocity profile as fluid flows toward downstream surface 101B. In some cases, a baffled structure may be provided in a first direction of fluid flow, and not provided in a second direction of fluid flow.

FIG. 6L illustrates aspects of ridge orientation with respect to a primary or bulk direction of fluid flow. A baffled structure comprising a plurality of ridged structures (659A, 659B, 659C, 659D, respectively) is shown. An orientation axis along the longer dimension of each ridged structure is shown for each ridged structure (e.g., axis A′ is shown for ridge 659A). For straight ridged structures (e.g., 659A, 659C, 659D), the orientation axes (e.g., A′, C′, D′, respectively) are oriented parallel to the orientation of the ridge. For the curved or asymmetric structure, 659B, the orientation axis B′ is oriented along a center of mass or volume for the ridged structure 659B (i.e., 50% of the mass or volume of the ridged structure 659B would be on one side of the orientation axis B′, and 50% of the mass or volume of the ridged structure would be on the opposite side of the orientation axis B′). A fluid flows across the ridged structures in a primary direction denoted by arrow V. Orientation angles Θ_{A}, Θ_{B}, Θ_{C}, and Θ_{D} are shown between respective orientation axes A′, B′, C′, and D′ and velocity orientation axis V. Ridged structures with an orientation angle of less than about 45° (e.g., ridged structures 659A, 659B) may be considered to be oriented toward the primary direction of fluid flow. Ridged structures with an orientation angle of greater than about 45° (e.g., ridged structures 659C, 659D) may be considered to be oriented opposed to the primary direction of fluid flow. A ridged structure with an orientation angle of about 45° (e.g., ±5°, ±10°, ±15°) may be considered to be diagonal to the primary direction of fluid flow. Alternatively, the orientation of a ridge structure may be determined with respect to another aspect of a fluidic vessel. For example, an orientation angle may be determined between an orientation axis of a ridged structure and an orientation axis of a side boundary 604 of a fluidic vessel.

Baffled structures depicted in FIGS. 6D-6K comprise a plurality of ridges. Baffled structures may also be formed with a plurality of depressions in a surface of a solid support. In such cases, depressions may be formed with particular depths, lengths, and/or widths. Patterning and arrangements of depressions may be varied analogously to FIGS. 6E-6I. A baffled structure may comprise a plurality of structures (e.g., ridged structures, depressions), such as at least about 2, 3, 4, 5, 10, 15, 20, 25, 30, 40, 50, 75, 100, 200, 300, 500, 1000, or more than 1000 structures. Alternatively or additionally, a baffled structure may comprise no more than about 1000, 500, 300, 200, 100, 75, 50, 40, 30, 25, 20, 15, 10, 5, 4, 3, or less than 3 structures.

It will be recognized that, in some fluidic systems, convective mass transfer may dominate over diffusive mass transfer for a flowing fluid within a fluidic vessel. The specific flux of a species within a fluid (e.g., macromolecules, small molecules) at a particular spatial coordinate within a fluidic vessel may be proportional to the magnitude of the velocity field at that spatial coordinate. Accordingly, a fluidic vessel, as set forth herein, that provides a substantially uniform velocity profile in a portion of the fluidic vessel may have a substantially uniform mass flux of the species in the portion of the fluidic vessel containing the substantially uniform velocity profile.

Structures (e.g., offset structures, baffled structures) provided in a fluidic vessel to provide a more uniform velocity profile may be designed and optimized by computational fluidic modeling packages such as COMSOL. Varying geometries of fluidic vessels, or structures disposed within the fluidic vessels, may be modeled in two or three dimensions, and flow simulations performed for each individual geometry. Simulated velocity fields can be compared for each geometry to identify a fluidic vessel geometry with an optimal fluid velocity profile. Various geometric variables set forth herein may be useful as variables in computational simulations.

A fluidic vessel, or a chamber or channel thereof, may have a volume, such as at least about 1 microliter (μL), 10 μL, 50 μL, 100 μL, 250 μL, 500 μL, 1 milliliter (mL), 5 mL, 10 mL, 25 mL, 50 mL, 100 mL, 250 mL, 500 mL, 1 liter (L), or more than 1 L. Alternatively or additionally, a fluidic vessel, or a chamber or channel thereof, may have a volume, such as no more than about 1 L, 500 mL, 250 mL, 100 mL, 50 mL, 25 mL, 10 mL, 5 mL, 1 mL, 500 μL, 250 μL, 100 μL, 50 μL, 10 μL, 1 μL, or less than 1 μL.

A fluidic vessel, or a chamber or channel thereof, may comprise an array of sites. Sites of an array of sites may be disposed on a surface of a fluidic vessel, such as a surface of a solid support. Sites of an array of sites may be disposed on a surface of a chamber or channel of a fluidic vessel. In some cases, sites may be provided on one and only one surface within a fluidic vessel. In other cases, sites may be provided on more than one surface within a fluidic vessel. In some cases, the dimensions of an array on a surface may be proportional to the dimensions of the surface. For example, a surface with an elongated aspect ratio (i.e., length>width) may contain an array with an elongated aspect ratio (i.e., the length of an area of the surface containing array sites is greater than a width of an area of the surface containing array sites).

Each individual site of an array of sites may contain a discrete area that is configured to retain an analyte or an anchoring moiety containing an analyte. An individual site of an array of sites may be separated from each adjacent site by an interstitial region. An interstitial region between a first site and a second site may be configured to inhibit binding of moieties (e.g., analytes, anchoring moieties). In some cases, sites of an array of sites may be provided in a pattern, such as a hexagonal, rectangular, or circular grid. In other cases, sites of an array of sites may be provided in a random pattern.

An array of sites may comprise a plurality of sites, such as at least about 10³, 10⁴, 10⁵, 10⁶, 10⁷, 10⁸, 10⁹, 10¹⁰, 10¹¹, 10¹², or more than 10¹² sites. Alternatively or additionally, an array of sites may comprise a plurality of sites, such as no more than about 10¹², 10¹¹, 10¹⁰, 10⁹, 10⁸, 10⁷, 10⁶, 10⁵, 10⁴, 10³, or less than 10³ sites. An individual site of an array of sites can have a characteristic dimension (e.g., a width, diameter, length, or height) of at least about 1 nanometer (nm), 10 nm, 50 nm, 100 nm, 250 nm, 500 nm, 1 micron (μm), 1.5 μm, 2 μm, 5 μm, 10 μm, 50 μm, 100 μm, or more than 100 μm. Alternatively or additionally, an individual site of an array of sites can have a characteristic dimension of no more than about 100 μm, 50 μm, 10 μm, 5 μm, 2 μm, 1.5 μm, 1 μm, 500 nm, 250 nm, 100 nm, 50 nm, 10 nm, 1 nm, or less than 1 nm. An individual site of an array can have a surface area of at least about 1 square nanometer (nm²), 10 nm², 10² nm², 10³ nm², 10⁴ nm², 10⁵ nm², 1 square micron (μm²), 2 μm², 5 μm², 10 μm², 10² μm², 10³ μm², 10⁴ μm², 10⁵ μm², or more than 10⁵ μm². Alternatively or additionally, an individual site of an array can have a surface area of at least about 10⁵ μm², 10⁴ μm², 10³ μm², 10² m², 10 μm², 5 μm², 2 μm², 1 m², 10⁵ nm², 10⁴ nm², 10³ nm², 10² nm², 5 nm², 2 nm², 1 nm² or less.

A site of an array of sites may comprise a layer or coating. A layer or coating of a site of an array of sites may comprise one or more coupling moieties that are configured to bind one or more entities (e.g., analytes, analytes of interest, anchoring moieties, analytes attached to anchoring moieties) to the site. A coupling moiety may comprise a covalent coupling moiety (e.g., a reactive functional group, a reactive ligand-receptor binding pair component) or a non-covalent coupling moiety (e.g., an oligonucleotide, a non-reactive ligand-receptor binding pair component). A layer or coating of an array of sites may comprise one or more passivating moieties (e.g, a polyethylene glycol moiety, an alkyl moiety, a branched or dendrimeric polymer, an ionic polymer, etc.) that are configured to inhibit orthogonal binding to the site (i.e., unwanted or unintended binding of entities).

A fluidic vessel comprising an array of sites may be provided with entities (e.g., analytes, anchoring moieties, analytes attached to anchoring moieties) bound to sites of the array of sites. In some cases, a fluidic vessel comprising an array of sites may be provided with analytes bound to sites of the array of sites. In some cases, a fluidic vessel comprising an array of sites may be provided with anchoring moieties bound to sites of the array of sites. An anchoring moiety may comprise a particle that is configured to facilitate attaching an analyte to an array site. An anchoring moiety may comprise a nanoparticle, such as an organic nanoparticle (e.g., a carbon nanoparticle, a nucleic acid nanoparticle, a polymeric nanoparticle) or an inorganic nanoparticle (e.g., a metal, metal oxide, or semiconductor nanoparticle).

An interstitial region separating a first site from a second site may comprise a layer or coating. A layer or coating of an interstitial region may be configured to inhibit binding of an entity (e.g., an analyte, an anchoring moiety, a binding reagent, etc.) to the interstitial region. A layer or coating of an interstitial region may comprise a hydrophobic moiety (e.g., a hexamethyldisilazane molecule, an alkyl moiety) or a hydrophilic moiety (e.g., a polyethylene glycol moiety, a dextran moiety, etc.). A surface of a fluidic vessel that does not contain an array of sites may also comprise a layer or coating. In some cases, a surface of a fluidic vessel that does not contain an array of sites may comprise a same layer or coating as an interstitial region. In other cases, a surface of a fluidic vessel that does not contain an array of sites may comprise a differing layer or coating compared to a layer or coating of an interstitial region.

A fluid delivered to a fluidic device may comprise any of a variety of components, such as a solvent species, pH buffering species, a cationic species, an anionic species, a surfactant species, a denaturing species, a crowding agent, an antioxidant, or a combination thereof. Advantageous compositions of differing fluidic media are described in more detail throughout the present disclosure. A solvent species may include water, acetic acid, methanol, ethanol, n-propanol, isopropyl alcohol, n-butanol, formic acid, ammonia, propylene carbonate, nitromethane, dimethyl sulfoxide, acetonitrile, dimethylformamide, acetone, ethyl acetate, tetrahydrofuran, dichloromethane, chloroform, carbon tetrachloride, dimethyl ether, diethyl ether, 1-4, dioxane, toluene, benzene, cyclohexane, hexane, cyclopentane, pentane, or combinations thereof. A fluid may include a buffering species including, but not limited to, MES, Tris, Bis-tris, Bis-tris propane, ADA, ACES, PIPES, MOPSO, MOPS, BES, TES, HEPES, HEPBS, HEPPSO, DIPSO, MOBS, TAPSO, TAPS, TABS, POPSO, TEA, EPPS, Tricine, Gly-Gly, Bicine, AMPD, AMPSO, AMP, CHES, phosphate buffer solution (PBS), CAPSO, CAPS, and CABS. A fluid may include cationic species such as Na+, K+, Ag+, Cu+, NH4+, Mg2+, Ca2+, Cu2+, Cd2+, Zn2+, Fe2+, Co2+, Ni2+, Cr2+, Mn2+, Ge2+, Sn2+, A13+, Cr3+, Fe3+, Co3+, Ni3+, Ti3+, Mn3+, Si4+, V4+, Ti4+, Mn4+, Ge4+, Se4+, V5+, Mn5+, Mn6+, Se6+, and combinations thereof. A fluidic medium may include anionic species such as F−, Cl−, Br−, ClO3−, H2PO4−, HCO3−, HSO4−, OH−, I−, NO3−, NO2−, MnO4−, SCN−, CO32−, CrO42−, Cr2O72−, HPO42−, SO42−, SO32−, PO43−, and combinations thereof. A fluid may include a surfactant species, such as a cationic surfactant, an anionic surfactant, a zwitterionic surfactant (e.g., a sultaine, a betaine), or an amphoteric surfactant. A fluid may include a surfactant species including, but not limited to, stearic acid, lauric acid, oleic acid, sodium dodecyl sulfate, sodium dodecyl benzene sulfonate, dodecylamine hydrochloride, hexadecyltrimethylammonium bromide, polyethylene oxide, nonylphenyl ethoxylates, Triton X, pentapropylene glycol monododecyl ether, octapropylene glycol monododecyl ether, pentaethylene glycol monododecyl ether, octaethylene glycol monododecyl ether, lauramide monoethylamine, lauramide diethylamine, octyl glucoside, decyl glucoside, lauryl glucoside, Tween 20, Tween 80, n-dodecyl-β-D-maltoside, nonoxynol 9, glycerol monolaurate, polyethoxylated tallow amine, poloxamer, digitonin, zonyl FSO, 2,5-dimethyl-3-hexyne-2,5-diol, Igepal CA630, Aerosol-OT, triethylamine hydrochloride, cetrimonium bromide, benzethonium chloride, octenidine dihydrochloride, cetylpyridinium chloride, adogen, dimethyldioctadecylammonium chloride, CHAPS, CHAPSO, cocamidopropyl betaine, amidosulfobetaine-16, cocoamphoacetate, cocoamidopropyl hydroxysultaine, lauryl-N,N-(dimethylammonio)butyrate, lauryl-N,N-(dimethyl)-glycinebetaine, hexadecyl phosphocholine, lauryldimethylamine N-oxide, lauryl-N,N-(dimethyl)-propanesulfonate, 3-(1-pyridinio)-1-propanesulfonate, 3-(4-tert-butyl-1-pyridinio)-1-propanesulfonate, N-laurylsarcosine, and combinations thereof. A fluid may comprise a denaturing species including, but not limited to, acetic acid, trichloroacetic acid, sulfosalicylic acid, sodium bicarbonate, ethanol, ethylenediamine tetraacetic acid (EDTA), urea, guanidinium chloride, lithium perchlorate, sodium dodecyl sulfate, 2-mercaptoethanol, dithiothreitol, and tris(2-carboxyethyl) phosphine (TCEP). A fluid may comprise a crowding agent, including but not limited to, carbonate ion, sulfate ion, phosphate ion, magnesium ion, lithium ion, zinc ion, aluminum ion, trehalose, glucose, proline, tert-butanol, polyethylene glycol, and combinations thereof.

A fluid delivered to a fluidic vessel may comprise an excipient species. An excipient species may be provided to preserve or promote a function or state of an assay agent (e.g., an analyte, binding reagent, or anchoring moiety). Exemplary types of excipient agents can include cryoprotectants, biocidal agents, chaotropes and/or denaturants, reactive species inhibitors, anti-aggregants, enzymatic inhibitors, and molecular stability promoters.

In some cases, an excipient agent may be provided in a fluid. In other cases, an excipient agent may be mixed or diluted into a fluid. For example, a method may comprise the steps of: i) providing a binding reagent in a first fluid comprising an excipient agent, ii) mixing the first fluid with a second fluid to form a third fluid, and iii) delivering the third fluid to a fluidic vessel, as set forth herein.

An excipient agent may comprise a cryoprotectant. A cryoprotectant may comprise one or more chemical species that prevent damage to an assay agent (e.g., a binding reagent, an analyte, an anchoring moiety) during storage or assay processes that occur at reduced temperatures (e.g., less than 10° C., 0° C., −10° C., etc.). Exemplary cryoprotectants can include dextrans, ethylene glycol, glycerol, glycerol-3-phosphate, dimethyl sulfoxide (DMSO), 2-methyl-2,4 propanediol (MPD), erythritol, xylitol, trehalose, sucrose, sorbitol, formamide, proline, polymers, and combinations thereof. An excipient agent may comprise a biocidal agent. A biocidal agent may comprise one or more chemical species that inhibit growth of single-cell or multi-cell biological organisms. A biocidal agent can include an antibiotic agent (e.g., proclin), an antifungal agent, an antiprotozoal agent, an anti-parasitic agent, and a combination thereof. An excipient agent may comprise an anti-aggregant. An anti-aggregant may prevent aggregation of macromolecules (e.g., polypeptides, nucleic acids, polysaccharides, combinations thereof). Exemplary anti-aggregants can include histidine, glutamine, arginine, sucrose, glycerol, trimethylamine N-oxide (TMAO), and combinations thereof. An excipient agent may comprise an enzymatic inhibitor. An enzymatic inhibitor can include any species that inhibits enzymatic activity, such as protease inhibitors and/or nuclease inhibitors. An excipient agent may comprise a molecular stability promoter. A nucleic acid stability promoter may comprise a chemical species that inhibits dehybridization of double-stranded nucleic acids. Exemplary nucleic acid stability promoters can include nucleic acid stability promoters, such as magnesium ions and polyamines (putrescine, spermine, spermidine, etc.), and other biomolecular stability promoters such as sucrose, maltodextrin, raffinose, trehalose, sorbitol, polyethylene glycol, and combinations thereof.

### Methods of Utilizing Fluidic Vessels

In an aspect, provided herein is a method, comprising: a) delivering a fluid to a first port of a fluidic vessel, as set forth herein, wherein the fluid comprises a plurality of macromolecules, as set forth herein, b) flowing the fluid comprising the plurality of macromolecules across an array of sites, as set forth herein, that is disposed within the fluidic vessel, thereby binding macromolecules of the plurality of macromolecules to sites of the array of sites, and c) discharging the fluid through a second port of the fluidic vessel. A macromolecule may comprise a molecule with a molecular weight of 1 kiloDalton (kDa) or more. Macromolecules can include biomolecules (e.g., polypeptides, nucleic acids, polysaccharides, etc.), polymeric molecules, and nanoparticles or microparticles (organic nanoparticles, organic microparticles, inorganic microparticles, inorganic nanoparticles, etc.).

In some cases, a macromolecule of a plurality of macromolecules can comprise an analyte of interest. For example, an analyte of interest may be an analyte separated from, purified from, or otherwise derived from a biological sample (e.g., a tissue sample, a cell, a biological fluid, etc.). In some cases, a macromolecule of a plurality of macromolecules can comprise an anchoring moiety. An anchoring moiety may comprise a particle (e.g., a nucleic acid nanoparticle) that is configured to bind to a surface of an array site, and is further configured to bind an analyte to the array site (optionally occluding contact between the array site and the analyte). In some cases, a macromolecule of a plurality of macromolecules may comprise a binding reagent. A binding reagent may comprise an affinity agent (e.g., an antibody, an aptamer, etc.) that is configured to form an interaction with an array site. In particular cases, a binding reagent may comprise a detection reagent. A detection reagent may comprise one or more of: i) one or more affinity agents, ii) one or more detectable labels (e.g., fluorophores, luminophores, radiolabels, nucleic acid or peptide barcodes, etc.), and iii) a retaining moiety (e.g., a nanoparticle) that is configured to couple together the one or more affinity agents and the one or more detectable labels.

In another aspect, provided herein is a method, comprising: a) delivering a fluid to a first port of a fluidic vessel, as set forth herein, wherein the fluid comprises a plurality of small molecules, as set forth herein, b) flowing the fluid comprising the plurality of small molecules across an array of sites, as set forth herein, that is disposed within the fluidic vessel, and c) discharging the fluid through a second port of the fluidic vessel. A small molecule may comprise a molecule with a molecular weight of less than 1 kiloDalton (kDa). Small molecules can include metabolites, pharmaceutical compounds, and chemical reagents.

A fluid delivered to a fluidic vessel may comprise a plurality of molecules (e.g., macromolecules, small molecules). Molecules may be delivered to a fluidic vessel, in which the molecules form interactions at array sites or with entities bound thereto (e.g., analytes, analytes of interest, anchoring moieties, etc.). A molecule of a plurality of molecules may form a binding interaction an array site (e.g., a covalent or non-covalent bond between the binding reagent and an analyte at the array site). A molecule of a plurality of molecules may bind to a surface layer or coating of an array site (e.g., binding of an analyte or anchoring moiety to the array site). A molecule of a plurality of molecules may modify an array site or an entity attached thereto. For example, a molecule may alter a conformation or morphology of an analyte at an array site (e.g., denaturing a folded polypeptide). In another example, a molecule may chemical react with or cleave an analyte at an array site.

A method may further comprise contacting or incubating a fluid with an array of sites in a fluidic vessel, as set forth herein. In some cases, contacting or incubating the fluid to the array of sites can comprise quiescently contacting the fluid to the array of sites. (i.e., substantially no pressure-driven flow of the fluid). In other cases, contacting the fluid to the array of sites can comprise non-quiescently contacting the fluid to the array of sites. For example, a fluid may be circulated through the fluidic vessel, or an oscillatory or bidirectional flow may facilitate fluid movement, thereby inducing motion of the molecules adjacent to the array of sites.

A fluid may be contacted to or incubated with an array of sites for at least about 1 second (s), 5 s, 10 s, 15 s, 30 s, 45 s, 60 s, 2 minutes (min) 3 min, 5 min, 10 min, 15 min, 20 min, 30 min, 60 min, 2 hours (hr), 3 hr, 6 hr, 12 hr, 24 hr, or more than 24 hr. Alternatively or additionally, a fluid may be contacted to or incubated with an array of sites for no more than about 24 hr, 12 hr, 6 hr, 3 hr, 2 hr, 60 min, 30 min, 20 min, 15 min, 10 min, 5 min, 3 min, 2 min, 60 s, 45 s, 30 s, 15 s, 10 s, 5 s, 1 s, or less than 1 s.

A volume of fluid delivered to a fluidic vessel may depend upon a capacity or volume of the fluidic vessel, or a chamber or channel thereof. For example, a fluidic vessel may comprise two 100 microliter (μL) chambers that are fluidically connected by a 10 μL channel, thereby giving the fluidic vessel a volume or fluid capacity of at least 110 μL. A method may comprise a step of delivering a fluid to a fluidic vessel, or a chamber or channel thereof, in which the volume of fluid delivered to the fluidic vessel, or the channel or chamber thereof, is greater than or equal to the volume or fluid capacity of the fluidic vessel, or the chamber or channel thereof. Alternatively, a method may comprise a step of delivering a fluid to a fluidic vessel, or a chamber or channel thereof, in which the volume of fluid delivered to the fluidic vessel, or the channel or chamber thereof, is less than the volume or fluid capacity of the fluidic vessel, or the chamber or channel thereof. A ratio of fluid volume delivered to a fluidic vessel, or a chamber or channel thereof, to fluidic vessel, chamber, or channel volume may be at least about 0.001, 0.01, 0.1, 0.25, 0.5, 0.75, 0.9, 0.99, 1, 1.5, 2, 3, 4, 5, 10, 20, 50, 100, 500, 1000, or more than 1000. Alternatively or additionally, a ratio of fluid volume delivered to a fluidic vessel, or a chamber or channel thereof, to fluidic vessel, chamber, or channel volume may be no more than about 1000, 500, 100, 50, 20, 10, 5, 4, 3, 2, 1.5, 1, 0.99, 0.9, 0.75, 0.5, 0.25, 0.1, 0.01, 0.001, or less than 0.001.

A volume of fluid may be delivered to a fluidic vessel, or a chamber or channel thereof, in a time of no more than about 1 hour (hr), 45 minutes (min), 30 min, 20 min, 15 min, 10 min, 5 min, 60 seconds (s), 45 s, 30 s, 20 s, 15 s, 10 s, 5 s, 1 s, or less than 1 s. Alternatively or additionally, a volume of fluid may be delivered to a fluidic vessel, or a chamber or channel thereof, in a time of at least about 1 s, 5 s, 10 s, 15 s, 20 s, 30 s, 45 s, 60 s, 5 min, 10 min, 15 min, 20 min, 30 min, 45 min, 1 hr, or more than 1 hr.

A flow rate of fluid delivered to, discharged from, or transporting through a fluidic vessel, as set forth herein, may be at least about 0.001 microliters per second (μL/s), 0.01 μL/s, 0.1 μL/s, 0.5 μL/s, 1 μL/s, 5 μL/s, 10 μL/s, 15 μL/s, 20 μL/s, 25 μL/s, 30 μL/s, 35 μL/s, 40 μL/s, 45 μL/s, 50 μL/s, 100 μL/s, 200 μL/s, 500 μL/s, 1 milliliter per second (mL/s), 10 mL/s, 100 mL/s, 1 Liter per second (L/s) or more than 1 L/s. Alternatively or additionally, a flow rate of fluid delivered to, discharged from, or transporting through a fluidic vessel, as set forth herein, may be no more than about 1 L/s, 100 mL/s, 10 mL/s, 1 mL/s, 500 μL/s, 200 μL/s, 100 μL/s, 50 L/s, 45 μL/s, 40 μL/s, 35 μL/s, 30 μL/s, 25 μL/s, 20 μL/s, 15 μL/s, 10 μL/s, 5 μL/s, 1 μL/s, 0.1 L/s, 0.01 μL/s, 0.001 μL/s, or less than 0.001 μL/s.

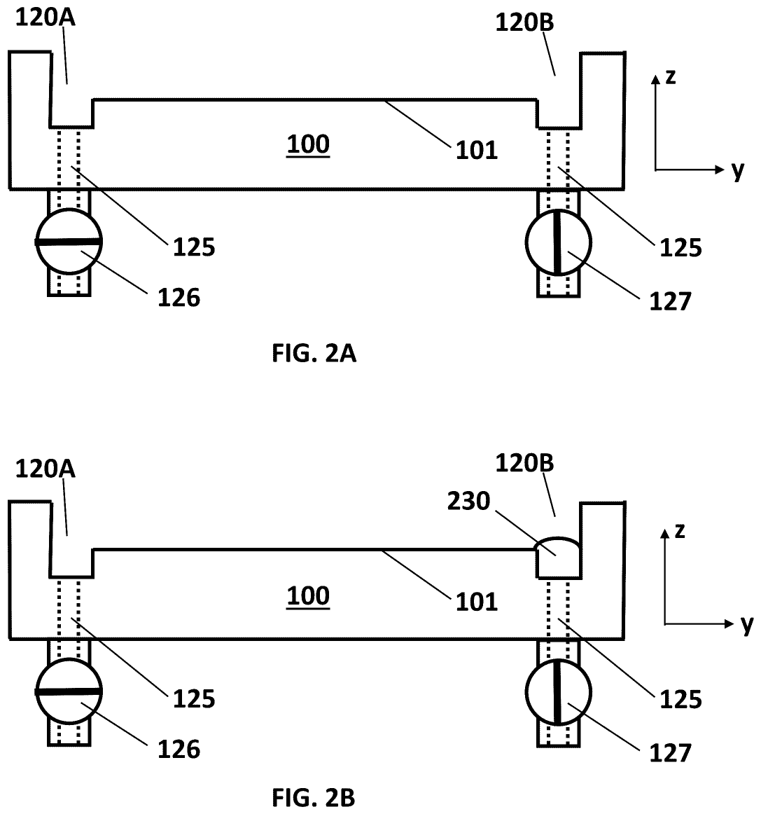

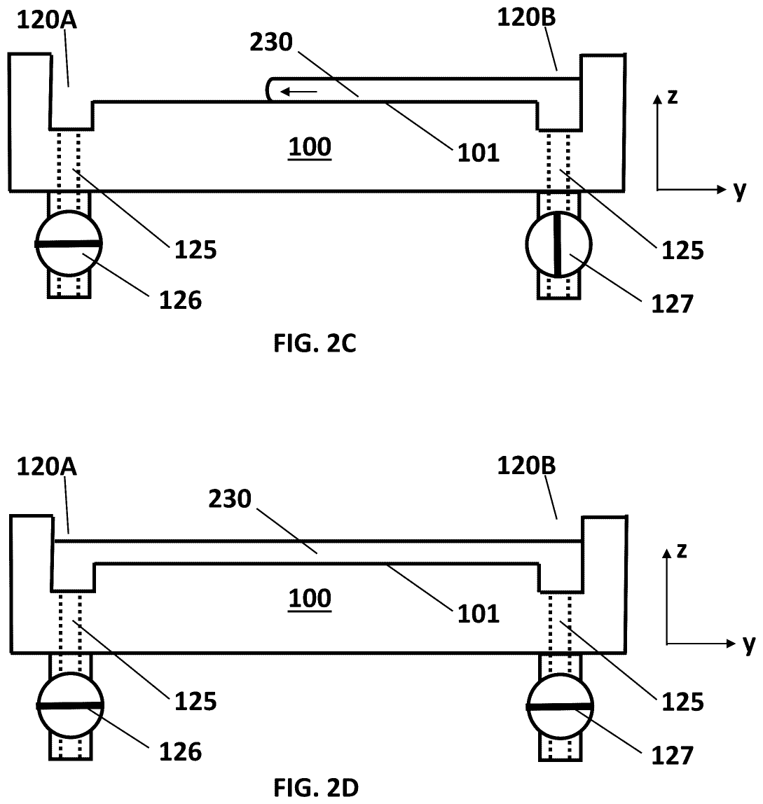

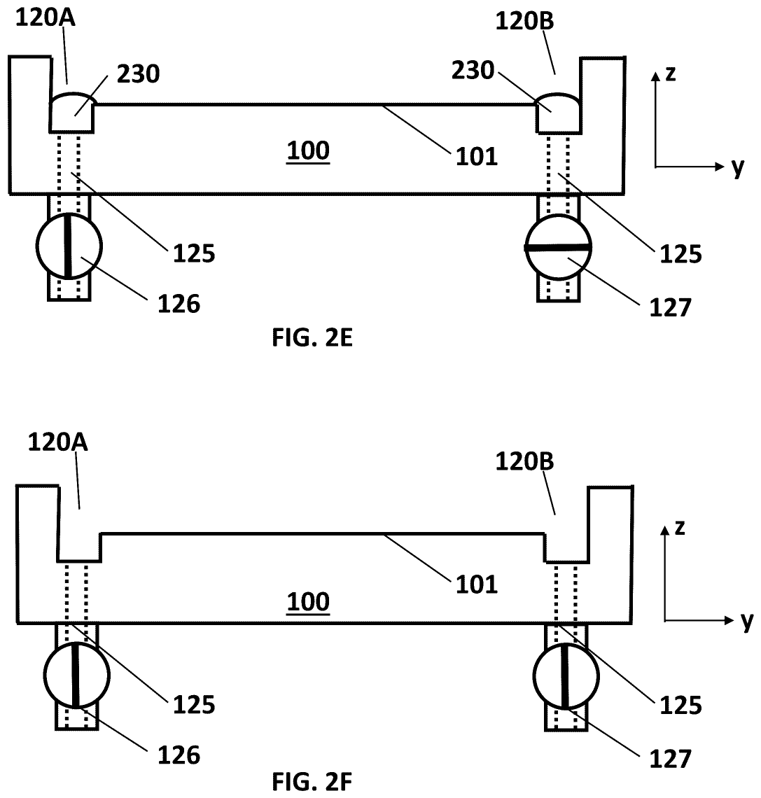

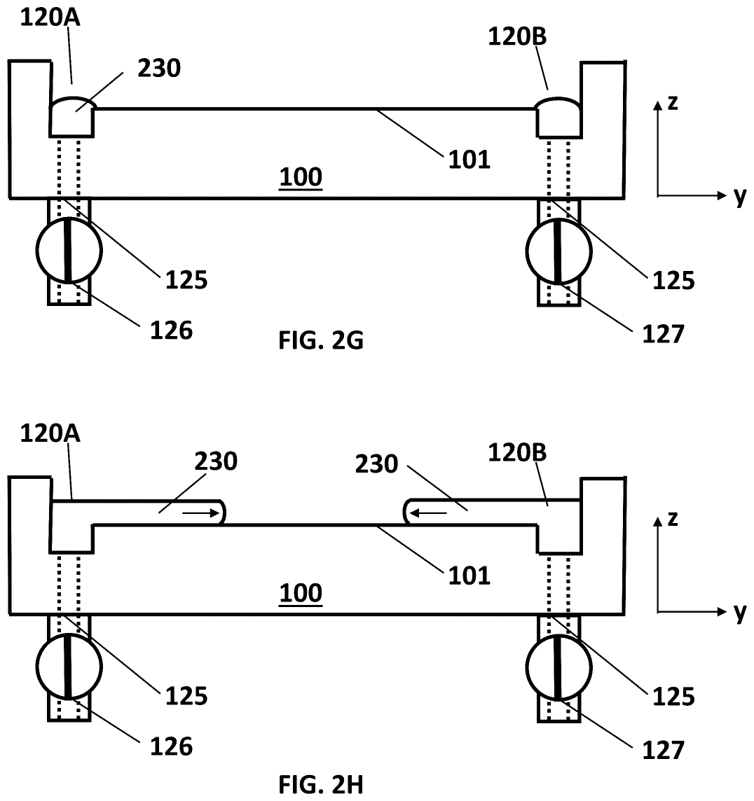

In some embodiments set forth herein, a fluidic vessel may comprise one or more channels provided adjacent to an array of sites, or along an elongated aspect of a surface of a chamber or channel of a fluidic vessel. FIGS. 2A-2H depict steps of methods of delivering and/or discharging fluid through similar fluidic vessels, in accordance with some embodiments. FIG. 2A depicts a cross-sectional view of a solid support 100 of a fluidic vessel. The solid support 100 comprises a substantially planar surface 101 that is flanked by a first channel 120A and a second channel 120B. The channels (120A and 120B) are configured to have fluid delivered or discharged through fluidic passages 125 that pass through the solid support 100. Fluid movement through the first channel 120A is controlled in part by a first valve 126, and fluid movement through the second channel 120B is controlled in part by a second valve 127. It will be understood that valves may be substituted with other flow control devices as appropriate, such as manifolds, autopipetting systems, septums, pumps, etc. As shown in FIG. 2A, the second valve 127 is open, thereby facilitating fluid delivery or discharge from the second channel 120B. As shown in FIG. 2B, a fluid 230 is delivered to the second channel 120B by delivery through the second valve 127. Assuming that the channel 120B has a length in an unseen x-axis direction, the fluid 230 may be delivered to the channel 120B until the fluid 230 occupies substantially the entire volume of the channel 120B.

Turning to FIG. 2C, after the fluid 230 has substantially filled the volume of the channel 120B, the fluid 230 may be delivered across the surface 101 of the solid support 100, flowing primarily in the y-axis direction toward the first channel 120A (as indicated by the arrow in fluid 230). As shown in FIG. 2D, after a sufficient volume of fluid 230 has been delivered to immerse the surface 101 of the solid support 100 and fill the first channel 120A, the second valve 127 may be closed, thereby stopping the delivery of fluid 230 through the second channel 120B.

Turning to FIG. 2E, the fluid 230 may be discharged from the fluidic vessel by opening the first valve 126, and withdrawing the fluid through the first channel 120A. In such a configuration, some residual fluid 230 may be retained in the second channel 120B. FIG. 2F illustrates an alternative method of fluid discharge, in which the first valve 126 and the second valve 127 are both opened, thereby facilitating discharge of fluid through both the first channel 120A and the second channel 120B.

Turning to FIGS. 2G and 2H, delivery of fluid to a fluidic vessel may occur in a bidirectional manner. As shown in FIG. 2G, fluid 230 may be delivered to both the first channel 120A and the second channel 120B through open valves 126 and 127, respectively. As shown in FIG. 2H, the fluid 230 can subsequently be delivered across the surface 101 of the solid support 100, thereby immersing the entire surface 101 of the solid support 100 with the fluid 230 once the two flows converge.

Methods of fluid delivery and discharge depicted in FIGS. 2A-2H may be useful for other configurations of fluidic vessels set forth herein. For example, use of flow control devices to regulate location and timing of fluid delivery and/or discharge may be utilized with fluidic vessels set forth herein. In another example, bidirectional flow may be utilized (i.e., a port used for delivery and discharge of a fluid).

### Polypeptide Assays

The present disclosure provides compositions, apparatus and methods that can be useful for characterizing sample components, such as proteins, nucleic acids, cells or other species, by obtaining multiple separate and non-identical measurements of the sample components. In particular configurations, the individual measurements may not, by themselves, be sufficiently accurate or specific to make the characterization, but an aggregation of the multiple non-identical measurements can allow the characterization to be made with a high degree of accuracy, specificity and confidence. For example, the multiple separate measurements can include subjecting the sample to reagents that are promiscuous with regard to recognizing multiple components of the sample. Accordingly, a first measurement carried out using a first promiscuous reagent may perceive a first subset of sample components without distinguishing one component from another. A second measurement carried out using a second promiscuous reagent may perceive a second subset of sample components, again, without distinguishing one component from another. However, a comparison of the first and second measurements can distinguish: (i) a sample component that is uniquely present in the first subset but not the second; (ii) a sample component that is uniquely present in the second subset but not the first; (iii) a sample component that is uniquely present in both the first and second subsets; or (iv) a sample component that is uniquely absent in the first and second subsets. The number of promiscuous reagents used, the number of separate measurements acquired, and degree of reagent promiscuity (e.g. the diversity of components recognized by the reagent) can be adjusted to suit the component diversity expected for a particular sample.

The present disclosure provides assays that are useful for detecting one or more analytes. Exemplary assays are set forth herein in the context of detecting proteins. Those skilled in the art will recognize that methods, compositions and apparatus set forth herein can be adapted for use with other analytes such as nucleic acids, polysaccharides, metabolites, vitamins, hormones, enzyme co-factors and others set forth herein or known in the art. Particular configurations of the methods, apparatus and compositions set forth herein can be made and used, for example, as set forth in U.S. Pat. No. 10,473,654 or US Pat. App. Pub. Nos. 2020/0318101 A1 or 2020/0286584 A1, each of which is incorporated herein by reference. Exemplary methods, systems and compositions are set forth in further detail below.

A composition, apparatus or method set forth herein can be used to characterize an analyte, or moiety thereof, with respect to any of a variety of characteristics or features including, for example, presence, absence, quantity (e.g. amount or concentration), chemical reactivity, molecular structure, structural integrity (e.g. full length or fragmented), maturation state (e.g. presence or absence of pre- or pro-sequence in a protein), location (e.g. in an analytical system, subcellular compartment, cell or natural environment), association with another analyte or moiety, binding affinity for another analyte or moiety, biological activity, chemical activity or the like. An analyte can be characterized with regard to a relatively generic characteristic such as the presence or absence of a common structural feature (e.g. amino acid sequence length, overall charge or overall pKa for a protein) or common moiety (e.g. a short primary sequence motif or post-translational modification for a protein). An analyte can be characterized with regard to a relatively specific characteristic such as a unique amino acid sequence (e.g. for the full length of the protein or a motif), an RNA or DNA sequence that encodes a protein (e.g. for the full length of the protein or a motif), or an enzymatic or other activity that identifies a protein. A characterization can be sufficiently specific to identify an analyte, for example, at a level that is considered adequate or unambiguous by those skilled in the art.

In particular configurations, a protein can be detected using one or more affinity agents having known or measurable binding affinity for the protein. For example, an affinity agent can bind a protein to form a complex and a signal produced by the complex can be detected. A protein that is detected by binding to a known affinity agent can be identified based on the known or predicted binding characteristics of the affinity agent. For example, an affinity agent that is known to selectively bind a candidate protein suspected of being in a sample, without substantially binding to other proteins in the sample, can be used to identify the candidate protein in the sample merely by observing the binding event. This one-to-one correlation of affinity agent to candidate protein can be used for identification of one or more proteins. However, as the protein complexity (i.e. the number and variety of different proteins) in a sample increases, or as the number of different candidate proteins to be identified increases, the time and resources to produce a commensurate variety of affinity agents having one-to-one specificity for the proteins approaches limits of practicality.

Methods set forth herein, can be advantageously employed to overcome these constraints. In particular configurations, the methods can be used to identify a number of different candidate proteins that exceeds the number of affinity agents used. For example, the number of candidate proteins identified can be at least 5×, 10×, 25×, 50×, 100× or more than the number of affinity agents used. This can be achieved, for example, by (1) using promiscuous affinity agents that bind to multiple different candidate proteins suspected of being present in a given sample, and (2) subjecting the protein sample to a set of promiscuous affinity agents that, taken as a whole, are expected to bind each candidate protein in a different combination, such that each candidate protein is expected to be encoded by a unique profile of binding and non-binding events. Promiscuity of an affinity agent is a characteristic that can be understood relative to a given population of proteins. Promiscuity can arise due to the affinity agent recognizing an epitope that is known to be present in a plurality of different candidate proteins suspected of being present in the given population of unknown proteins. For example, epitopes having relatively short amino acid lengths such as dimers, trimers, or tetramers can be expected to occur in a substantial number of different proteins in the human proteome. Alternatively or additionally, a promiscuous affinity agent can recognize different epitopes (e.g. epitopes differing from each other with regard to amino acid composition or sequence), the different epitopes being present in a plurality of different candidate proteins. For example, a promiscuous affinity agent that is designed or selected for its affinity toward a first trimer epitope may bind to a second epitope that has a different sequence of amino acids when compared to the first epitope.

Although performing a single binding reaction between a promiscuous affinity agent and a complex protein sample may yield ambiguous results regarding the identity of the different proteins to which it binds, the ambiguity can be resolved when the results are combined with other identifying information about those proteins. The identifying information can include characteristics of the protein such as length (i.e. number of amino acids), hydrophobicity, molecular weight, charge to mass ratio, isoelectric point, chromatographic fractionation behavior, enzymatic activity, presence or absence of post translational modifications or the like. The identifying information can include results of binding with other promiscuous affinity agents. For example, a plurality of different promiscuous affinity agents can be contacted with a complex population of proteins, wherein the plurality is configured to produce a different binding profile for each candidate protein suspected of being present in the population. In this example, each of the affinity agents can be distinguishable from the other affinity agents, for example, due to unique labeling (e.g. different affinity agents having different luminophore labels), unique spatial location (e.g. different affinity agents being located at different addresses in an array), and/or unique time of use (e.g. different affinity agents being delivered in series to a population of proteins). Accordingly, the plurality of promiscuous affinity agents produces a binding profile for each individual protein that can be decoded to identify a unique combination of epitopes present in the individual protein, and this can in turn be used to identify the individual protein as a particular candidate protein having the same or similar unique combination of epitopes. The binding profile can include observed binding events as well as observed non-binding events and this information can be evaluated in view of the expectation that particular candidate proteins produce a similar binding profile, for example, based on presence and absence of particular epitopes in the candidate proteins.

In some configurations, distinct and reproducible binding profiles may be observed for one or more unknown proteins in a sample. However, in many cases one or more binding events produces inconclusive or even aberrant results and this, in turn, can yield ambiguous binding profiles. For example, observation of binding outcome for a single-molecule binding event can be particularly prone to ambiguities due to stochasticity in the behavior of single molecules when observed using certain detection hardware. The present disclosure provides methods that provide accurate protein identification despite ambiguities and imperfections that can arise in many contexts. In some configurations, methods for identifying, quantitating or otherwise characterizing one or more proteins in a sample utilize a binding model that evaluates the likelihood or probability that one or more candidate proteins that are suspected of being present in the sample will have produced an empirically observed binding profile. The binding model can include information regarding expected binding outcomes (e.g. binding or non-binding) for binding of one or more affinity reagent with one or more candidate proteins. The information can include an a priori characteristic of a candidate protein, such as presence or absence of a particular epitope in the candidate protein or length of the candidate protein. Alternatively or additionally, the information can include empirically determined characteristics such as propensity or likelihood that the candidate protein will bind to a particular affinity reagent. Accordingly, a binding model can include information regarding the propensity or likelihood of a given candidate protein generating a false positive or false negative binding result in the presence of a particular affinity reagent, and such information can optionally be included for a plurality of affinity reagents.

Methods set forth herein can be used to evaluate the degree of compatibility of one or more empirical binding profiles with results computed for various candidate proteins using a binding model. For example, to identify an unknown protein in a sample of many proteins, an empirical binding profile for the protein can be compared to results computed by the binding model for many or all candidate proteins suspected of being in the sample. In some configurations of the methods set forth herein, identity for the unknown protein is determined based on a likelihood of the unknown protein being a particular candidate protein given the empirical binding pattern or based on the probability of a particular candidate protein generating the empirical binding pattern. Optionally a score can be determined from the measurements that are acquired for the unknown protein with respect to many or all candidate proteins suspected of being in the sample. A digital or binary score that indicates one of two discrete states can be determined. In particular configurations, the score can be non-digital or non-binary. For example, the score can be a value selected from a continuum of values such that an identity is made based on the score being above or below a threshold value. Moreover, a score can be a single value or a collection of values. Particularly useful methods for identifying proteins using promiscuous reagents, serial binding measurements and/or decoding with binding models are set forth, for example, in U.S. Pat. No. 10,473,654 US Pat. App. Pub. No. 2020/0318101 A1 or Egertson et al., BioRxiv (2021), DOI: 10.1101/2021.10.11.463967, each of which is incorporated herein by reference.

The present disclosure provides compositions, apparatus and methods for detecting one or more proteins. A protein can be detected using one or more affinity agents having binding affinity for the protein. The affinity agent and the protein can bind each other to form a complex and, during or after formation, the complex can be detected. The complex can be detected directly, for example, due to a label that is present on the affinity agent or protein. In some configurations, the complex need not be directly detected, for example, in formats where the complex is formed and then the affinity agent, protein, or a label component that was present in the complex is detected.

Many protein detection methods, such as enzyme linked immunosorbent assay (ELISA), achieve high-confidence characterization of one or more protein in a sample by exploiting high specificity binding of antibodies, aptamers or other binding agents to the protein(s) and detecting the binding event while ignoring all other proteins in the sample. ELISA is generally carried out at low plex scale (e.g. from one to a hundred different proteins detected in parallel or in succession) but can be used at higher plexity. ELISA methods can be carried out by detecting immobilized binding agents and/or proteins in multiwell plates, on arrays, or on particles in microfluidic devices. Exemplary plate-based methods include, for example, the MULTI-ARRAY technology commercialized by MesoScale Diagnostics (Rockville, Maryland) or Simple Plex technology commercialized by Protein Simple (San Jose, CA). Exemplary, array-based methods include, but are not limited to those utilizing Simoa® Planar Array Technology or Simoa® Bead Technology, commercialized by Quanterix (Billerica, MA). Further exemplary array-based methods are set forth in U.S. Pat. Nos. 9,678,068; 9,395,359; 8,415,171; 8,236,574; or 8,222,047, each of which is incorporated herein by reference. Exemplary microfluidic detection methods include those commercialized by Luminex (Austin, Texas) under the trade name xMAP® technology or used on platforms identified as MAGPIX®, LUMINEX® 100/200 or FEXMAP 3D®.

Other detection methods that can also be used, for example at low plex scale, include procedures that employ SOMAmer reagents and SOMAscan assays commercialized by Soma Logic (Boulder, CO). In one configuration, a sample is contacted with aptamers that are capable of binding proteins with specificity for the amino acid sequence of the proteins. The resulting aptamer-protein complexes can be separated from other sample components, for example, by attaching the complexes to beads (or other solid support) that are removed from other sample components. The aptamers can then be isolated and, because the aptamers are nucleic acids, the aptamers can be detected using any of a variety of methods known in the art for detecting nucleic acids, including for example, hybridization to nucleic acid arrays, PCR-based detection, or nucleic acid sequencing. Exemplary methods and compositions are set forth in U.S. Pat. Nos. 7,855,054; 7,964,356; 8,404,830; 8,945,830; 8,975,026; 8,975,388; 9,163,056; 9,938,314; 9,404,919; 9,926,566; 10,221,421; 10,239,908; 10,316,321 10,221,207 or 10,392,621, each of which is incorporated herein by reference.

In some detection assays, a protein can be cyclically modified and the modified products from individual cycles can be detected. In some configurations, a protein can be sequenced by a sequential process in which each cycle includes steps of detecting the protein and removing one or more terminal amino acids from the protein. Optionally, one or more of the steps can include adding a label to the protein, for example, at the amino terminal amino acid or at the carboxy terminal amino acid. In particular configurations, a method of detecting a protein can include steps of (i) exposing a terminal amino acid on the protein; (ii) detecting a change in signal from the protein; and (iii) identifying the type of amino acid that was removed based on the change detected in step (ii). The terminal amino acid can be exposed, for example, by removal of one or more amino acids from the amino terminus or carboxyl terminus of the protein. Steps (i) through (iii) can be repeated to produce a series of signal changes that is indicative of the sequence for the protein.

In a first configuration of a cyclical protein detection method, one or more types of amino acids in the protein can be attached to a label that uniquely identifies the type of amino acid. In this configuration, the change in signal that identifies the amino acid can be loss of signal from the respective label. For example, lysines can be attached to a distinguishable label such that loss of the label indicates removal of a lysine. Alternatively or additionally, other amino acid types can be attached to other labels that are mutually distinguishable from lysine and from each other. For example, lysines can be attached to a first label and cysteines can be attached to a second label, the first and second labels being distinguishable from each other. Exemplary compositions and techniques that can be used to remove amino acids from a protein and detect signal changes are those set forth in Swaminathan et al., Nature Biotech. 36:1076-1082 (2018); or U.S. Pat. Nos. 9,625,469 or 10,545,153, each of which is incorporated herein by reference. Methods and apparatus under development by Erisyon, Inc. (Austin, TX) may also be useful for detecting proteins.

In a second configuration of a cyclical protein detection method, a terminal amino acid of a protein can be recognized by an affinity agent that is specific for the terminal amino acid or specific for a label moiety that is present on the terminal amino acid. The affinity agent can be detected on the array, for example, due to a label on the affinity agent. Optionally, the label is a nucleic acid barcode sequence that is added to a primer nucleic acid upon formation of a complex. For example, a barcode can be added to the primer via ligation of an oligonucleotide having the barcode sequence or polymerase extension directed by a template that encodes the barcode sequence. The formation of the complex and identity of the terminal amino acid can be determined by decoding the barcode sequence. Multiple cycles can produce a series of barcodes that can be detected, for example, using a nucleic acid sequencing technique. Exemplary affinity agents and detection methods are set forth in US Pat. App. Pub. No. 2019/0145982 A1; 2020/0348308 A1; or 2020/0348307 A1, each of which is incorporated herein by reference. Methods and apparatus under development by Encodia, Inc. (San Diego, CA) may also be useful for detecting proteins.

Cyclical removal of terminal amino acids from a protein can be carried out using an Edman-type sequencing reaction in which a phenyl isothiocyanate reacts with a N-terminal amino group under mildly alkaline conditions (e.g. about pH 8) to form a cyclical phenylthiocarbamoyl Edman complex derivative. The phenyl isothiocyanate may be substituted or unsubstituted with one or more functional groups, linker groups, or linker groups containing functional groups. An Edman-type sequencing reaction can include variations to reagents and conditions that yield a detectable removal of amino acids from a protein terminus, thereby facilitating determination of the amino acid sequence for a protein or portion thereof. For example, the phenyl group can be replaced with at least one aromatic, heteroaromatic or aliphatic group which may participate in an Edman-type sequencing reaction, non-limiting examples including: pyridine, pyrimidine, pyrazine, pyridazoline, fused aromatic groups such as naphthalene and quinoline), methyl or other alkyl groups or alkyl group derivatives (e.g., alkenyl, alkynyl, cyclo-alkyl). Under certain conditions, for example, acidic conditions of about pH 2, derivatized terminal amino acids may be cleaved, for example, as a thiazolinone derivative. The thiazolinone amino acid derivative under acidic conditions may form a more stable phenylthiohydantoin (PTH) or similar amino acid derivative which can be detected. This procedure can be repeated iteratively for residual protein to identify the subsequent N-terminal amino acid. Many variations of Edman-type degradation have been described and may be used including, for example, a one-step removal of an N-terminal amino acid using alkaline conditions (Chang, J. Y., FEBS LETTS., 1978, 91(1), 63-68). In some cases, Edman-type reactions may be thwarted by N-terminal modifications which may be selectively removed, for example, N-terminal acetylation or formylation (e.g., see Gheorghe M. T., Bergman T. (1995) in Methods in Protein Structure Analysis, Chapter 8: Deacetylation and internal cleavage of Proteins for N-terminal Sequence Analysis. Springer, Boston, MA. https://doi.org/10.1007/978-1-4899-1031-8_8).

Non-limiting examples of functional groups for substituted phenyl isothiocyanate may include ligands (e.g. biotin and biotin analogs) for known receptors, labels such as luminophores, or reactive groups such as click functionalities (e.g. compositions having an azide or acetylene moiety). The functional group may be a DNA, RNA, peptide or small molecule barcode or other tag which may be further processed and/or detected.

The removal of an amino terminal amino acid using Edman-type processes can utilize at least two main steps, the first step includes reacting an isothiocyanate or equivalent with protein N-terminal residues to form a relatively stable Edman complex, for example, a phenylthiocarbamoyl complex. The second step can include removing the derivatized N-terminal amino acid, for example, via heating. The protein, now having been shortened by one amino acid, may be detected, for example, by contacting the protein with a labeled affinity agent that is complementary to the amino terminus and examining the protein for binding to the agent, or by detecting loss of a label that was attached to the removed amino acid.

Edman-type processes can be carried out in a multiplex format to detect, characterize or identify a plurality of proteins. A method of detecting a protein can include steps of (i) exposing a terminal amino acid on a protein at an address of an array; (ii) binding an affinity agent to the terminal amino acid, where the affinity agent includes a nucleic acid tag, and where a primer nucleic acid is present at the address; (iii) extending the primer nucleic acid, thereby producing an extended primer having a copy of the tag; and (iv) detecting the tag of the extended primer. The terminal amino acid can be exposed, for example, by removal of one or more amino acids from the amino terminus or carboxyl terminus of the protein. Steps (i) through (iv) can be repeated to produce a series of tags that is indicative of the sequence for the protein. The method can be applied to a plurality of proteins on the array and in parallel. Whatever the plexity, the extending of the primer can be carried out, for example, by polymerase-based extension of the primer, using the nucleic acid tag as a template. Alternatively, the extending of the primer can be carried out, for example, by ligase- or chemical-based ligation of the primer to a nucleic acid that is hybridized to the nucleic acid tag. The nucleic acid tag can be detected via hybridization to nucleic acid binding reagents (e.g. in an array), amplification-based detections (e.g. PCR-based detection, or rolling circle amplification-based detection) or nuclei acid sequencing (e.g. cyclical reversible terminator methods, nanopore methods, or single molecule, real time detection methods). Exemplary methods that can be used for detecting proteins using nucleic acid tags are set forth in US Pat. App. Pub. No. 2019/0145982 A1; 2020/0348308 A1; or 2020/0348307 A1, each of which is incorporated herein by reference.

A protein can optionally be detected based on its enzymatic or biological activity. For example, a protein can be contacted with a reactant that is converted to a detectable product by an enzymatic activity of the protein. In other assay formats, a first protein having a known enzymatic function can be contacted with a second protein to determine if the second protein changes the enzymatic function of the first protein. As such, the first protein serves as a reporter system for detection of the second protein. Exemplary changes that can be observed include, but are not limited to, activation of the enzymatic function, inhibition of the enzymatic function, attenuation of the enzymatic function, degradation of the first protein or competition for a reactant or cofactor used by the first protein. Proteins can also be detected based on their binding interactions with other molecules such as proteins, nucleic acids, nucleotides, metabolites, hormones, vitamins, small molecules that participate in biological signal transduction pathways, biological receptors or the like. For example, a protein that participates in a signal transduction pathway can be identified as a particular candidate protein by detecting binding to a second protein that is known to be a binding partner for the candidate protein in the pathway.

The presence or absence of post-translational modifications (PTM) can be detected using a composition, apparatus or method set forth herein. A PTM can be detected using an affinity agent that recognizes the PTM or based on a chemical property of the PTM. Exemplary PTMs that can be detected, identified or characterized include, but are not limited to, myristoylation, palmitoylation, isoprenylation, prenylation, farnesylation, geranylgeranylation, lipoylation, flavin moiety attachment, Heme C attachment, phosphopantetheinylation, retinylidene Schiff base formation, dipthamide formation, ethanolamine phosphoglycerol attachment, hypusine, beta-Lysine addition, acylation, acetylation, deacetylation, formylation, alkylation, methylation, C-terminal amidation, arginylation, polyglutamylation, polyglyclyation, butyrylation, gamma-carboxylation, glycosylation, glycation, polysialylation, malonylation, hydroxylation, iodination, nucleotide addition, phosphoate ester formation, phosphoramidate formation, phosphorylation, adenylylation, uridylylation, propionylation, pyrolglutamate formation, S-glutathionylation, S-nitrosylation, S-sulfenylation, S-sulfinylation, S-sulfonylation, succinylation, sulfation, glycation, carbamylation, carbonylation, isopeptide bond formation, biotinylation, carbamylation, oxidation, reduction, pegylation, ISGylation, SUMOylation, ubiquitination, neddylation, pupylation, citrullination, deamidation, elminylation, disulfide bridge formation, proteolytic cleavage, isoaspartate formation, racemization, and protein splicing.

PTMs may occur at particular amino acid residues of a protein. For example, the phosphate moiety of a particular proteoform can be present on a serine, threonine, tyrosine, histidine, cysteine, lysine, aspartate or glutamate residue of the protein. In other examples, an acetyl moiety can be present on the N-terminus or on a lysine; a serine or threonine residue can have an O-linked glycosyl moiety; an asparagine residue can have an N-linked glycosyl moiety; a proline, lysine, asparagine, aspartate or histidine amino acid can be hydroxylated; an arginine or lysine residue can be methylated; or the N-terminal methionine or at a lysine amino acid can be ubiquitinated.

In some configurations of the apparatus and methods set forth herein, one or more proteins can be detected on a solid support. For example, protein(s) can be coupled to a support, the support can be contacted with detection agents (e.g. affinity agents) in solution, the agents can interact with the protein(s), thereby producing a detectable signal, and then the signal can be detected to determine the presence of the protein(s). In multiplexed versions of this approach, different proteins can be coupled to different addresses in an array, and the probing and detection steps can occur in parallel. In another example, affinity agents can be coupled to a solid support, the support can be contacted with proteins in solution, the proteins can interact with the affinity agents, thereby producing a detectable signal, and then the signal can be detected to determine presence, quantity or characteristics of the proteins. This approach can also be multiplexed by coupling different affinity agents to different addresses of an array.

Proteins, affinity agents or other objects of interest can be coupled to a solid support via covalent or non-covalent bonds. For example, a linker can be used to covalently couple a protein or other object of interest to an array. A particularly useful linker is a structured nucleic acid particle such as a nucleic acid nanoball (e.g. a concatemeric amplicon produced by rolling circle replication of a circular nucleic acid template) or a nucleic acid origami. For example, a plurality of proteins can be conjugated to a plurality of structured nucleic acid particles, such that each protein-conjugated particle forms an address in the array. Exemplary linkers for coupling proteins, or other objects of interest, to an array or other solid support are set forth in US Pat. App. Pub. No. 2021/0101930 A1, which is incorporated herein by reference.

A protein can be detected based on proximity of two or more affinity agents. For example, the two affinity agents can include two components each: a receptor component and a nucleic acid component. When the affinity agents bind in proximity to each other, for example, due to ligands for the respective receptors being on a single protein, or due to the ligands being present on two proteins that associate with each other, the nucleic acids can interact to cause a modification that is indicative of the two ligands being in proximity. Optionally, the modification can be polymerase catalyzed extension of one of the nucleic acids using the other nucleic acid as a template. As another option, one of the nucleic acids can form a template that acts as splint to position other nucleic acids for ligation to an oligonucleotide. Exemplary methods are commercialized by Olink Proteomics AB (Uppsala Sweden) or set forth in U.S. Pat. Nos. 7,306,904; 7,351,528; 8,013,134; 8,268,554 or 9,777,315, each of which is incorporated herein by reference.

A method or apparatus of the present disclosure can optionally be configured for optical detection (e.g. luminescence detection). Analytes or other entities can be detected, and optionally distinguished from each other, based on measurable characteristics such as the wavelength of radiation that excites a luminophore, the wavelength of radiation emitted by a luminophore, the intensity of radiation emitted by a luminophore (e.g. at particular detection wavelength(s)), luminescence lifetime (e.g. the time that a luminophore remains in an excited state) or luminescence polarity. Other optical characteristics that can be detected, and optionally used to distinguish analytes, include, for example, absorbance of radiation, resonance Raman, radiation scattering, or the like. A luminophore can be an intrinsic moiety of a protein or other analyte to be detected, or the luminophore can be an exogenous moiety that has been synthetically added to a protein or other analyte.

A method or apparatus of the present disclosure can use a light sensing device that is appropriate for detecting a characteristic set forth herein or known in the art. Particularly useful components of a light sensing device can include, but are not limited to, optical sub-systems or components used in nucleic acid sequencing systems. Examples of useful sub systems and components thereof are set forth in US Pat. App. Pub. No. 2010/0111768 A1 or U.S. Pat. Nos. 7,329,860; 8,951,781 or 9,193,996, each of which is incorporated herein by reference. Other useful light sensing devices and components thereof are described in U.S. Pat. Nos. 5,888,737; 6,175,002; 5,695,934; 6,140,489; or 5,863,722; or US Pat. Pub. Nos. 2007/007991 A1, 2009/0247414 A1, or 2010/0111768; or WO2007/123744, each of which is incorporated herein by reference. Light sensing devices and components that can be used to detect luminophores based on luminescence lifetime are described, for example, in U.S. Pat. Nos. 9,678,012; 9,921,157; 10,605,730; 10,712,274; 10,775,305; or 10,895,534, each of which is incorporated herein by reference.

Luminescence lifetime can be detected using an integrated circuit having a photodetection region configured to receive incident photons and produce a plurality of charge carriers in response to the incident photons. The integrated circuit can include at least one charge carrier storage region and a charge carrier segregation structure configured to selectively direct charge carriers of the plurality of charge carriers directly into the charge carrier storage region based upon times at which the charge carriers are produced. See, for example, U.S. Pat. Nos. 9,606,058, 10,775,305, and 10,845,308, each of which is incorporated herein by reference. Optical sources that produce short optical pulses can be used for luminescence lifetime measurements. For example, a light source, such as a semiconductor laser or LED, can be driven with a bipolar waveform to generate optical pulses with FWHM durations as short as approximately 85 ps having suppressed tail emission. See, for example, in U.S. Pat. No. 10,605,730, which is incorporated herein by reference.

For configurations that use optical detection (e.g. luminescent detection), one or more analytes (e.g. proteins) may be immobilized on a surface, and this surface may be scanned with a microscope to detect any signal from the immobilized analytes. The microscope itself may include a digital camera or other luminescence detector configured to record, store, and analyze the data collected during the scan. A luminescence detector of the present disclosure can be configured for epiluminescent detection, total internal reflection (TIR) detection, waveguide assisted excitation, or the like.

A light sensing device may be based upon any suitable technology, and may be, for example, a charged coupled device (CCD) sensor that generates pixilated image data based upon photons impacting locations in the device. It will be understood that any of a variety of other light sensing devices may also be used including, but not limited to, a detector array configured for time delay integration (TDI) operation, a complementary metal oxide semiconductor (CMOS) detector, an avalanche photodiode (APD) detector, a Geiger-mode photon counter, a photomultiplier tube (PMT), charge injection device (CID) sensors, JOT image sensor (Quanta), or any other suitable detector. Light sensing devices can optionally be coupled with one or more excitation sources, for example, lasers, light emitting diodes (LEDs), arc lamps or other energy sources known in the art.

An optical detection system can be configured for single molecule detection. For example, waveguides or optical confinements can be used to deliver excitation radiation to locations of a solid support where analytes are located. Zero-mode waveguides can be particularly useful, examples of which are set forth in U.S. Pat. Nos. 7,181,122, 7,302,146, or 7,313,308, each of which is incorporated herein by reference. Analytes can be confined to surface features, for example, to facilitate single molecule resolution. For example, analytes can be distributed into wells having nanometer dimensions such as those set forth in U.S. Pat. Nos. 7,122,482 or 8,765,359, or US Pat. App. Pub. No 2013/0116153 A1, each of which is incorporated herein by reference. The wells can be configured for selective excitation, for example, as set forth in U.S. Pat. No. 8,798,414 or 9,347,829, each of which is incorporated herein by reference. Analytes can be distributed to nanometer-scale posts, such as high aspect ratio posts which can optionally be dielectric pillars that extend through a metallic layer to improve detection of an analyte coupled to the pillar. See, for example, U.S. Pat. Nos. 8,148,264, 9,410,887 or 9,987,609, each of which is incorporated herein by reference. Further examples of nanostructures that can be used to detect analytes are those that change state in response to the concentration of analytes such that the analytes can be quantitated as set forth in WO 2020/176793 A1, which is incorporated herein by reference.

An apparatus or method set forth herein need not be configured for optical detection. For example, an electronic detector can be used for detection of protons or charged labels (see, for example, US Pat. App. Pub. Nos. 2009/0026082 A1; 2009/0127589 A1; 2010/0137143 A1; or 2010/0282617 A1, each of which is incorporated herein by reference in its entirety). A field effect transistor (FET) can be used to detect analytes or other entities, for example, based on proximity of a field disrupting moiety to the FET. The field disrupting moiety can be due to an extrinsic label coupled to an analyte or affinity agent, or the moiety can be intrinsic to the analyte or affinity agent being used. Surface plasmon resonance can be used to detect binding of analytes or affinity agents at or near a surface. Exemplary sensors and methods for coupling molecules to sensors are set forth in US Pat. App. Pub. Nos. 2017/0240962 A1; 2018/0051316 A1; 2018/0112265 A1; 2018/0155773 A1 or 2018/0305727 A1; or U.S. Pat. Nos. 9,164,053; 9,829,456; 10,036,064, each of which is incorporated herein by reference.

In some configurations of the compositions, apparatus and methods set forth herein, one or more proteins can be present on a solid support, where the proteins can optionally be detected. For example, a protein can be coupled to a solid support, the solid support can be contacted with a detection agent (e.g. affinity agent) in solution, the affinity agent can interact with the protein, thereby producing a detectable signal, and then the signal can be detected to determine the presence, absence, quantity, a characteristic or identity of the protein. In multiplexed versions of this approach, different proteins can be coupled to different addresses in an array, and the detection steps can occur in parallel, such that proteins at each address are detected, quantified, characterized or identified. In another example, detection agents can be coupled to a solid support, the support can be contacted with proteins in solution, the proteins can interact with the detection agents, thereby producing a detectable signal, and then the signal can be detected to determine the presence of the proteins. This approach can also be multiplexed by coupling different binding reagents to different addresses of an array.

In multiplexed configurations, different proteins can be coupled to different unique identifiers (e.g. addresses in an array), and the proteins can be manipulated and detected in parallel. For example, a fluid containing one or more different affinity agents can be delivered to an array such that the proteins of the array are in simultaneous contact with the affinity agent(s). Moreover, a plurality of addresses can be observed in parallel allowing for rapid detection of binding events. A plurality of different proteins can have a complexity of at least 5, 10, 100, 1×10³, 1×10⁴, 1×10⁵ or more different native-length protein primary sequences. Alternatively or additionally, a proteome, proteome subfraction or other protein sample that is analyzed in a method set forth herein can have a complexity that is at most 1×10⁵, 1×10⁴, 1×10³, 100, 10, 5 or fewer different native-length protein primary sequences. The total number of proteins of a sample that is detected, characterized or identified can differ from the number of different primary sequences in the sample, for example, due to the presence of multiple copies of at least some protein species. Moreover, the total number of proteins of a sample that is detected, characterized or identified can differ from the number of candidate proteins suspected of being in the sample, for example, due to the presence of multiple copies of at least some protein species, absence of some proteins in a source for the sample, or loss of some proteins prior to analysis.

A protein can be coupled to a unique identifier using any of a variety of means. The coupling can be covalent or non-covalent. Exemplary covalent attachments include chemical linkers such as those achieved using click chemistry or other linkages known in the art or described in U.S. patent application Ser. No. 17/062,405, which is incorporated herein by reference. Non-covalent attachment can be mediated by receptor-ligand interactions (e.g. (strept)avidin-biotin, antibody-antigen, or complementary nucleic acid strands), for example, wherein the receptor is attached to the unique identifier and the ligand is attached to the protein or vice versa. In particular configurations, a protein is coupled to a solid support (e.g. an address in an array) via a structured nucleic acid particle (SNAP). A protein can be coupled to a SNAP and the SNAP can interact with a solid support, for example, by non-covalent interactions of the DNA with the support and/or via covalent linkage of the SNAP to the support. Nucleic acid origami or nucleic acid nanoballs are particularly useful. The use of SNAPs and other moieties to couple proteins to unique identifiers such as tags or addresses in an array are set forth in US Pat. App. Ser. Nos. 17/062,405 and 63/159,500, each of which is incorporated herein by reference.

The methods, compositions and apparatus of the present disclosure are particularly well suited for use with proteins. Although proteins are exemplified throughout the present disclosure, it will be understood that other analytes can be similarly used. Exemplary analytes include, but are not limited to, biomolecules, polysaccharides, nucleic acids, lipids, metabolites, hormones, vitamins, enzyme cofactors, therapeutic agents, candidate therapeutic agents or combinations thereof. An analyte can be a non-biological atom or molecule, such as a synthetic polymer, metal, metal oxide, ceramic, semiconductor, mineral, or a combination thereof.

One or more proteins that are used in a method, composition or apparatus herein, can be derived from a natural or synthetic source. Exemplary sources include, but are not limited to biological tissues, fluids, cells or subcellular compartments (e.g. organelles). For example, a sample can be derived from a tissue biopsy, biological fluid (e.g. blood, sweat, tears, plasma, extracellular fluid, urine, mucus, saliva, semen, vaginal fluid, synovial fluid, lymph, cerebrospinal fluid, peritoneal fluid, pleural fluid, amniotic fluid, intracellular fluid, extracellular fluid, etc.), fecal sample, hair sample, cultured cell, culture media, fixed tissue sample (e.g. fresh frozen or formalin-fixed paraffin-embedded) or product of a protein synthesis reaction. A protein source may include any sample where a protein is a native or expected constituent. For example, a primary source for a cancer biomarker protein may be a tumor biopsy sample or bodily fluid. Other sources include environmental samples or forensic samples.

Exemplary organisms from which proteins or other analytes can be derived include, for example, a mammal such as a rodent, mouse, rat, rabbit, guinea pig, ungulate, horse, sheep, pig, goat, cow, cat, dog, primate, non-human primate or human; a plant such as Arabidopsis thaliana, tobacco, corn, sorghum, oat, wheat, rice, canola, or soybean; an algae such as Chlamydomonas reinhardtii; a nematode such as Caenorhabditis elegans; an insect such as Drosophila melanogaster, mosquito, fruit fly, honey bee or spider; a fish such as zebrafish; a reptile; an amphibian such as a frog or Xenopus laevis; a Dictyostelium discoideum; a fungi such as Pneumocystis carinii, Takifugu rubripes, yeast, Saccharamoyces cerevisiae or Schizosaccharomyces pombe; or a Plasmodium falciparum. Proteins can also be derived from a prokaryote such as a bacterium, Escherichia coli, staphylococci or Mycoplasma pneumoniae; an archae; a virus such as Hepatitis C virus, influenza virus, coronavirus, or human immunodeficiency virus; or a viroid. Proteins can be derived from a homogeneous culture or population of the above organisms or alternatively from a collection of several different organisms, for example, in a community or ecosystem.

In some cases, a protein or other biomolecule can be derived from an organism that is collected from a host organism. For example, a protein may be derived from a parasitic, pathogenic, symbiotic, or latent organism collected from a host organism. A protein can be derived from an organism, tissue, cell or biological fluid that is known or suspected of being linked with a disease state or disorder (e.g., cancer). Alternatively, a protein can be derived from an organism, tissue, cell or biological fluid that is known or suspected of not being linked to a particular disease state or disorder. For example, the proteins isolated from such a source can be used as a control for comparison to results acquired from a source that is known or suspected of being linked to the particular disease state or disorder. A sample may include a microbiome or substantial portion of a microbiome. In some cases, one or more proteins used in a method, composition or apparatus set forth herein may be obtained from a single source and no more than the single source. The single source can be, for example, a single organism (e.g. an individual human), single tissue, single cell, single organelle (e.g. endoplasmic reticulum, Golgi apparatus or nucleus), or single protein-containing particle (e.g., a viral particle or vesicle).

A method, composition or apparatus of the present disclosure can use or include a plurality of proteins having any of a variety of compositions such as a plurality of proteins composed of a proteome or fraction thereof. For example, a plurality of proteins can include solution-phase proteins, such as proteins in a biological sample or fraction thereof, or a plurality of proteins can include proteins that are immobilized, such as proteins coupled to a particle or solid support. By way of further example, a plurality of proteins can include proteins that are detected, analyzed or identified in connection with a method, composition or apparatus of the present disclosure. The content of a plurality of proteins can be understood according to any of a variety of characteristics such as those set forth below or elsewhere herein.

A plurality of proteins can be characterized in terms of total protein mass. The total mass of protein in a liter of plasma has been estimated to be 70 g and the total mass of protein in a human cell has been estimated to be between 100 pg and 500 pg depending upon cells type. See Wisniewski et al. Molecular & Cellular Proteomics 13:10.1074/mcp.M113.037309, 3497-3506 (2014), which is incorporated herein by reference. A plurality of proteins used or included in a method, composition or apparatus set forth herein can include at least 1 pg, 10 pg, 100 pg, 1 ng, 10 ng, 100 ng, 1 μg, 10 μg, 100 μg, 1 mg, 10 mg, 100 mg or more protein by mass. Alternatively or additionally, a plurality of proteins may contain at most 100 mg, 10 mg, 1 mg, 100 μg, 10 μg, 1 μg, 100 ng, 10 ng, 1 ng, 100 pg, 10 pg, 1 pg or less protein by mass.

A plurality of proteins can be characterized in terms of percent mass relative to a given source such as a biological source (e.g. cell, tissue, or biological fluid such as blood). For example, a plurality of proteins may contain at least 60%, 75%, 90%, 95%, 99%, 99.9% or more of the total protein mass present in the source from which the plurality of proteins was derived. Alternatively or additionally, a plurality of proteins may contain at most 99.9%, 99%, 95%, 90%, 75%, 60% or less of the total protein mass present in the source from which the plurality of proteins was derived.

A plurality of proteins can be characterized in terms of total number of protein molecules. The total number of protein molecules in a Saccharomyces cerevisiae cell has been estimated to be about 42 million protein molecules. See Ho et al., Cell Systems (2018), DOI: 10.1016/j.cels.2017.12.004, which is incorporated herein by reference. A plurality of proteins used or included in a method, composition or apparatus set forth herein can include at least 1 protein molecule, 10 protein molecules, 100 protein molecules, 1×10⁴ protein molecules, 1×10⁶ protein molecules, 1×10⁸ protein molecules, 1×10¹⁰ protein molecules, 1 mole (6.02214076×10²³ molecules) of protein, 10 moles of protein molecules, 100 moles of protein molecules or more. Alternatively or additionally, a plurality of proteins may contain at most 100 moles of protein molecules, 10 moles of protein molecules, 1 mole of protein molecules, 1×10¹⁰ protein molecules, 1×10⁸ protein molecules, 1×10⁶ protein molecules, 1×10⁴ protein molecules, 100 protein molecules, 10 protein molecules, 1 protein molecule or less.

A plurality of proteins can be characterized in terms of the variety of full-length primary protein structures in the plurality. For example, the variety of full-length primary protein structures in a plurality of proteins can be equated with the number of different protein-encoding genes in the source for the plurality of proteins. Whether or not the proteins are derived from a known genome or from any genome at all, the variety of full-length primary protein structures can be counted independent of presence or absence of post translational modifications in the proteins. A human proteome is estimated to have about 20,000 different protein-encoding genes such that a plurality of proteins derived from a human can include up to about 20,000 different primary protein structures. See Aebersold et al., Nat. Chem. Biol. 14:206-214 (2018), which is incorporated herein by reference. Other genomes and proteomes in nature are known to be larger or smaller. A plurality of proteins used or included in a method, composition or apparatus set forth herein can have a complexity of at least 2, 5, 10, 100, 1×10³, 1×10⁴, 2×10⁴, 3×10⁴ or more different full-length primary protein structures. Alternatively or additionally, a plurality of proteins can have a complexity that is at most 3×10⁴, 2×10⁴, 1×10⁴, 1×10³, 100, 10, 5, 2 or fewer different full-length primary protein structures.

In relative terms, a plurality of proteins used or included in a method, composition or apparatus set forth herein may contain at least one representative for at least 60%, 75%, 90%, 95%, 99%, 99.9% or more of the proteins encoded by the genome of a source from which the sample was derived. Alternatively or additionally, a plurality of proteins may contain a representative for at most 99.9%, 99%, 95%, 90%, 75%, 60% or less of the proteins encoded by the genome of a source from which the sample was derived.

A plurality of proteins can be characterized in terms of the variety of primary protein structures in the plurality including transcribed splice variants. The human proteome has been estimated to include about 70,000 different primary protein structures when splice variants are included. See Aebersold et al., Nat. Chem. Biol. 14:206-214 (2018), which is incorporated herein by reference. Moreover, the number of the partial-length primary protein structures can increase due to fragmentation that occurs in a sample. A plurality of proteins used or included in a method, composition or apparatus set forth herein can have a complexity of at least 2, 5, 10, 100, 1×10³, 1×10⁴, 7×10⁴, 1×10⁵, 1×10⁶ or more different primary protein structures. Alternatively or additionally, a plurality of proteins can have a complexity that is at most 1×10⁶, 1×10⁵, 7×10⁴, 1×10⁴, 1×10³, 100, 10, 5, 2 or fewer different primary protein structures.

A plurality of proteins can be characterized in terms of the variety of protein structures in the plurality including different primary structures and different proteoforms among the primary structures. Different molecular forms of proteins expressed from a given gene are considered to be different proteoforms. Protoeforms can differ, for example, due to differences in primary structure (e.g. shorter or longer amino acid sequences), different arrangement of domains (e.g. transcriptional splice variants), or different post translational modifications (e.g. presence or absence of phosphoryl, glycosyl, acetyl, or ubiquitin moieties). The human proteome is estimated to include hundreds of thousands of proteins when counting the different primary structures and proteoforms. See Aebersold et al., Nat. Chem. Biol. 14:206-214 (2018), which is incorporated herein by reference. A plurality of proteins used or included in a method, composition or apparatus set forth herein can have a complexity of at least 2, 5, 10, 100, 1×10³, 1×10⁴, 1×10⁵, 1×10⁶, 5×10⁶, 1×10⁷ or more different protein structures. Alternatively or additionally, a plurality of proteins can have a complexity that is at most 1×10⁷, 5×10⁶, 1×10⁶, 1×10⁵, 1×10⁴, 1×10³, 100, 10, 5, 2 or fewer different protein structures.

A plurality of proteins can be characterized in terms of the dynamic range for the different protein structures in the sample. The dynamic range can be a measure of the range of abundance for all different protein structures in a plurality of proteins, the range of abundance for all different primary protein structures in a plurality of proteins, the range of abundance for all different full-length primary protein structures in a plurality of proteins, the range of abundance for all different full-length gene products in a plurality of proteins, the range of abundance for all different proteoforms expressed from a given gene, or the range of abundance for any other set of different proteins set forth herein. The dynamic range for all proteins in human plasma is estimated to span more than 10 orders of magnitude from albumin, the most abundant protein, to the rarest proteins that have been measured clinically. See Anderson and Anderson Mol Cell Proteomics 1:845-67 (2002), which is incorporated herein by reference. The dynamic range for plurality of proteins set forth herein can be a factor of at least 10, 100, 1×10³, 1×10⁴, 1×10⁶, 1×10⁸, 1×10¹⁰, or more. Alternatively or additionally, the dynamic range for plurality of proteins set forth herein can be a factor of at most 1×10¹⁰, 1×10⁸, 1×10⁶, 1×10⁴, 1×10³, 100, 10 or less.

A method set forth herein can be carried out in a fluid phase or on a solid phase. For fluid phase configurations, a fluid containing one or more proteins can be mixed with another fluid containing one or more affinity agents. For solid phase configurations one or more proteins or affinity agents can be coupled to a solid support. One or more components that will participate in a binding event can be contained in a fluid and the fluid can be delivered to a solid support, the solid support being coupled to one or more other component that will participate in the binding event.

A method of the present disclosure can be carried out at single analyte resolution.

Alternatively to single-analyte resolution, a method can be carried out at ensemble-resolution or bulk-resolution. Bulk-resolution configurations acquire a composite signal from a plurality of different analytes or affinity agents in a vessel or on a surface. For example, a composite signal can be acquired from a population of different protein-affinity agent complexes in a well or cuvette, or on a solid support surface, such that individual complexes are not resolved from each other. Ensemble-resolution configurations acquire a composite signal from a first collection of proteins or affinity agents in a sample, such that the composite signal is distinguishable from signals generated by a second collection of proteins or affinity agents in the sample. For example, the ensembles can be located at different addresses in an array. Accordingly, the composite signal obtained from each address will be an average of signals from the ensemble, yet signals from different addresses can be distinguished from each other.

A composition, apparatus or method set forth herein can be configured to contact one or more proteins (e.g. an array of different proteins) with a plurality of different affinity agents. For example, a plurality of affinity agents (whether configured separately or as a pool) may include at least 2, 5, 10, 25, 50, 100, 250, 500 or more types of affinity agents, each type of affinity agent differing from the other types with respect to the epitope(s) recognized. Alternatively or additionally, a plurality of affinity agents may include at most 500, 250, 100, 50, 25, 10, 5, or 2 types of affinity agents, each type of affinity agent differing from the other types with respect to the epitope(s) recognized. Different types of affinity agents in a pool can be uniquely labeled such that the different types can be distinguished from each other. In some configurations, at least two, and up to all, of the different types of affinity agents in a pool may be indistinguishably labeled with respect to each other. Alternatively or additionally to the use of unique labels, different types of affinity agents can be delivered and detected serially when evaluating one or more proteins (e.g. in an array).

A method of the present disclosure can be performed in a multiplex format. In multiplexed configurations, different proteins can be coupled to different unique identifiers (e.g. the proteins can be coupled to different addresses in an array). Multiplexed proteins can be manipulated and detected in parallel. For example, a fluid containing one or more different affinity agents can be delivered to a protein array such that the proteins of the array are in simultaneous contact with the affinity agent(s). Moreover, a plurality of addresses can be observed in parallel allowing for rapid detection of binding events. A plurality of different proteins can have a complexity of at least 5, 10, 100, 1×10³, 1×10⁴, 2×10⁴, 3×10⁴ or more different native-length protein primary sequences. Alternatively or additionally, a proteome or proteome subfraction that is analyzed in a method set forth herein can have a complexity that is at most 3×10⁴, 2×10⁴, 1×10⁴, 1×10³, 100, 10, 5 or fewer different native-length protein primary sequences. The plurality of proteins can constitute a proteome or subfraction of a proteome. The total number of proteins that is detected, characterized or identified can differ from the number of different primary sequences in the sample from which the proteins are derived, for example, due to the presence of multiple copies of at least some protein species. Moreover, the total number of proteins that are detected, characterized or identified can differ from the number of candidate proteins suspected of being present, for example, due to the presence of multiple copies of at least some protein species, absence of some proteins in a source for the proteins, or loss of some proteins prior to analysis.

A particularly useful multiplex format uses an array of proteins and/or affinity agents. A polypeptide, anchoring group, polypeptide composite or other analyte can be coupled to a unique identifier, such as an address in an array, using any of a variety of means. The coupling can be covalent or non-covalent. Exemplary covalent attachments include chemical linkers such as those achieved using click chemistry or other linkages known in the art or described in US Pat. App. Pub. No. 2021/0101930 A1, which is incorporated herein by reference. Non-covalent attachment can be mediated by receptor-ligand interactions (e.g. (strept)avidin-biotin, antibody-antigen, or complementary nucleic acid strands), for example, in which the receptor is attached to the unique identifier and the ligand is attached to the protein or vice versa. In particular configurations, a protein is coupled to a solid support (e.g. an address in an array) via a structured nucleic acid particle (SNAP). A protein can be coupled to a SNAP and the SNAP can interact with a solid support, for example, by non-covalent interactions of the DNA with the support and/or via covalent linkage of the SNAP to the support. Nucleic acid origami or nucleic acid nanoballs are particularly useful. The use of SNAPs and other moieties to couple proteins to unique identifiers such as tags or addresses in an array are set forth in US Pat. App. Pub. No. 2021/0101930 A1, which is incorporated herein by reference.

A solid support or a surface thereof may be configured to display an analyte or a plurality of analytes. A solid support may contain one or more patterned, formed, or prepared surfaces that contain at least one address for displaying an analyte. In some cases, a solid support may contain one or more patterned, formed, or prepared surfaces that contain a plurality of addresses, with each address configured to display one or more analytes. Accordingly, an array as set forth herein may comprise a plurality of analytes coupled to a solid support or a surface thereof. In some configurations, a solid support or a surface thereof may be patterned or formed to produce an ordered or patterned array of addresses. The deposition of analytes on the ordered or patterned array of addresses may be controlled by interactions between the solid support and the analytes such as, for example, electrostatic interactions, magnetic interactions, hydrophobic interactions, hydrophilic interactions, covalent interactions, or non-covalent interactions. Accordingly, the coupling of an analyte at each address of an array may produce an ordered or patterned array of analytes whose average spacing between analytes is determined based upon the tolerance of the ordering or patterning of the solid support and the size of an analyte-binding region for each address. An ordered or patterned array of analytes may be characterized as having a regular geometry, such as a rectangular, triangular, polygonal, or annular grid. In other configurations, a solid support or a surface thereof may be non-patterned or non-ordered. The deposition of analytes on the non-ordered or non-patterned array of addresses may be controlled by interactions between the solid support and the analytes, or inter-analyte interactions such as, for example, steric repulsion, electrostatic repulsion, electrostatic attraction, magnetic repulsion, magnetic attraction, covalent interactions, or non-covalent interactions.

A solid support or a surface thereof may contain one or more structures or features. A structure or feature may comprise an elevation, profile, shape, geometry, or configuration that deviates from an average elevation, profile, shape, geometry, or configuration of a solid support or surface thereof. A structure or feature may be a protruding structure or feature, such as a ridge, post, pillar, or pad, if the structure or feature extends above the average elevation of a surface of a solid support. A structure or feature may be a depressed structure, such as a channel, well, pore, or hole, if the structure or feature extends below the average elevation of a surface of a solid support. A structure or feature may be an intrinsic structure or feature of a substrate (i.e., arising due to the physical or chemical properties of the substrate, or a physical or chemical mechanism of formation), such as surface roughness structures, crystal structures, or porosity. A structure or feature may be formed by a method of processing a solid support. In some configurations, a solid support or a surface may be processed by a lithographic method to form one or more structures or features. A solid support or a surface thereof may be formed by a suitable lithographic method, including, but not limited to photolithography, Dip-Pen nanolithography, nanoimprint lithography, nanosphere lithography, nanoball lithography, nanopillar arrays, nanowire lithography, immersion lithography, neutral particle lithography, plasmonic lithography, scanning probe lithography, thermochemical lithography, thermal scanning probe lithography, local oxidation nanolithography, molecular self-assembly, stencil lithography, laser interference lithography, soft lithography, magnetolithography, stereolithography, deep ultraviolet lithography, x-ray lithography, ion projection lithography, proton-beam lithography, or electron-beam lithography.

A solid support or surface may comprise a plurality of structures or features. A plurality of structures or features may comprise an ordered or patterned array of structures or features. A plurality of structures or features may comprise an non-ordered, non-patterned, or random array of structures or features. A structure or feature may have an average characteristic dimension (e.g., length, width, height, diameter, circumference, etc.) of at least about 1 nanometer (nm), 5 nm, 10 nm, 20 nm, 30 nm, 40 nm, 50 nm, 75 nm, 100 nm, 150 nm, 200 nm, 250 nm, 300 nm, 400 nm, 500 nm, 750 nm, 1000 nm, or more than 1000 nm. Alternatively or additionally, a structure or feature may have an average characteristic dimension of no more than about 1000 nm, 750 nm, 500 nm, 400 nm, 300 nm, 250 nm, 200 nm, 150 nm, 100 nm, 75 nm, 50 nm, 40 nm, 30 nm, 20 nm, 10 nm, 5 nm, 1 nm, or less than 1 nm. An array of structures or features may have an average pitch, in which the pitch is measured as the average separation between respective centerpoints of neighboring structures or features. An array may have an average pitch of at least about 1 nm, 5 nm, 10 nm, 20 nm, 30 nm, 40 nm, 50 nm, 75 nm, 100 nm, 150 nm, 200 nm, 250 nm, 300 nm, 400 nm, 500 nm, 750 nm, 1 micron (μm), 2 μm, 5 μm, 10 μm, 50 μm, 100 μm, or more than 100 μm. Alternatively or additionally, an array may have an average pitch of no more than about 100 μm, 50 μm, 10 μm, 5 μm, 1 μm, 750 nm, 500 nm, 400 nm, 300 nm, 250 nm, 200 nm, 150 nm, 100 nm, 75 nm, 50 nm, 40 nm, 30 nm, 20 nm, 10 nm, 5 nm, 1 nm, or less than 1 nm.

A solid support or a surface thereof may include a base substrate material and, optionally, one or more additional materials that are contacted or adhered with the substrate material. A solid support may comprise one or more additional materials that are deposited, coated, or inlayed onto the substrate material. Additional materials may be added to the substrate material to alter the properties of the substrate material. For example, materials may be added to alter the surface chemistry (e.g., hydrophobicity, hydrophilicity, non-specific binding, electrostatic properties), alter the optical properties (e.g., reflective properties, refractive properties), alter the electrical or magnetic properties (e.g., dielectric materials, conducting materials, electrically-insulating materials), or alter the heat transfer characteristics of the substrate material. Additional materials contacted or adhered with a substrate material may be ordered or patterned onto the substrate material to, for example, locate the additional material at addresses or locate the additional material at interstitial regions between addresses. Exemplary additional materials may include metals (e.g., gold, silver, copper, etc.), metal oxides (e.g., titanium oxide, silicon dioxide, alumina, iron oxides, etc.), metal nitrides (e.g., silicon nitride, aluminum nitride, boron nitride, gallium nitride, etc.), metal carbides (e.g., tungsten carbide, titanium carbide, iron carbide, etc.), metal sulfides (e.g., iron sulfide, silver sulfide, etc.), and organic moieties (e.g., polyethylene glycol (PEG), dextrans, chemically-reactive functional groups, etc.).

A method of the present disclosure can include the step of coupling one or more analytes to a solid support or a surface thereof prior to performing a detection step set forth herein. The coupling of one or more analytes to a solid support surface may include covalent or non-covalent coupling of the one or more analytes to the solid support. Covalent coupling of an analyte to a solid support can include direct covalent coupling of an analyte to a solid support (e.g., formation of coordination bonds) or indirect covalent coupling between a reactive functional group of the analyte and a reactive functional group that is coupled to the solid support (e.g., a CLICK-type reaction). Non-covalent coupling can include the formation of any non-covalent interaction between an analyte and a solid support, including electrostatic or magnetic interactions, or non-covalent bonding interactions (e.g., ionic bonds, van der Waals interactions, hydrogen bonding, etc.). The skilled person will readily recognize that the particular analyte and the choice of solid support can affect the selection of a coupling chemistry for the compositions and methods set forth herein.

Accordingly, a coupling chemistry may be selected based upon the criterium that it provides a sufficiently stable coupling of an analyte to a solid support for a time scale that meets or exceeds the time scale of a method as set forth herein. For example, a polypeptide identification method can require a coupling of the analyte to the solid support for a sufficient amount of time to permit a series of empirical measurements of the analyte to occur. An analyte may be continuously coupled to a solid support for an observable length of time such as, for example, at least about 1 minute, 1 hour (hr), 3 hrs, 6 hrs, 12 hrs, 1 day, 1.5 days, 2 days, 3 days, 1 week (wk), 2 wks, 3 wks, 1 month, or more. The coupling of an analyte to a solid support can occur with a solution-phase chemistry that promotes the deposition of the analyte on the solid support. Coupling of an analyte to a solid support may occur under solution conditions that are optimized for any conceivable solution property, including solution composition, species concentrations, pH, ionic strength, solution temperature, etc. Solution composition can be varied by chemical species, such as buffer type, salts, acids, bases, and surfactants. In some configurations, species such as salts and surfactants may be selected to facilitate the formation of interactions between an analyte and a solid support. Covalent coupling methods for coupling an analyte to a solid support may include species such as catalyst, initiators, and promoters to facilitate particular reactive chemistries.

Coupling of an analyte to a solid support may be facilitated by a mediating group. A mediating group may modify the properties of the analyte to facilitate the coupling. Useful mediating groups have been set forth herein (e.g., structured nucleic acid particles). In some configurations, a mediating group can be coupled to an analyte prior to coupling the analyte to a solid support. Accordingly, the mediating group may be chosen to increase the strength, control, or specificity of the coupling of the analyte to the solid support. In other configurations, a mediating group can be coupled to a solid support prior to coupling an analyte to the solid support. Accordingly, the mediating group may be chosen to provide a more favorable coupling chemistry than can be provided by the solid support alone.

The following clauses describe specific embodiments of the disclosure.

Clause 1. A fluidic vessel, comprising a chamber bounded by at least one substantially planar surface and a second surface, a first port between the chamber and an exterior of the fluidic vessel, a second port between the chamber and the exterior of the fluidic vessel, and a channel disposed between the first port and the second port, wherein the channel is bounded by the at least one substantially planar surface and the second surface, wherein the fluidic vessel further comprises an offset structure, wherein the first port is configured to deliver fluid to a surface of the offset structure, wherein the surface of the offset structure is substantially parallel to the surface of the substantially planar surface, and wherein a depth of the chamber between the surface of the offset structure and the second surface of the chamber is less than the depth of the chamber between the substantially planar surface and the second surface of the chamber.

Clause 2. The fluidic vessel of clause 1, wherein a fluid flow within the chamber has an average speed of at least 80% of the maximum speed of the fluid flow.

Clause 3. The fluidic vessel of clause 1 or 2, wherein the substantially planar surface comprises an array, wherein the array comprises a plurality of sites.

Clause 4. The fluidic vessel of any one of clauses 1-3, wherein the average speed of a fluid flow is measured along an axis that is offset from and parallel to the substantially planar surface, wherein the axis is oriented substantially orthogonal to the direction of the fluid flow.

Clause 5. The fluidic vessel of any one of clauses 1-4, wherein the offset structure further comprises a curved edge, wherein the curved edge occurs at a transition between the surface of the offset structure and the substantially planar surface.

Clause 6. The fluidic vessel of clause 5, wherein a downstream distance between a centerpoint of the curved edge and a centerpoint of the first port is less than a downstream distance between an edge point of the curved edge and the centerpoint of the first port, wherein the downstream distance is measured as the distance between the curved edge and an axis passing through the centerpoint of the first port that is oriented orthogonal to the primary fluid flow direction of the fluidic vessel.

Clause 7. The fluidic vessel of clause 5 or 6, wherein the transition between the surface of the offset structure and the substantially planar surface is substantially orthogonal to the surface of the substantially planar surface.

Clause 8. The fluidic vessel of clause 5 or 6, wherein the transition between the surface of the offset structure and the substantially planar surface is substantially non-orthogonal to the surface of the substantially planar surface.

Clause 9. The fluidic vessel of clause 8, wherein the transition between the surface of the offset structure and the substantially planar surface is inclined from the surface of the offset structure to the substantially planar surface.

Clause 10. A fluidic vessel, comprising a first port, a second port, and a channel disposed between the first port and the second port, wherein the channel is bounded by at least one substantially planar surface and a second surface, wherein the channel has a depth between the substantially planar surface and the second surface, wherein the fluidic vessel comprises a baffled structure, wherein the first port is configured to deliver fluid across the baffled structure, wherein the baffled structure comprises a plurality of protrusions, wherein a length of a protrusion of the plurality of protrusions is greater than a width of the protrusion of the plurality of protrusions, and wherein the protrusion of the plurality of protrusions is oriented substantially orthogonal to a primary fluid flow direction of the fluidic vessel.

Clause 11. The fluidic vessel of clause 10, wherein the two or more protrusions of the plurality of protrusions are oriented substantially orthogonal to the primary fluid flow direction of the fluidic vessel.

Clause 12. The fluidic vessel of clause 10 or 11, wherein the plurality of protrusions comprise two or more rows of protrusions.

Clause 13. The fluidic vessel of clause 12, wherein a first row of the two or more rows of protrusions comprises more protrusions than a second row of the two or more rows of protrusions.

Clause 14. The fluidic vessel of any one of clauses 10-13, wherein the plurality of protrusions is disposed on the substantially planar surface.

Clause 15. The fluidic vessel of any one of clauses 10-13, wherein the plurality of protrusions is disposed on the second surface.

Clause 16. A fluidic vessel, comprising a first port, a second port, and a channel disposed between the first port and the second port, wherein the channel is bounded by at least one substantially planar surface, wherein an array comprising a plurality of sites is disposed on the substantially planar surface, and wherein the channel has an average depth between the substantially planar surface and an opposing surface in an orthogonal direction relative to the substantially planar surface of no more than 20 microns.

Clause 17. The fluidic vessel of clause 16, wherein the channel has an average depth between the substantially planar surface and an opposing surface in an orthogonal direction relative to the substantially planar surface of no more than 10 microns.

Clause 18. A fluidic vessel, comprising: a) a flow region with an aspect ratio greater than 1, wherein the aspect ratio is a length of the flow region divided by a width of the flow region; b) a first surface bounding the flow region, wherein the first surface comprises a curved surface; and c) a second surface bounding the flow region, wherein the second surface comprises a substantially planar surface; wherein the first surface is substantially opposed to the second surface; wherein the flow region has a depth between the first surface and second surface; and wherein a cross-sectional profile of the first surface varies with the length of the flow region.

Clause 19. The fluidic vessel of clause 18, wherein the fluidic vessel further comprises a first port and a second port, wherein the first port and the second port are disposed at opposite ends of the flow region with respect to the lengthwise direction of the flow region.

Clause 20. The fluidic vessel of clause 18, wherein the first port or the second port passes through the first surface bounding the flow region.

Clause 21. The fluidic vessel of clause 18, wherein the first port or the second port passes through the second surface bounding the flow region.

Clause 22. The fluidic vessel of clause 18, wherein the first port and the second port pass through the first surface bounding the flow region.

Clause 23. The fluidic vessel of clause 18, wherein the first port and the second port pass through the second surface bounding the flow region.

Clause 24. The fluidic vessel of clause 18, wherein the first surface and the second surface each individually comprise a port.

Clause 25. The fluidic vessel of clause 18, wherein the first surface or the second surface does not comprise a fluidic port.

Clause 26. The fluidic vessel of clause 25, wherein neither the first surface nor the second surface comprises a fluidic port.

Clause 27. The fluidic vessel of any one of clauses 18-26, wherein the cross-sectional profile of curvature of the first surface is characterized by an increasing average separation distance between the first surface and the second surface as a function of distance along the lengthwise direction of the flow region.

Clause 28. The fluidic vessel of clause 27, wherein the average separation distance between the first surface and the second surface as a function of distance along the lengthwise direction of the flow region increases non-linearly.

Clause 29. The fluidic vessel of any one of clauses 18-28, wherein the cross-sectional profile of curvature of the first surface is characterized by a decreasing variance of the separation distance between the first surface and the second surface as a function of distance along the lengthwise direction of the flow region.

Clause 30. A fluidic vessel, comprising: a) a flow region with an aspect ratio greater than 1, wherein the aspect ratio is a length of the flow region divided by a width of the flow region; b) a substantially planar surface bounding the flow region; and c) an offset surface comprising a port, wherein the offset surface is substantially parallel to and offset from the substantially planar surface; wherein the offset surface comprises a curved edge that spans at least a portion of the width of the flow region, wherein the curved edge is indented toward the port.

Clause 31. The fluidic vessel of clause 30, wherein the curved edge spans the entire width of the flow region.

Clause 32. The fluidic vessel of clause 30, wherein the curved edge does not span the entire width of the flow region.

Clause 33. The fluidic vessel of any one of clauses 30-32, wherein the offset surface has a height that is at least 20% of the average depth of the fluidic vessel at the flow region.

Clause 34. The fluidic vessel of any one of clauses 30-33, wherein the offset surface has a height that is no more than 80% of the average depth of the fluidic vessel at the flow region.

Clause 35. The fluidic vessel of any one of clauses 30-34, wherein the offset surface has a height that is at least 5% of the average width of the fluidic vessel at the flow region.

Clause 36. The fluidic vessel of any one of clauses 30-35, wherein the offset surface has a height that is no more than 50% of the average width of the fluidic vessel at the flow region.

Clause 37. The fluidic vessel of any one of clauses 30-36, wherein a transition between the substantially planar surface and the offset surface is substantially horizontal.

Clause 38. The fluidic vessel of any one of clauses 30-36, wherein a transition between the substantially planar surface and the offset surface is inclined.

Clause 39. A fluidic vessel, comprising: a) a surface comprising an array of sites, wherein the surface has an aspect ratio greater than 1, wherein the aspect ratio is a length of the surface divided by a width of the surface; b) a port passing through the surface, wherein the port provides fluidic communication to the surface; and c) a baffled structure comprising a plurality of ridged structures, wherein the baffled structure is disposed in a region between the port and the array of sites.

Clause 40. The fluidic vessel of clause 39, wherein the array of sites is disposed on a solid support, and wherein the baffled structure is disposed on the solid support.

Clause 41. The fluidic vessel of clause 39, wherein the array of sites is disposed on a first solid support, and wherein the baffled structure is disposed on a second solid support.

Clause 42. The fluidic vessel of clause 41, wherein the first solid support is substantially opposed to the second solid support.

Clause 43. The fluidic vessel of any one of clauses 39-42, wherein an orientation angle of a ridged structure of the plurality of ridged structures is opposed to a primary direction of fluid flow.

Clause 44. The fluidic vessel of any one of clauses 39-42, wherein an orientation angle of a ridged structures of the plurality of ridged structures is toward a primary direction of fluid flow.

Clause 45. The fluidic vessel of any one of clauses 39-44, wherein a ridged structure of the plurality of ridged structures is substantially linear.

Clause 46. The fluidic vessel of any one of clauses 39-44, wherein a ridged structure of the plurality of ridged structures is curved.

Clause 47. The fluidic vessel of any one of clauses 39-46, wherein a ridged structure of the plurality of ridged structures has a height of at least 40% of a height of a chamber or channel in which the ridged structure is disposed.

Clause 48. The fluidic vessel of any one of clauses 39-47, wherein a ridged structure of the plurality of ridged structures has a height of no more than 60% of a height of a chamber or channel in which the ridged structure is disposed.

Clause 49. The fluidic vessel of any one of clauses 39-48, wherein the plurality of ridged structures comprises at least 3 ridged structures.

Clause 50. The fluidic vessel of clause 49, wherein the plurality of ridged structures comprises at least 10 ridged structures.

Clause 51. A fluidic vessel, comprising: a) a solid support, wherein a surface of the solid support comprises an array, wherein the array comprises a plurality of sites, wherein the surface of the solid support has an average length and an average width, and wherein the average length of the surface of the solid support is greater than the average width of the solid support; b) a first channel in the solid support, wherein the first channel is disposed adjacent to a first side of the array; and c) a second channel in the solid support, wherein the second channel is disposed adjacent to a second side of the array, wherein the second side differs from the first side; wherein an average separation distance between the first channel and the second channel is less than the average length of the surface of the solid support.

Clause 52. A method, comprising: a) delivering a fluid to a first port of a fluidic vessel of any one of clauses 1-51, wherein the fluid comprises a plurality of macromolecules; b) flowing the fluid comprising the plurality of macromolecules across an array of sites that is disposed within the fluidic vessel, thereby binding macromolecules of the plurality of macromolecules to sites of the array of sites; and c) discharging the fluid through a second port of the fluidic vessel.

Clause 53. The method of clause 52, wherein a macromolecule of the plurality of macromolecules comprises an analyte of interest.

Clause 54. The method of clause 52 or 53, wherein a macromolecule of the plurality of macromolecules comprises an anchoring moiety.

Clause 55. The method of any one of clauses 52-54, wherein a macromolecule of the plurality of macromolecules comprises a detection reagent.

Clause 56. The method of any one of clauses 52-55, further comprising contacting the fluid to the array of sites.

Clause 57. The method of clause 56, wherein contacting the fluid to the array of sites comprises quiescently contacting the fluid to the array of sites.

Clause 58. The method of clause 56, wherein contacting the fluid to the array of sites comprises non-quiescently contacting the fluid to the array of sites.

Clause 59. The method of any one of clauses 56-58, wherein the contacting occurs for at least 10 seconds (s).

Clause 60. The method of any one of clauses 56-59, wherein the contacting occurs for no more than 1 hour (hr).

Clause 61. The method of any one of clauses 52-60, wherein the fluidic vessel comprises a chamber, wherein the chamber has a volume.

Clause 62. The method of clause 61, wherein delivering the fluid to the first port of the fluidic vessel comprises delivering a volume of fluid to the first port that is greater than or equal to the volume of the chamber of the fluidic vessel.

Clause 63. The method of clause 62, wherein delivering the volume of fluid to the first port that is greater than or equal to the volume of the chamber of the fluidic vessel occurs in no more than 60 seconds (s).

### Example 1—Fluidic Device with Offset Structure

Fluidic velocity profiles were simulated in COMSOL modeling software to compare velocity profile differences between a fluidic vessel having a flat inlet structure and a fluidic vessel having an offset inlet structure. The overall structure of the U-shaped fluidic vessel is shown in FIG. 7A. The fluidic vessels comprised a first solid support with two substantially planar regions (101A and 101B) that are configured to contain an array of sites, as set forth herein. The two substantially planar regions were enclosed within chambers formed by joining of a second solid support to the first solid support. The chambers containing the substantially planar regions were modeled to have substantially vertical side walls and a substantially flat surface on the second solid support that was substantially opposed to the two substantially planar regions of the first solid support. The two chambers were fluidically connected by a U-shaped channel 740 that made a 180° turn. The fluidic vessels were simulated to have a fluid delivered through port 721 and discharged through port 720. The inlet port entered the first chamber in a tapered entrance region 101′ that broadened out to the full width of the fluidic vessel downstream from the port 721. The width of the chamber was constant until it tapered to the width of the U-shaped channel 740. The second chamber expanded from the U-shaped channel 740 width to the full fluidic vessel width until tapering at the outlet port 720. Each chamber had a maximum width of 2 millimeters (mm), a maximum channel height of 50 microns, and a length of 100 mm.

The first simulated fluidic vessel was modeled to have a flat surface at the inlet port 721. The second simulated fluidic vessel was modeled to have the offset structure described for FIGS. 6A and 6B. For the second fluidic vessel, the fluidic velocity profile was simulated for varying heights of the offset structure. The offset structure was simulated for heights of 5 microns, 10 microns, 20 microns, and 50 microns.

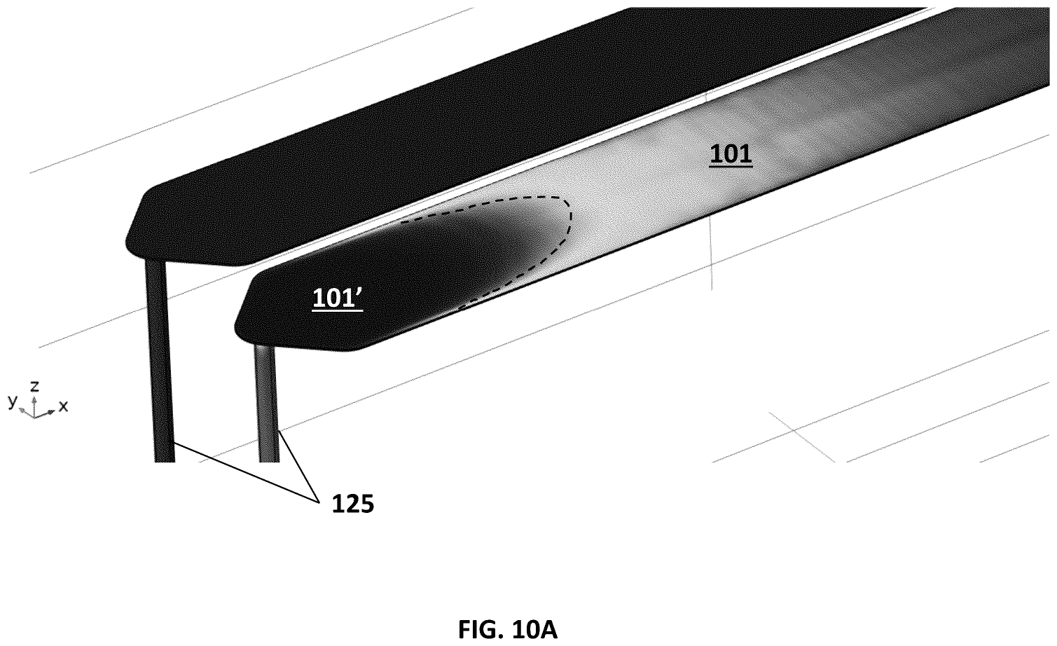

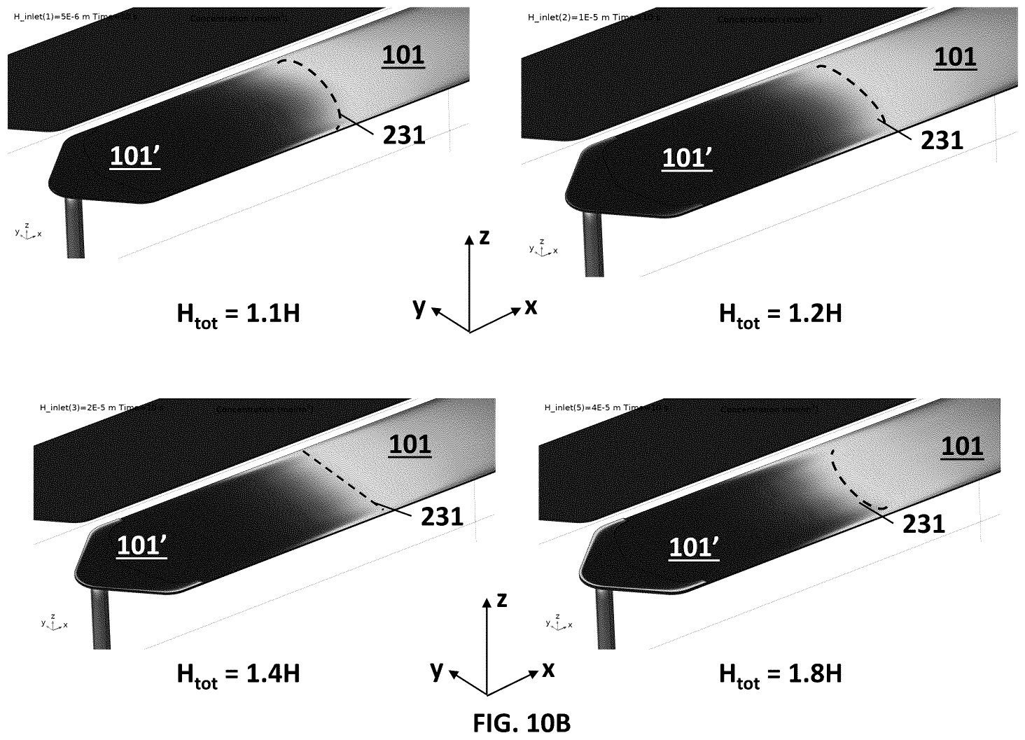

FIG. 10A depicts the simulated flow velocity profile for the first fluidic vessel. The flow velocity profile had the expected substantially parabolic velocity profile in the x-y plane (parallel to the surface of the first solid support. FIG. 10B depicts simulated velocity profiles for the second fluidic vessel as a function of the offset structure height. As the height of the offset structure is increased the fluidic velocity profile was observed to change from the substantially parabolic velocity profile to a more substantially uniform flow velocity profile. At an offset structure height of 40% of the maximum channel height (20 microns), the fluidic velocity profile was observed to be substantially uniform in the y-axis direction, with a decrease in fluid velocity only observed adjacent to the side walls of the chamber. As the height of the offset structure was raised beyond 40% of the maximum channel height, the fluidic speed was observed to have maxima just within the low speed regions adjacent to the sidewalls, with a local speed minimum near the centerpoint of the channel with respect to the y-axis.

### Example 2—Fluidic Device with Baffled Structure

Fluidic velocity profiles were simulated in COMSOL modeling software to assess velocity profile differences between a fluidic vessel having baffled inlet structures of varying heights. The overall structure of the U-shaped fluidic vessel, as shown in FIG. 7A, was described in Example 1.

The simulated fluidic vessel was modeled to have the baffled structure described for FIGS. 6D and 6J. Each individual ridge comprising the baffled structure had a length of 1 mm and a width of 0.1 mm. For the second fluidic vessel, the fluidic velocity profile was simulated for varying heights of the ridges of the baffled structure. The baffled structure was simulated for heights of 5 microns, 20 microns, 25 microns, and 35 microns.

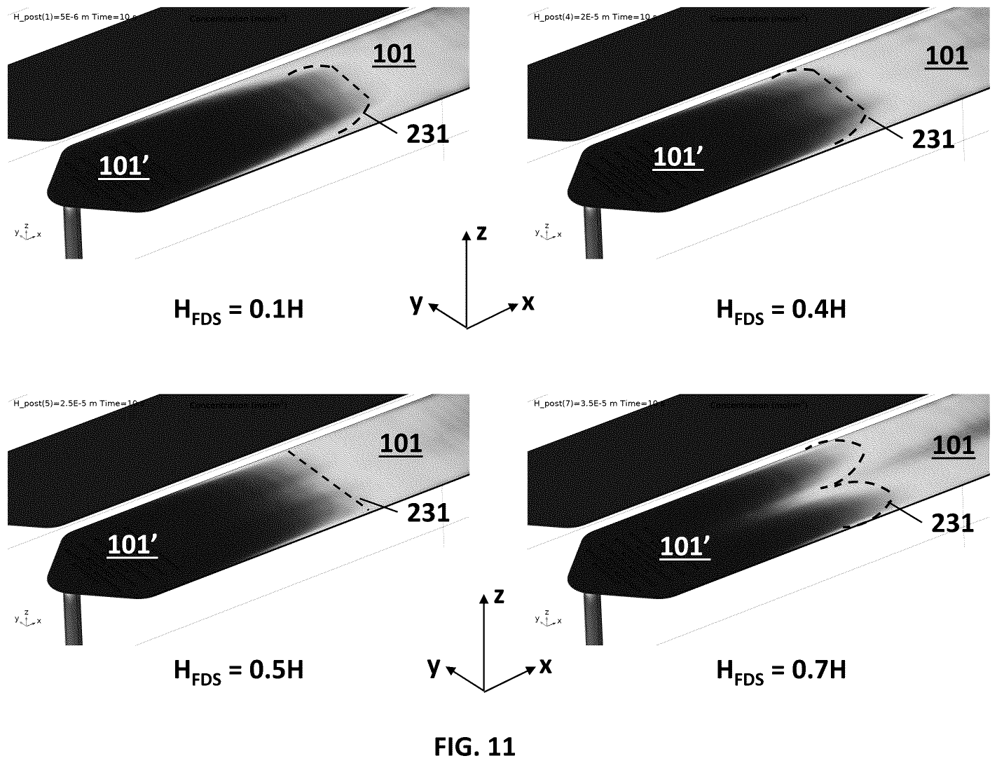

FIG. 11 depicts simulated velocity profiles for the fluidic vessel as a function of the baffled structure height. As the height of the offset structure is increased the fluidic velocity profile was observed to change from the substantially parabolic velocity profile to a more substantially uniform flow velocity profile. At an offset structure height of 50% of the maximum channel height (25 microns), the fluidic velocity profile was observed to be substantially uniform in the y-axis direction, with a decrease in fluid speed only observed adjacent to the side walls of the chamber. As the height of the offset structure was raised beyond 50% of the maximum channel height, the fluidic speed was observed to form two parabolic maxima, with low speed regions adjacent to the sidewalls and at the centerline of the chamber.

What is claimed is:

1) A fluidic vessel, comprising a chamber bounded by at least one substantially planar surface and a second surface, a first port between the chamber and an exterior of the fluidic vessel, a second port between the chamber and the exterior of the fluidic vessel, and a channel disposed between the first port and the second port, wherein the channel is bounded by the at least one substantially planar surface and the second surface, wherein the fluidic vessel further comprises an offset structure, wherein the first port is configured to deliver fluid to a surface of the offset structure, wherein the surface of the offset structure is substantially parallel to the surface of the substantially planar surface, and wherein a depth of the chamber between the surface of the offset structure and the second surface of the chamber is less than the depth of the chamber between the substantially planar surface and the second surface of the chamber.

2) The fluidic vessel of claim 1, wherein a fluid flow within the chamber has an average speed of at least 80% of the maximum speed of the fluid flow.

3) The fluidic vessel of claim 1, wherein the substantially planar surface comprises an array, wherein the array comprises a plurality of sites.

4) The fluidic vessel of claim 1, wherein the average speed of a fluid flow is measured along an axis that is offset from and parallel to the substantially planar surface, wherein the axis is oriented substantially orthogonal to the direction of the fluid flow.

5) The fluidic vessel of claim 1, wherein the offset structure further comprises a curved edge, wherein the curved edge occurs at a transition between the surface of the offset structure and the substantially planar surface.

6) The fluidic vessel of claim 5, wherein a downstream distance between a centerpoint of the curved edge and a centerpoint of the first port is less than a downstream distance between an edge point of the curved edge and the centerpoint of the first port, wherein the downstream distance is measured as the distance between the curved edge and an axis passing through the centerpoint of the first port that is oriented orthogonal to a primary fluid flow direction of the fluidic vessel.

7) The fluidic vessel of claim 5, wherein the transition between the surface of the offset structure and the substantially planar surface is substantially orthogonal to the surface of the substantially planar surface.

8) The fluidic vessel of claim 5, wherein the transition between the surface of the offset structure and the substantially planar surface is substantially non-orthogonal to the surface of the substantially planar surface.

9) The fluidic vessel of claim 8, wherein the transition between the surface of the offset structure and the substantially planar surface is inclined from the surface of the offset structure to the substantially planar surface.

10) A fluidic vessel, comprising a first port, a second port, and a channel disposed between the first port and the second port, wherein the channel is bounded by at least one substantially planar surface and a second surface, wherein the channel has a depth between the substantially planar surface and the second surface, wherein the fluidic vessel comprises a baffled structure, wherein the first port is configured to deliver fluid across the baffled structure, wherein the baffled structure comprises a plurality of protrusions, wherein a length of a protrusion of the plurality of protrusions is greater than a width of the protrusion of the plurality of protrusions, and wherein the protrusion of the plurality of protrusions is oriented substantially orthogonal to a primary fluid flow direction of the fluidic vessel.

11) The fluidic vessel of claim 10, wherein the two or more protrusions of the plurality of protrusions are oriented substantially orthogonal to the primary fluid flow direction of the fluidic vessel.

12) The fluidic vessel of claim 10, wherein the plurality of protrusions comprise two or more rows of protrusions.

13) The fluidic vessel of claim 12, wherein a first row of the two or more rows of protrusions comprises more protrusions than a second row of the two or more rows of protrusions.

14) The fluidic vessel of claim 10, wherein the plurality of protrusions is disposed on the substantially planar surface.

15) The fluidic vessel of claim 10, wherein the plurality of protrusions is disposed on the second surface.

16) A fluidic vessel, comprising a first port, a second port, and a channel disposed between the first port and the second port, wherein the channel is bounded by at least one substantially planar surface, wherein an array comprising a plurality of sites is disposed on the substantially planar surface, and wherein the channel has an average depth between the substantially planar surface and an opposing surface in an orthogonal direction relative to the substantially planar surface of no more than 20 microns.

17) The fluidic vessel of claim 16, wherein the channel has an average depth between the substantially planar surface and an opposing surface in an orthogonal direction relative to the substantially planar surface of no more than 10 microns.

18) A fluidic vessel, comprising:
a) a flow region with an aspect ratio greater than 1, wherein the aspect ratio is a length of the flow region divided by a width of the flow region;
b) a first surface bounding the flow region, wherein the first surface comprises a curved surface; and
c) a second surface bounding the flow region, wherein the second surface comprises a substantially planar surface;
wherein the first surface is substantially opposed to the second surface;
wherein the flow region has a depth between the first surface and second surface; and
wherein a cross-sectional profile of the first surface varies with the length of the flow region.

19) The fluidic vessel of claim 18, wherein the fluidic vessel further comprises a first port and a second port, wherein the first port and the second port are disposed at opposite ends of the flow region with respect to the lengthwise direction of the flow region.

20) The fluidic vessel of claim 18, wherein the first port or the second port passes through the first surface bounding the flow region.
